(19) United States
(12) Patent Application Publication
(10) Pub. No.: US 2009/0053512 A1
(43) Pub. Date: Feb. 26, 2009

(54) MULTIFUNCTIONAL POLYMER COATED MAGNETIC NANOCOMPOSITE MATERIALS

(75) Inventors: Jeffrey Pyun, Tucson, AZ (US); Bryan Korth, Tucson, AZ (US); Steven Bowles, Pittsburgh, PA (US); Pei Yuin Keng, Sarawak (MY)

Correspondence Address: OBLON, SPIVAK, MCCLELLAND MAIER & NEUSTADT, P.C., 1940 DUKE STREET, ALEXANDRIA, VA, 22314, US

(73) Assignee: THE ARIZONA BD OF REG ON BEHALF OF THE UNIV OF AZ, Tucson, AZ (US)

(21) Appl. No.: 12/282,408

(22) PCT Filed: Mar. 12, 2007
(86) PCT No.: PCT/US07/63792

§ 371 Date: Oct. 31, 2008

Related U.S. Application Data
(60) Provisional application No. 60/781,030, filed on Mar. 10, 2006.

(51) Int. Cl. B32B 15/02; B32B 9/00

(52) U.S. Cl. 428/336; 252/62.51 R; 252/62.55; 428/368; 428/457; 428/702; 428/411.1; 428/367

(57) ABSTRACT

A polymer coated nanoparticle containing a metallic core and a polymer shell encapsulating said metallic core is useful, for example, in magnetic tapes and supercapacitors.

### BACKGROUND OF THE INVENTION

1. Field of the Invention

The present invention relates to a polymer coated metallic nanoparticle, methods of making the polymer coated metallic nanoparticle and its use.

2. Discussion of the Background

The synthesis and controlled assembly of functional nanoparticles has been widely explored as a route to obtain novel materials possessing enhanced synergistic properties. (Tang, Z.; Kotov, N. A., One-dimensional assemblies of nanoparticles: Preparation, properties, and promise. Advanced Materials (Weinheim, Germany) 2005, 17, (8), 951-962.) This bottom up approach to materials synthesis requires robust chemistry to functionalize colloidal building blocks and selective assembly processes to organize nanoparticles into complex materials.

A number of different strategies have been developed to hierarchically assemble functional nanoparticles using molecular recognition processes, block copolymer templates, lithographically templated surfaces, liquid-liquid interfaces and field induced dipolar associations (Mirkin, C. A.; Letsinger, R. L.; Mucic, R. C.; Storhoff, J. J., A DNA-based method for rationally assembling nanoparticles into macroscopic materials. Nature (London) 1996, 382, (6592), 607-609; Storhoff, J.; Mirkin, C. A., Programmed Materials Synthesis with DNA. Chemical Reviews (Washington, D.C.) 1999, 99, (7), 1849-1862; Boal, A. K.; Ilhan, F.; DeRouchey, J. E; Thurn-Albrecht, T.; Russell, T. P.; Rotello, V. M., Self-assembly of nanoparticles into structured spherical and network aggregates. Nature (London 2000, 404, (6779), 746-748; Shenhar, R.; Rotello, V. M., Nanoparticles: Scaffolds and Building Blocks. Accounts of Chemical Research 2000, 36, (7), 549-561; Shenhar, R.; Norsten, T. B.; Rotello, V. M., Polymer-mediated nanoparticle assembly: structural control and applications. Advanced Materials (Weinheim, Germany) 2005, 17, (6), 657-669); Sankaran, V; Cummins, C. C.; Schrock, R. R.; Cohen, R. E.; Silbey, R. J., Small lead sulfide (PbS) clusters prepared via ROMP block copolymer technology. Journal of the American Chemical Society 1990, 112, (19), 6858-9; Cumins, C. C.; Schrock, R. R.; Cohen, R. E., Synthesis of zinc sulfide and cadmium sulfide within ROMP block copolymer microdomains. Chemistry of Materials 1992, 4, (1), 27-30; Ng Cheong Chan, Y.; Schrock, R. R., Synthesis of palladium nanoclusters within spherical microdomains in films made from block copolymer/homopolymer blends. Chemistry of Materials 1993, 5, (4), 566-70; Tadd, E. H.; Bradley, J.; Tannenbaum, R., Spatial Distribution of Cobalt Nanoclusters in Block Copolymers. Langmuir 2002, 18, (6), 2378-2384; Bockstaller, M. R.; Lapetnikov, Y.; Margel, S.; Thomas, E. L., Size-Selective Organization of Enthalpic Compatibilized Nanocrystals in Ternary Block Copolymer/Particle Mixtures, Journal of the American Chemical Society 2003, 125, (18), 5276-5277; Bockstaller, M. R.; Mickiewicz, R. A.; Thomas, E. L., Block copolymer nanoconposites: Perspectives for tailored functional materials. Advanced Materials (Weinheim, Germany) 2005, 17, (11), 1331-1349; Sessions, L. B.; Miinea, L. A.; Ericson, K. D.; Glueck, D. S.; Grubbs, R. B., Alkyne-Functional Homopolymers and Block Copolymers through Nitroxide-Mediated Free Radical Polymerization of 4-(Phenylethynyl)styrene. Macromolecules 2005, 38, (6), 2116-2121; Tannenbaum, R.; Zubris. M.; Goldberg, E. P.; Reich, S.; Dan, N., Polymer-Directed Nanocluster Synthesis. Control of Particle Size and Morphology. Macromolecules 2005, 38, (10), 4254-4259; Demers, L. M.; Park, S.-J.; Taton, T. A.; Li, Z.; Mirkin, C. A., Orthogonal assembly of nanoparticles building blocks on dip-pen nanolithographically generated templates of DNA Angewandte Chemie, International Edition 2001, 40, (16), 3071-3073. 16. Liu, X.; Fu, L.; Hong, S.; Dravid, V. P.; Mirkin, C. A., Arrays of magnetic nanoparticles patterned via \“dip-pen\”nanolithography. Advanced Materials (Weinheim, Germany) 2002, 14, (3), 231-234; Xia, Y.; Yin, Y.; Lu, Y.; McLellan, J., Template-assisted self-assembly of spherical colloids into complex and controllable structures. Advanced Functional Materials 2003, 125, (12), 907-918; Yin, Y.; Xia, Y. Self-Assembly of Spherical Colloids into Helical Chains with Well-Controlled Handedness. Journal of the American Chemical Society 2003, 125, (8), 2048-2049; Lin, Y.; Skaff, H.; Boeker, A.; Dinsmore, A. D.; Emrick, T.; Russell, T. P., Ultrathin crosslinked nanoparticle membranes. Journal of the American Chemical Society 2003, 125, (42), 12690-12691; Duan, H.; Wang, D.; Kurth, D. G.; Moehwald, H., Directing self-assembly of nanoparticles at water/oil interfaces. Angewandte Chemie, International Edition 2004, 43, (42), 5639-5642; Duan, H.; Wang, D.; Sobal, N. S.; Giersig, M.; Kurth, D. G.; Moehwald, H., Magnetic Colloidosomes Derived from Nanoparticle interfacial Self-Assembly. Nano Letters 2005, 5, (5), 949-952; Gu, H.; Yang, Z.; Gao, J.; Chang, C. K.; Xu, B., Heterodimers of Nanoparticles: Formation at a Liquid-Liquid Interface and Particle-Specific Surface Modification by Functional Molecules, Journal of the American Chemical Society 2005, 127, (1), 34-35; Lin, Y.; Boeker, A.; Skaff, H.; Cookson, D.; Dinsmore, A. D.; Emrick, T.; Russell, T. P., Nanoparticle assembly at fluid interfaces: Structure and dynamics Langmuir 2005, 21, (1), 191-194; Hao, T., Electrorheological fluids Advanced Materials (Weinheim, Germany) 2001, 13, (24), 1847-1857).

The use of magnetic attractions induced from external applied fields has recently gained attention as a selective and versatile process to organize both micro- and nanoparticles into one-dimensional (1-D) chains (Skjeltorp, A. T., Ordering phenomena of particles dispersed in magnetic fluids Journal of Applied Physics 1985, 57, (8, Pt. 2A), 3285-90; Furst, E. M.; Suzuki, C.; Fermigier, M.; Gast, A. P., Permanently Linked Monodisperse Paramagnetic Chains. Langmuir 1998, 14, (26), 7334-7336; Furst, E. M.; Gast, A. P., Micromechanics of Dipolar Chains Using Optical Tweezers, Physical Review Letters 1999, 82, (20), 4130-4133; Skjeltorp, A. T.; Clausen, S.; Helgesen, G., Ferrofluids, complex particle dynamics and braid description. Journal of Magnetism and Magnetic Materials 2001, 226-230, (Pt. 1), 534-539; Biswal, S. L.; Gast, A. P., Mechanics of semiflexible chains formed by poly(ethylene glycol)-linked paramagnetic particles. Physical Review E: Statistical Nonlinear, and Soft Matter Physics 2003, 68, (2-1), 021402/1-021402/9; Biswal, S. L.; Gast, A. P., Micromixing with Linked Chains of Paramagnetic Particles. Analytical Chemistry 2004, 76, (21), 6448-6455; Toussaint, R.; Akselvoll, J.; Helgesen, G.; Flekkoy, L.; G.; Skjeltorp, A. T., Interactions of magnetic holes in ferrofluid layers. Progress in Colloid & Polymer Science 2004, 128, 151-155; Cohen-Tarmoudji, L.; Bertrand, L.; Bressy, L.; Goubault, C.; Baudry, J.; Klein, J.; Joanny, J.-F.; Bibette, J., Polymer Bridging Probed by Magnetic Colloids. Physical Review Letters 2005, 94, (3), 038301/1-038301/4; Goubault, C.; Leal-Calderon, F.; Viovy, J.-L.; Bibette, J., Self-Assembled Magnetic Nanowires Made Irreversible by Polymer Bridging. Langmuir 2005, 21, (9), 3725-3729; Pileni, M. P., Nanocrystal Self-Assemblies: Fabrication and Collective Properties. Journal of Physical Chemistry B 2001, 105, (17), 3358-3311; Germain, V.; Pileni, M.-P., Size distribution of cobalt nanocrystals: A key parameter in formation of columns and labyrinths in mesoscopic structures. Advanced Materials (Weinheim, Germany) 2005, 17, (11), 1424-1429; Pileni, M.-P.; Ngo, A.-T., Mesoscopic structures of maghemite nanocrystals: Fabrication, magnetic properties, and uses. Chem Phys Chem 2005, 6, (6), 1027-1034).

Magnetic colloidal dispersions, or ferrofluids, are an interesting class of materials that can reversibly respond to an applied magnetic field (H) by a change in viscosity, or shape of the media (Zahn, M., Magnetic fluid and nanoparticle applications to nanotechnology, Journal of Nanoparticle Research 2001, 3, (1), 73-78; Pileni, M.-P., Magnetic fluids: fabrication, magnetic properties, and organization of nanocrystals. Advanced Functional Materials 2001, 11, (5), 323-336.) In these systems, an applied field induces dipolar interactions between colloids which result in the formation of chain-like and columnar assemblies. These chain-like assemblies are oriented in the direction of the applied field. In the case of dispersions of high magnetization and/or concentration, chains of assembled colloids also laterally associate into bundles of chains throughout the medium (FIG. 1, gap-spanning chains). Dispersions possessing lower magnetization and/or concentration form single chain and open ended aggregates (FIG. 1) de Cans, B. J.; Duin, N. J.; van den Ende, D.; Mellema, J., The influence of particle size on the magnetorheological properties of a inverse ferrofluid. Journal of Chemical Physics 2000, 113, (5), 2032-2042). A current limitation in the field of ferrofluids and magnetic nanoparticles is the lack of robust synthetic methods to functionalize colloidal surfaces. The coating and passivation of magnetic nanoparticles with polymer surfactants has been achieved as a promising route to modify the properties of these materials However, the use of the polymer surfactant to introduce a wide range of functionality to magnetic colloids has not been extensively developed. Subtle differences in the chemical composition of these materials may allow for the preparation of novel structures that harness the advantages of magnetic assembly.

Magnetic field-induced assembly of dispersed micron-sized latex particles and functional emulsion droplets has been achieved to form assembled chains spanning several microns in length. In these systems, very small iron oxide nanoparticles (6-10 nm) are encapsulated in a crosslinked latex particle, or emulsion droplet with loadings of 65-wt % iron oxide. Previous work by Gast et al., demonstrated that superparamagnetic micron-sized latex particles could be functionalized, assembled and covalently bound into beaded chains (Furst, E. M.; Suzuki, C.; Fermigier, M.; Gast, A. P., Permanently Linked Monodisperse Paramagnetic Chains. Langiuir 1998, 14, (26), 7334-7336; Biswal, S.; Cast, A. P., Mechanics of semiflexible chains formed by poly(ethylene glycol)-linked paramagnetic particles. Physical Review E: Statistical, Nonlinear, and Soft Matter Physics 2003, 68, (2-1, 021402/1-021402/9). Similarly, the field-induced formation of extended nanowires was reported by Bibette et al., using a mixture of magnetic droplets (600 nm) and a poly(acrylic acid) linker (Cohen-Tannoudji, L.; Bertrand, E.; Bressy, L.; Goubault, C.; Baudry, J.; Klein, J.; Joanny, J.-F.; Bibette, J., Polymer Bridging Probed by Magnetic Colloids. Physical Review Letters 2005, 94, (3), 038301/1-038301/4; Goubault, C.; Leal-Calderon, F.; Viovy, J.-L.; Bibette, J., Self-Assembled Magnetic Nanowires Made Irreversible by Polymer Bridging. Langmuir 2005, 21, (9), 3725-3729). These important examples confirm that magnetic assembly is a powerful tool to prepare higher order mesostructures. However, the exploration of nanoscale building blocks using smaller magnetic colloids (particle size<100 nm) coated with organic polymer shells has not been performed. By going to smaller dimensions, both the organic and inorganic components can be intimately compatabilized, which may afford novel synergistic properties in the nanocomposite material.

The assembly of magnetic nanoparticles has been widely investigated using computation modeling (Chantrell, R. W.; Bradbury, A.; Popplewell, J.; Charles, S. W., Particle cluster configuration in magnetic fluids. Journal of Physics D: Applied Physics 1980, 13, (7), L119-L122; Chantrell, R. W.; Bradbury, A.; Popplewell, J.; Charles, S. W., Agglomerate formation in a magnetic fluid, Journal of Applied Physics 1982, 53, (3, Pt. 2), 2742-4; Safran, S. A., Ferrofluids. Magnetic strings and networks. Nature Materials 2003, 2, (2), 71-72) and in the solid-state on surfaces (Pileni, M. P., Nanocrystal Self-Assemblies: Fabrication and Collective Properties. Journal of Physical Chemistry B 2001, 105, (17), 3358-3371; Sun, S.; Murray, C. B., Synthesis of monodisperse cobalt nanocrystals and their assembly into magnetic superlattices, Journal of Applied Physics 1999, 85, (8, Pt. 2A), 4325-4330; Puntes, V. F.; Krishnan, K. M.; Alivisatos, A. P., Synthesis, self-assembly and magnetic behavior of a two-dimensional superlattice of a single-crystal cobalt. Appl. Phys. Lett 2001 S78, 2187-2189; Tripp S. L.; Puzstay, S. V.; Ribbe, A. E.; Wei, A., Self-assembly of cobalt nanoparticle rings. J. Am. Chem. Soc. 2002, 124, 7914-7915; Bao, Y.; Beerman, M.; Krishnan, K. M., Controlled self-assembly of cobalt nanocrystals, J. Mag. Mag. Mater. 2003, 266, 1245-1249). However, the experimental demonstration of field-induced, or self-assembled organization of dispersed magnetic nanoparticles into permanently linked mesoscopic chains has not been achieved. A fundamental problem encountered with the assembly of very small magnetic nanoparticles is the facile perturbation of the dipolar associations from thermal fluctuations (i.e. Brownian motion). This effect can be overcome to some degree by the application of strong magnetic fields, (Butter, K.; Bomans, P. H. H.; Frederik, P. M.; Vroege, C. J.; Philipse, A. P., Direct observation of dipolar chains in iron ferrofluids by cryogenic electron microscopy. Nature Materials 2003, 2, (2), 88-91) but is an inherent limitation incurred when dealing with nanoparticles that are too small (i.e., superparamagnetic). Thus, magnetic assembly processes require the use of single domain ferromagnetic colloids, which are nanoparticles that possess sufficient size and magnetization to retain their dipole moment in the absence of an applied magnetic field. Computations simulations using Monte Carlo methods have shown that dispersed ferromagnetic colloids under certain conditions assemble into chains and bracelets in the absence of a magnetic field (Chantrell, R. W.; Bradbury, A.; Popplewell, J.; Charles, S. W., Particle cluster configuration in magnetic fluids. Journal of Physics D: Applied Physics 1980, 13, (7), L119-L122). Recent work by Philipse et al., has experimentally confirmed this prediction using cryogenic transmission electron microscopy (cryo-TEM) to visualize frozen assemblies of magnetite (Fe₃O₄) nanoparticles particle size=18 nm) (Klokkenburg, M.; Vonk, C.; Claesson, E. M.; Meeldijk, J. D.; Erne, B. H.; Philipse, A. P., Direct Imaging of Zero-Field Dipolar Structures in Colloidal Dispersions of Synthetic Magnetite. Journal of the American Chemical Society 2004, 126, (51), 16706-16707). These promising findings suggest that the dipolar association of functional magnetic nanoparticles is a viable route to for 1-D mescoscopic structures. However, the ability to chemically link these assembled structures together remains elusive, requiring further synthetic developments into the functionalization of magnetic nanoparticles.

The preparation of polymer-coated magnetic nanoparticles has been widely explored as a route to stabilize colloidal dispersions and magnetic thin films. Core-shell nanoparticles composed of magnetic nanoparticle cores and polymeric shells have been prepared by a number of different approaches, including the thermal decomposition of iron, or cobalt carbonyl complexes (Fe(CO)₅, CO₂(CO)₈) using copolymer surfactants (Thomas., J. R., Preparation and magnetic properties of colloidal cobalt particles. (Journal of Applied Physics 1966, 37, (7), 2914-15; Griffiths, C. H.; O'Horo, M. P.; Smith, T. W., The structure, magnetic characterization, and oxidation of colloidal iron dispersions. Journal of Applied Physics 1979, 50, (11, Pt, 1), 7108-15; Platonova, O. A.; Bronstein, L. M.; Solodovnikov, S. P.; Yanovskaya, I. M.; Obolonkova, E. S.; Valetsky, P. M.; Wenz, E.; Antonietti, M., Cobalt nanoparticles in block copolymer micelles. Preparation and properties. Colloid and Polymer Science 1997, 275, (5), 426-431; Dailey, J. P.; Phillips, J. P.; Li, C.; Riffle, J. S., Synthesis of silicone magnetic fluid for use in eye surgery. Journal of Magnetism and Magnetic Materials 1999, 194, (1-3), 140-148; Stevenson, J. P.; Rutnakormpituk, M.; Vadala, M.; Esker, A.; Charles, S. W.; Wells, S.; Dailey, J. P.; Riffle, J. S., Magnetic cobalt dispersions in poly(dimethylsiloxane) fluids. Journal of Magnetism and Magnetic Materials 2001, 225, (1-2), 47-58; Burke, N. A. D. Stoever, H. D. H.; Dawson, F. P., Magnetic Nanocomposites-Preparation and Characterization of Polymer-Coated Iron Nanoparticles. Chemistry of Materials 2002, 14, (11), 4752-4761; Rutnakornpituk, M., Thompson, M. S.; Harris, L. A.; Farmer, K. E.; Esker, A. R.; Riffle, J. S.; Connolly, J.; St. Pierre, T. G., Formation of cobalt nanoparticle dispersions in the presence of polysiloxane block copolymers. Polymer 2002, 43, (8), 2337-2348; Diana, F. S.; Lee, S.-H.; Petroff, P. M.; Kramer, E. J., Fabrication of hcp-Co Nanocrystals via Rapid Pyrolysis in Inverse PS-b-PVP Micelles and Thermal Annealing. Nano Letters 2003, 3 (7) 89-895; Bronstein, L. M.; Sidorov. S. N.; Valetsky, P. M. Nanostructured polymeric systems as nanoreactors for nanoparticle formation. Russian Chemical Reviews 2004, 73, (5) 501-515; Connolly, J.; St. Pierre, T. G.; Rutnakornpituk, M.; Riffle, J. S., Cobalt nanoparticles formed in polysiloxane copolymer micelles: Effect of production methods on magnetic properties. Journal of Physics D: Applied Physics 204, 37, (18), 2475-2482; Vadala, M.; Rutnakornpituk M.; Zalich, M. A.; St. Pierre T. G.; Riffle, J. S., Block copolysiloxanes and their complexation with cobalt nanoparticles. Polymer 2004, 45, (22), 7449-7461).

Surface initiated polymerizations from functionalized superparamagnetic colloidal initiators has also been reported as a route to polymer coated nanoparticles (Vestal, C. R.; Zhang, Z. J., Atom Transfer Radical Polymerization Synthesis and Magnetic Characterization of Mn₂Fe₂O₄/Polystyrene Core/Shell Nanoparticles, Journal of the American Chemical Society 2002, 124, (48), 14312-14313; Wang, Y.; Teng, X.; Wang, J.-S.; Yang, H., Solvent-Free Atom Transfer Radical Polymerization in the Synthesis of Fe2O3@Polystyrene Core-Shell Nanoparticles. Nano Letters 2003, 3, (6), 789-793; Marutani, E.; Yamamoto, S.; Ninjbadgar, T; Tsujii, Y.; Fukuda, T.; Takano, M., Surface-initiated atom transfer radical polymerization of methyl methacrylate on magnetite nanoparticles. Polymer 2004, 45, (7), 2231-2235; Matsuno, R.; Yamamoto, K.; Otsuka, H.; Takahara, A., Polystyrene- and Poly(3-vinylpyridine)-Grafted Magnetite Nanoparticles Prepared through Surface-Initiated Nitroxide-Mediated Radical Polymerization. Macromolecules 2004, 37, (6), 2203-2209; Ninjbadgar, T.; Yamamoto, S.; Fukuda, T., Synthesis and magnetic properties of the g-Fe2O3/poly-(methyl methacrylate)-core/shell nanoparticles. Solid State Sciences 2004, 6, (8), 879-885).

The postfunctionalization of preformed magnetic nanoparticles with linear polymers and dendrimers has also been demonstrated (Sun, S.; Anders, S.; Hamann, H. F.; Thiele, J.-U.; Baglin, J. E. E.; Thomson, T.; Fullerton, E. E.; Murray, C. B.; Terris, B. D., Polymer mediated self-assembly of magnetic nanoparticles. Journal of the American Chemical Society 2002, 124, (12), 2884-2885; Kim, M.; Chen, Y.; Liu, Y.; Peng, X., Super-stable, high-quality Fe3O4 dendron-nanocrystals dispersible in both organic and aqueous solutions. Advanced Materials (Weinheim, Germany) 2005, 17, (11), 1429-1432).

Additionally, the coprecipitation of iron (II) and iron (III) salts within block copolymer and molecular brush templates have also been investigated (Yan, X.; Liu, G.; Liu, F.; Tang, B. Z.; Peng, H.; Pakhomov, A. B.; Wong, C. Y., Superparamagnetic triblock copolymer/Fe2O3 hybrid nanofibers, Angewandte Chemie, International Edition 2001, 40, (19), 35933596; Zhang, M.; Estournes, C.; Bietsch, W.; Mueller, A. H. E., Superparamagnetic hybrid nanocylinders. Advanced Functional Materials 2004, 14, (9), 871-882).

While all of these strategies have been reported, the development of a single, versatile platform to both passivate magnetic nanoparticles and introduce functionality to modify nanocomposite properties remains an important challenge in this area. This synthetic limitation has stifled the exploitation of magnetic field induced assembly to “lock-in” higher order particle structures. Further ore, preparing materials with compatible organic and inorganic components on the nanometer level may allow emergence of synergistic properties that were not present in the previous composite systems. Recent developments in both controlled radical polymerization and dendrimer chemistry have enabled the preparation of a wide range of (co)polymners possessing precise molecular weight, composition, functionality and architecture (Matyjaszewski. K.; Xia, J., Atom Transfer Radical Polymerization. Chemical Reviews 2001, 101, (9), 2921-299; Hawker, C. J.; Bosman, A. W.; Harth, E. New Polymer Synthesis by Nitroxide Mediated Living Radical Polymerizations. Chemical Reviews 2001, 101, (12), 3661-3688; Grayson, S. M.; Frechet, J. M. J., Convergent Dendrons and Dendrimers: from Synthesis to Applications. Chemical Reviews 2001, 101, (12), 3819-3867; Hawker, C. J.; Wooley K. L., The convergent-growth approach to dendritic macromolecules. Advances in Dendritic Macromolecules 1995, 2, 1-39; Tomalia, D. A.; Frechet, J. M. J., Discovery of dendrimers and dendritic polymers: a brief historical perspective. Journal of Polymer Science, Part A: Polymer Chemistry 2002, 40, (16), 2719-2728).

The application of these synthetic methodologies to prepare copolymer surfactants for the passivation and functionalization of magnetic nanoparticles remains largely unexplored.

### SUMMARY OF THE INVENTION

It is therefore an object of the present invention to provide polymer surfactants to introduce a wide range of functionalities to nanoscale magnetic colloids. It is a further object of the present invention to provide nanoscale magnetic colloids coated with organic polymer shells. Yet another object of the present invention is to provide for the field-induced or self-assembled organization of dispersed magnetic nanoparticles into permanently linked mesoscopic chains. Another object of the present invention is to functionalize magnetic nanoparticles, to form 1-D mesocopic structures and to link such structures chemically or physically.

Another object of the present invention is to provide magnetic tapes containing for example aligned magnetic nanoparticles dispersed in a polymer matrix.

This and other objects have been achieved by the present invention the first embodiment of which includes a polymer coated nanoparticle, comprising:

a metallic core; and

a polymer shell encapsulating said metallic core.

In another embodiment, the present invention provides a chain structure, comprising:

a plurality of the above nanoparticles.

In another embodiment, the present invention provides a polymer matrix, comprising:

the above nanoparticle.

In another embodiment the present invention provides a process for preparing the above nanoparticle, comprising:

reacting a metal carbonyl compound or mixtures of different metal carbonyl compounds in the presence of a polymer.

In yet another embodiment, the present invention provides a process for preparing the above nanoparticle, comprising:

exchange of a polymer onto a nanoparticle by a ligand exchange reaction using a ligand that has a higher affinity toward the metallic core than the ligand already attached to the metallic core.

Further, the present invention provides a metal-filled carbon nanowire, obtained by alignment, and pyrolysis of a plurality of the above polymer coated nanoparticles.

In another embodiment, the present invention provides a hollow carbon nanowire, obtained by alignment, pyrolysis and acidic degradation of a plurality of the above polymer coated nanoparticles.

In another embodiment, the present invention provides a magnetic tape, comprising the above polymer coated nanoparticle.

### BRIEF DESCRIPTION OF DRAWINGS

FIG. 1 shows covalently linked magnetic chains.

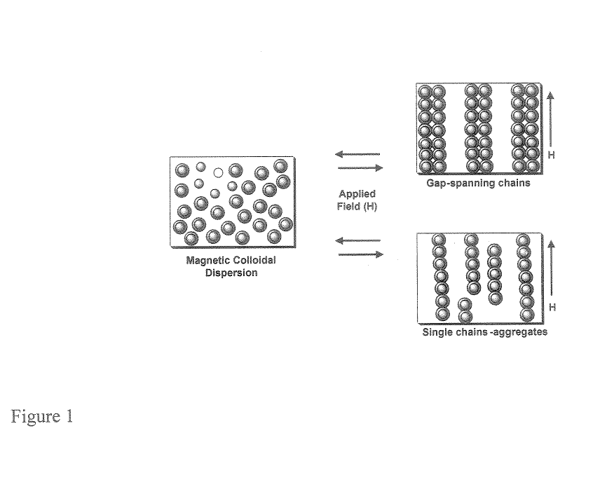

FIG. 2 is a general scheme of the synthesis of magnetic nanocomposite materials and the alignment and crosslinking of assembled colloids into magnetic polymer chains.

FIG. 3 shows that copolymer surfactants are prepared targeting the installation of ligating, crosslinkable and other “property-modifying” groups, such as, fluorescent dyes, fluorinated groups and rubbery/glassy segments.

FIG. 4 shows functional copolymer surfactants possessing linear and dendritic architectures.

FIG. 5 shows the preparation of a library of functional surfactants can be achieved by the copolymerization of styrene, or acrylate monomers with various comonomers.

FIG. 6 shows the synthesis of alkoxyamines as a route to prepare amine and phosphine oxide end-functional polystyrene.

FIG. 7 shows the preparation of both 2^{nd} and 4^{th} generation (G-2, G-4) dendron initiators 16 and 17 with a protected acid and peripheral tetrahydropyran (THP) groups, respectively.

FIG. 8 shows the thermolysis of dicobaltoctacarbonyl (CO₂CO₈) in the presence of functional copolymers.

FIG. 9 shows the TEM images of PS coated cobalt nanoparticles.

FIG. 10 shows the preferred structure of surfactants for magnetic nanoparticle shells.

FIG. 11 shows (a) a UV-VIS spectrum of copolymer 18 (bottom), TOPO-OA (trioctylphosphine and oleic acid) capped Co colloids (middle), pyrene labeled Co colloids (top), (b) XPS of Co nanoparticle coated with copolymer 19.

FIG. 12 shows the synthesis of discrete shell-crosslinked nanoparticles using the ligand exchange approach.

FIG. 13 shows the preparation of polydisperse magnetic chains from crosslinkable magnetic colloids followed by magnetic fractionation to isolate assembled 1-D structures of higher chain length and magnetization.

FIG. 14 shows the preparation of mesoscopic chains possessing random and block segments of different magnetic colloids.

FIG. 15 shows the TEM of magnetic nanoparticle chains.

FIG. 16 shows the preparation of mesoscopic magnetic chains in the absence of an applied field due to the formation of free radicals on nanoparticles, and their preferential 1-D associations from magnetic dipoles.

FIG. 17 shows the general methodology for the preparation of aligned chains in thin films.

FIG. 18 (a) shows a TEM of polymer coated cobalt nanoparticles (20 nm) deposited in the absence of a field, (b) shows a TEM of identical nanoparticles deposited in the presence of a weak magnetic filed. Extended chains over 10 microns are formed due to alignment.

FIG. 19 shows the synthesis of nanowires using magnetic nanoparticles coated with PAN carbon precursors. Acid degradation of cobalt inclusions yield hollow nanowires. Microporosity can be tuned by using SAN-sacrificial polymers as microporogens onto nanoparticles.

FIG. 20 is a schematic of a supercapacitor.

FIG. 21 is a schematic of a electrochemical double layer device.

FIG. 22 shows the synthesis of end-functional polystyrene surfactants using alkoxyamine initiators (1, 3) and preparation of PS-Co nanoparticles TEM of colloids cast onto carbon coated TEM grids confirm that highly uniform and ferromagnetic nanoparticles (D=15 nm±1.5 n) and micron-sized chains were formed from dipolar associations. Nanoparticle chains can be formed by self-assembly (a), or in a field (100 mT) (b) when drop cast onto TEM grids. Higher magnification images (c, d) confirm that uniform polymer coated colloids are formed.

FIG. 23 is a general scheme for ligand exchange and SEC characterization (size exclusion chromatography) of polymer surfactants after HCl degradation of Co colloids Beginning with PS-CoNP (M_{n PS}=5,000 g/mol), ligand exchange with a PMMA-CCOH surfactant (M_{n PMMA}=10,000 g/mol) yielded a PMMA-CoNP. HCl degradation of ligand exchanged colloid and SEC confirmed quantitative functionalization.

FIG. 24 shows the preparation of multifunctional ferromagnetic cobalt colloids via ligand exchange of functional (co)polymer surfactants.

FIG. 25 shows the synthesis of PAN coated ferromagnetic cobalt colloids using ligand exchange. Thin films cast from DMF in a weak field (100 mT) afforded aligned PAN nanoparticle chains. Pyrolysis of thin films yielded carbon nanowires with cobalt colloid inclusions. FE-SEM (filed emission scanning electron microscopy) confirmed 1-D morphology of PAN-Co films (top-right) and in carbon nanowires (bottom-right).

FIG. 26 shows the preparation of metallic cobalt, cobalt oxide and hollow carbon nanowires by oxidation, or acidic dissolution of cobalt nanoparticles in carbonized nanowires.

FIG. 27 shows TEM images of PS-CoNP chains deposited onto carbon coated TEM grids under different conditions to yield to the following morphologies: (a) self-assembled randomly entangled chains cast from toluene (zero-field) (b) aligned PS-CoNP chains cast from toluene under influence of weak magnetic field (100 mT) (c) self-assembled lamellar morphology of PS-CoNP chains cast from a co-solvent mixture (CH₂Cl₂/DCB).

FIG. 28 shows FE-SEM of pyrolyzed PAN-CoNP chains formed into carbon nanowires (a) single nanowire spanning microns in length deposited parallel to graphite substrates using a 300 mT magnetic field, (b) thick films of carbon deposited from DMF with magnetic fields (100 mT) aligned perpendicular to Si substrates. Large micron sized aggregated formed due to perpendicular and lateral assembly of PAN-CoNPs. Higher magnification of cracked edges of thin film reveal nanowires oriented in direction of applied field.

FIG. 29 shows the synthesis of “patchy” magnetic nanoparticles via ligand exchange using PAN and SAN (co)polymers.

FIG. 30 shows C-AFM (contact atomic force microscopy) height and current images rendered with Pt/Ir tip (20 n=2 tip/sample contact area) on graphite.

I-V curves of PAN-CoNP before and after pyrolysis confirm the formation of conductive phases on carbonized materials.

FIG. 31 shows a TEM of PS-CoNP nanoparticles prepared from low-temperature thermolysis of CO₂CO₈ and ligand exchange applied for scale-up synthesis of hybrid materials.

FIG. 32 shows the fabrication of vertically aligned periodical arrays of carbon nanowires via magnetic assembly of PAN-CoNPs in anodized aluminum oxide (AAO) templates, pyrolysis within membrane pores and removal of template.

FIG. 33 shows the synthesis of phosphine oxide functional random copolymers and the preparation of polymer encapsulated cobalt nanoparticles.

FIG. 34 shows a TEM image of cobalt nanoparticles prepared from thermolysis of CO₂CO₈ in the presence of phosphine oxide functional copolymers.

FIG. 35 shows the synthesis of polystyrenic surfactants and ferromagnetic cobalt nanoparticles.

FIG. 36 shows TEM images of ferromagnetic pS-coated cobalt nanoparticles (a) self-assembled by deposition from toluene dispersions onto carbon coated copper grids, (b) cast from toluene dispersion and aligned under a magnetic filed (100 mT), (c) self-assembled single nano-particle chains (d) high magnification image visualizing cobalt colloidal core (dark center) and pS surfactant shell (light halo).

FIG. 37 shows (a) XRD of pS-coated cobalt nanoparticles possessing the fcc phase, (b) VSM of pS-cobalt nanoparticles at 300K (open circles, Ms=400 emu/g, Hc=100) and 40 K (open squares, Ms=400 emu/g, Hc=200)

FIG. 38 shows a TEM image of binary assemblies composed of pS coated cobalt nanoparticles and SiO₂ beads.

FIG. 39 shows random and block copolymers possessing various ligating functional groups used in the synthesis of cobalt nanoparticles.

FIG. 40 shows (a) SEC chromatogram of poly(t-butyl acrylate)-block-polystyrene (Mn=10,000; Mw/Mn=109); (b) SEC chromatogram of poly(styrene-random-(t-butyl acrylate) (Mn=15,000; Mw/Mn=0.12).

FIG. 41 shows TEM of (a) cobalt aggregates formed by the thermolysis of CO₂CO₈ in the presence of poly(styrene-random-(4-vinylphenol)), (b) cobalt nanoparticles prepared from poly(styrene-random-(2-vinylpyridine)), (c) cobalt nanoparticles prepared from poly(acrylic acid)block-polystyrene, (d) cobalt nanoparticle image from (c) at higher magnification. Black bar=100 nm.

FIG. 42 shows (left image) TEM image of ferromagnetic polystyrene coated cobalt nanoparticles deposited onto carbon coated copper grid from dilute toluene nanoparticle dispersion (1 mg/mL). Polystyrene Mₙ=5,000 g/mol; M_{w}/Mₙ=1.10; particle size cobalt core=15 nm+1.5 n; thickness of polystyrene shell=2 nm, total diameter=19 nm. (right image): tapping mode atomic force microscopy image of same ferromagnetic nanoparticles.

FIG. 43 shows a TEM image of a binary colloidal assembly of silica nanoparticles (particle size=170 nm) and ferromagnetic polystyrene nanoparticles (details same as for FIG. 42).

FIG. 44 is a scheme (top): different arrangements of polymeric coatings on nanoparticles, (top-left)-end tethered polymers on nanoparticle surface forming “hairy nanoparticle,” (top-center)-dense crosslinked polymer shell around nanoparticle, “shell-crosslinked nanoparticle,” (top-right)-combination of two previous architectures, multi-layer core-shell nanoparticle with dense crosslinked inner layer and “hairy” outer layer (bottom-left): scheme of magnetic nanoparticle surface with single polymer chain coordination to surface, (bottom-right): description in words of kinds of functional groups and polymers that can be introduced to ferromagnetic nanoparticles.

FIG. 45 shows (left) Dark-field TEM images of cobalt nanoparticles (10 nm) with 2 nm cobalt oxide layer that is antiferromagnetic (i.e., “non-magnetic”). (right) high resolution/magnification TEM image of same Co nanoparticles.

FIG. 46 shows four TEM images of different sizes of magnetic nanoparticles used as the storage media for magnetic tape.

FIG. 47 shows another TEM of magnetic nanoparticles that are ball milled in attempt to obtained particles of smaller size. Significant aggregation, bottom scheme is scheme of process.

FIG. 48 shows two general types of storage media for magnetic tape: (left) particulate media is composed of magnetic nanoparticles blended in polymer thin film (right) evaporative media is continuous metallic thin film of magnetic material (e.g. cobalt).

FIG. 49 shows a TEM image of ferromagnetic polystyrene cobalt nanoparticles and single nanoparticle chain formed on carbon coated TEM grid.

### DETAILED DESCRIPTION OF THE INVENTION

The present invention provides a modular approach for the controlled synthesis of, for example, mesoscopic one-dimensional (1-D) structures. Magnetic associations are used to controllably assemble hybrid building blocks comprising organic polymers and metallic nanoparticles. The metallic nanoparticles are coated with the organic polymers resulting in metallic nanoparticles coated with a polymer shell. This material is also referred to as a nanocomposite or hybrid nanocomposite. Preferably functional polymers and/or copolymers are used as surfactants to prepare magnetic nanoparticles having a particle size of 1-200 nm preferably 2-100 n, more preferably 5-50 nm and most preferably about 20 nm. The copolymer surfactant becomes a functional coating around the magnetic nanoparticle. The particle diameter of the metallic nanoparticle includes all values and subvalues therebetween, especially including 2, 4, 6, 8, 10, 12, 14, 16, 18, 20, 22, 24, 26, 28, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190 and 195 nm.

The metallic nanoparticles are preferably in colloidal form, more preferably functional magnetic colloids which are organized into chain-like structures spanning nanometers to microns in length in the presence of an external magnetic field, or by self-assembly from the dipolar associations of ferromagnetic colloids.

The organic polymers are not particularly limited. The term “polymer” includes homopolymers and copolymers comprising polymerized monomer units of two or more monomers. Preferred organic polymers include homopolymers, copolymers, random polymers block copolymers, dendrimers, statistical polymers linear, branched, star-shaped, dendritic polymers, segmented polymers and graft copolymers. Preferred polymers include polymers containing in polymerized form ethylenically unsaturated monomer units, N-functional polymers, (meth)acrylates, vinyl polymers, conjugated polymers such as polythiophene, styrenic polymers, polyethylene glycol, polysiloxanes, polyethylene oxide, hydroxyethyl(meth)acrylate, dimethylaminoethyl(meth)acrylate, polyacrylonitrile, polystyrene, PMMA, polypyrroles, proteins, peptides, fluorescent polymers, each of which can be substituted or unsubstituted with for example a linear or branched alkyl group having 1 to 24 C-atoms. Two or more polymers may be combined as blends or in copolymers.

The polymers may be crosslinked using known crosslinkers such as monomers having at least two ethylenically unsaturated groups or alkoxysilanes.

The polymer surfactants of the present invention may be combined with small molecule surfactants such as oleyl amine, oleic acid and TOPO. In addition, small molecule surfactants may be used instead of the polymers described above.

The polymer shell may be one layer or a combination of two or more layers.

The metallic core is not particularly limited. Preferred examples include magnetic or ferromagnetic metallic cores, including combinations of two or more metals, semi-metals, metal oxides, or doped metal oxides in the core. Further, preferred cores contain Co, Ni and/or Fe, alone or in combination, optionally in combination with at least one metal selected from Ti, V, Cu, Zn, Zr, Mo, Ru, Rh, Ag, Au, Pt, Re, Ir, Os, Cr, Nb, Hf, Ta and W. The metallic core can contain metal alloys or transition metal-metalloid alloys containing Fe, Co, or Ni in combination with for example B, C, Si, P, or Al. Other ferromagnetic materials include ZnZr. Other materials for the core include metal oxides such as magnetite (Fe₃O₄), maghemite (Fe₂O₃), cobalt ferrite (CoFe₂O₄) and manganese ferrite (MnFe₂O₄). The core may contain semi-metals such as bismuth, magnetic oxides such as perovskites, including manganate perovskite. Doped metal oxides can also be used.

The polymer coated nanoparticles are preferably polymer coated ferromagnetic nanoparticles having a range of saturation magnetization of 10-100 emu/g, a coercivity range of 100-2000 Oe at room temperature. The saturation magnetization includes all values and subvalues therebetween, especially including 20, 30, 40, 50, 60, 70, 80 and 90 emu/g. The coercivity includes all values and subvalues therebetween, especially including 200, 300, 400, 500, 600, 700, 800, 900, 1000, 1100, 1200, 1300, 1400, 1500, 1600, 100, 1800 and 1900 Oe.

Particularly preferred polymer shells contain polystyrenics, poly(methacrylate), polyacrylates, polyacrylonitrile, vinylic derived polymers, conjugated polymers such as polythiophene, polypyrrole, polyaniline.

The number average molecular weight of the polymer shell is not particularly limited but is preferably Mn=100 to 100,000 g/mol, preferably Mn=1,000 to 50,000 g/mol. The Mn includes all values and subvalues therebetween, especially including 500, 1000, 2000, 3000, 4000, 5000, 6000, 7000, 8000, 9000, 10000, 15000, 20000, 25000, 30000, 40000, 50000, 60000, 70000, 80000, and 90000 g/mol.

The polydispersity of the polymers of the shell (Mw/Mn) is not particularly limited, however, Mw/Mn=1.05 to 2.0, preferred is Mw/Mn=1.05 to 1.20. The polydispersity includes all values and subvalues therebetween, especially including 1.1, 1.15, 1.2, 1.3, 1.4, 1.5, 1.6, 1.7, 1.8 and 1.9.

The weight ratio between core and shell is 10-90 wt % of core and 90-10 wt % of shell based on the weight of the nanoparticle. The amount of core includes all values and subvalues therebetween, especially including 20, 25, 30, 35, 40, 45, 50, 55, 60, 65, 70, 75, 80 and 85 wt %. The shell includes all values and subvalues therebetween, especially including 20, 25, 30, 35, 40, 45, 50, 55, 60, 65, 70, 75, 80 and 85 wt %.

The diameter of the core is in the range of 1-100 nm, preferably 10-50 nm. The thickness of the shell is in the range of 2-20 nm The diameter of the core includes all values and subvalues therebetween, especially including 5, 10, 15, 20, 25, 30, 35, 40, 45, 50, 55, 60, 65, 70, 75, 80, 85, 90 and 95 nm. The thickness of the shell includes all values and subvalues therebetween, especially including 4, 6, 8, 10, 12, 14, 16 and 18 nm.

Preferably, the polymer of the shell is functionalized using groups to impart specific properties such as hydrophobic, hydrophilic, rubbery, glassy, fluorescent, electro-active, conductive electrical, heat). Other preferred functional groups include polyelectrolyte functional groups, bio-conjugates such as proteins and peptides, coordinating functional groups such as alcohols, amines, thiols, hetero-atom functional groups, fluorinated groups and chromophores. Fluorescent groups include but are not limited to pyrenes, fluorescene, anil-red, pyrroline. Polyelectrolyte functional groups include but are not limited to carboxylates, polyacrylic acid, polystyrene sulfonate, and ammonium salts Preferred functional groups include carboxylic acid groups, amines, alcohols, nitrites, aromatics, alkyl esters, protected esters, silyl protected alcohols and carboxylic acids, siloxanes, silanes, amides, activated esters, alkyl halides, alkoxyamines, thioesters, protected phenols, acetals, vinylic groups, pyridines, phenols, phosphine oxides, pyrenes and their combinations. Preferred ligating groups include carboxylic acids, amines, nitrites, alcohols, phosphines and phosphine oxides. Two or more functional groups may be combined. Various ligating, crosslinking and property modifying groups may be used in one polymer.

The functional groups may be introduced into the main chain, side chain of the polymers or as an end-group of the main chain or side chain.

The functional groups and their combinations are preferably selected for their compatibility with the core and the remainder of the polymer structure. For example, functional side chain groups in the copolymer should not compete with the ligating end-group for coordination to the nanoparticle surface. Additionally, crosslinkable groups in this system can be thermally stable to survive the particle forming thermolysis reaction.

Functional groups may be introduced into the polymeric surfactant before the preparation of the coated nanoparticle or by using post-functionalization of the polymer shell of a polymer coated nanoparticle.

In a preferred embodiment, the polymer coated nanoparticles are used alone or as a dispersion in aqueous solvents, organic solvents or a polymer matrix. Preferred aqueous solvents include water, mixtures of water with alcohols such as ethanol and methanol and mixtures of water with other polar solvents. Preferred organic solvents include toluene, THF, dichloromethane, acetone, DMF, ethanol, methanol. Preferred polymers for the polymer matrix are those described above for the preparation of polymer shells.

The polymer coated nanoparticles may be arranged into one-dimensional (1-D), two-dimensional (2-D) or three-dimensional (3-D) structures. Preferred structures include chain-like structures and bracelets. The arrangement may be a result of self-assembly or binding through covalent bonds. The arrangements may be oriented in an electric or magnetic field.

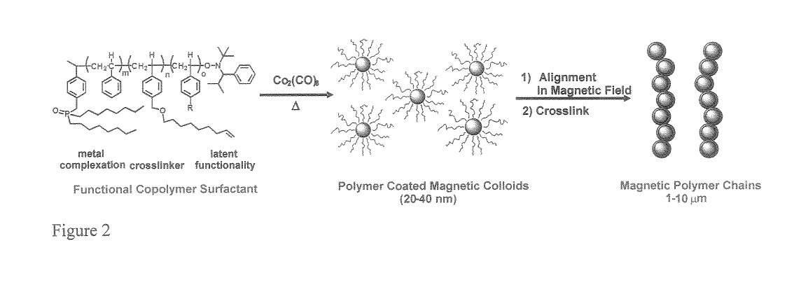

In a preferred embodiment, the encapsulation of the polymer shell around the magnetic colloidal core allows for control of nanocomposite properties and the installation of latent functionality. The 1-D associations induced from the magnetic dipole moments of the colloidal core are a selective mechanism to organize the polymer-coated colloids of the present invention into linear assemblies (FIG. 2). Activation of latent crosslinkable functionality in aligned magnetic colloids is achieved to form covalently linked magnetic chains. In these systems, assembly of colloids into chains is dictated by the magnetic properties of the core and is independent of the surface functionality of the copolymer shell. By the hybridization of organic polymers and inorganic colloids on the nanoscale, nanocomposite materials are accessible that possess both the high functionality and processing character of polymers, while retaining high magnetic susceptibility at room temperature.

The present invention describes the development of new synthetic methodologies to prepare functional, polymer coated nanoparticles. Controlled radical polymerizations and dendrimer chemistry are used to synthesize functional copolymers as surfactants in the preparation of magnetic colloidal dispersions of the present invention. By precise control of copolymer functionality with ligands for metal nanoparticle passivation and reactive groups for crosslinking, a wide array of functional colloidal dispersions can be prepared. Magnetic alignment of dispersed colloids followed by crosslinking of functional groups in the copolymer shell yield magnetic polymer chains containing covalently linked nanoparticle repeating units. The controllable functionalization of magnetic nanoparticles is a step toward many applications for biotechnology and microelectronics. Further, the assembly of functional nanoparticles via magnetic dipolar associations is a novel “bottom-up” approach to preparing complex hybrid mesostructures possessing novel mechanical and magnetic properties.

The preparation of a library of colloidal building blocks is achieved by in situ formation with functional polymer and copolymers, and postfunctionaiization of preformed magnetic colloids with the polymers described above, including dendron-coil copolymers.

The materials of the present invention can be used in flexible magnetic storage and magnetorheological fluids.

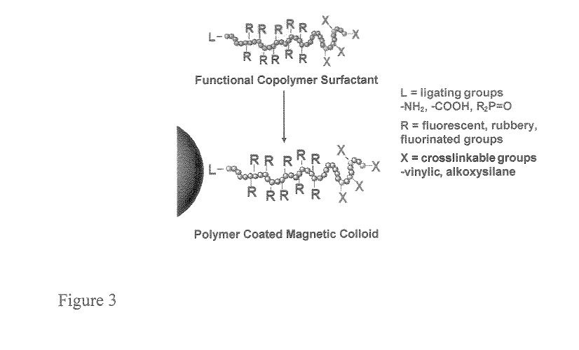

The polymer coated nanoparticles of the present invention are preferably polymer coated magnetic colloids. The polymer coated nanoparticles can be prepared by reacting metal carbonyl compounds (coordination complexes of transition metals with carbon monoxide) such as dicobalt octacarbonyl, nickel tetra carbonyl, iron pentacarbonyl or mixtures of different metal carbonyls in the presence of a polymer surfactant. The reaction temperatures range for these reactions is in the order of 100 to 250° C. The reaction temperature includes all values and subvalues therebetween, especially including 110, 120, 130, 140, 150, 160, 170, 10, 190, 200, 210, 220, 230 and 240° C. The polymer surfactant contains preferably a metal complexation crosslinker and a latent functionality as described above. See for example FIG. 2. In addition, another functional group as described above, such as a fluorescent, glassy, rubbery group may be present. See for example FIG. 3. Each of the crosslinkable, the ligating and the other functional group may be present in the main chain, side chain or as a terminal group in the polymers of the present invention.

Methods of making the nanoparticles according to the present invention include: decomposition of metal carbonyl complexes, and “poly-ol” reduction of metal salts such as (Fe(II) acetylacetonate, Co(II) acetylacetonate with reducing agent such as 1,2-hexadecanediol, hydrazine, DMF. For example, bimetallic metal alloys of FePt, CoPt can be obtained via reduction of metal salts.

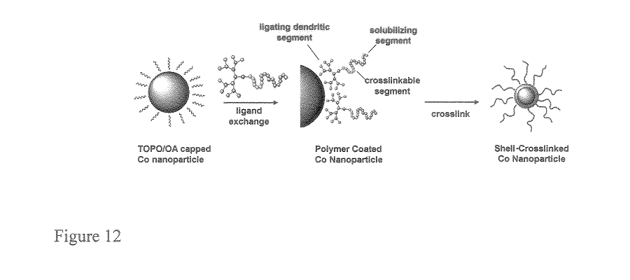

Functional polymers can also be synthesized using known polymerization techniques to prepare polymer coated ferromagnetic nanoparticles. Various functionalities can be introduced onto the magnetic nanoparticle as an organic shell coating via functionalization of polymer surfactants coordinated onto magnetic nanoparticle surface. Exchange of different polymers onto magnetic nanoparticles can also be achieved with ligand exchange reactions using ligands that have a higher affinity toward the core than the ligands already attached to the core. See for example FIG. 12. This method is particularly important to incorporate sensitive and reactive functional groups that cannot survive the higher temperatures required for formation of ferromagnetic nanoparticles. In the ligand exchange, preferably carboxylic acid ligands displace pre-coordinated amine and phosphine oxide ligands. Preferably, the ligand exchange proceeds in non-polar organic solvents commensurate with polymeric surfactants used for ligand exchange functionalization. Examples of the solvents include tetrahydrofuran, toluene, benzene, xylene, chlorobenzene, dichlorobenzene, dichloromethane, chloroform, acetone, ethyl acetate, butanol, ethanol, methanol. Mixtures of solvents may be used. The reaction temperature can be from room temperature to the boiling point of the solvent used.

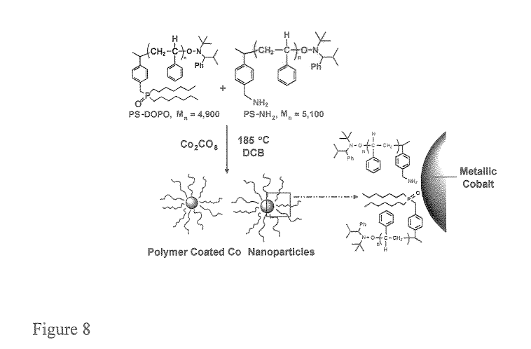

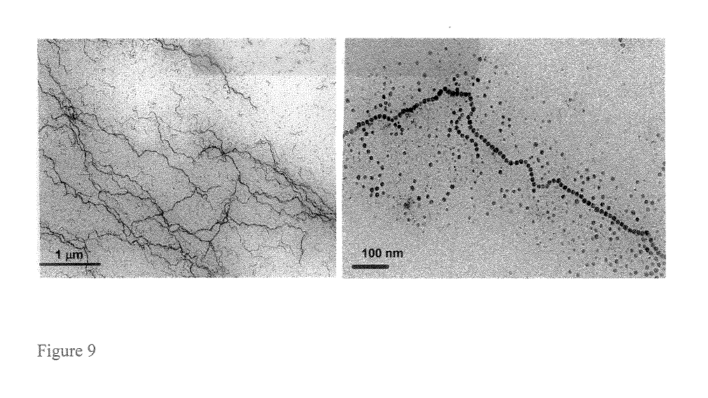

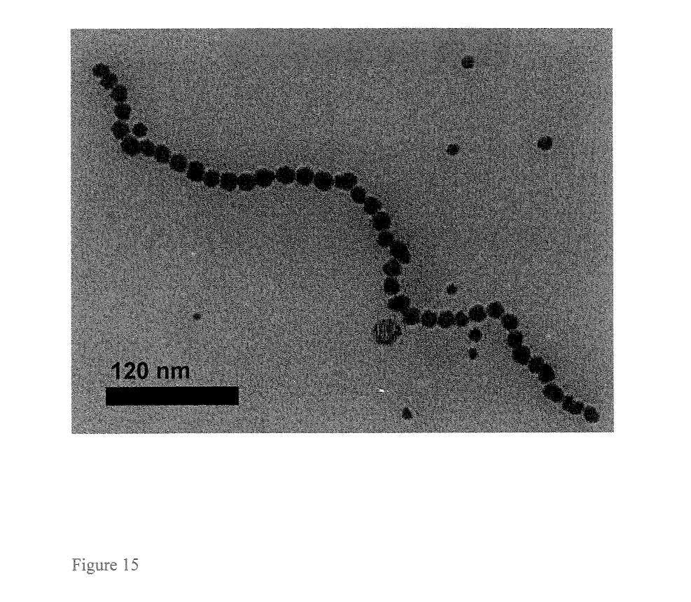

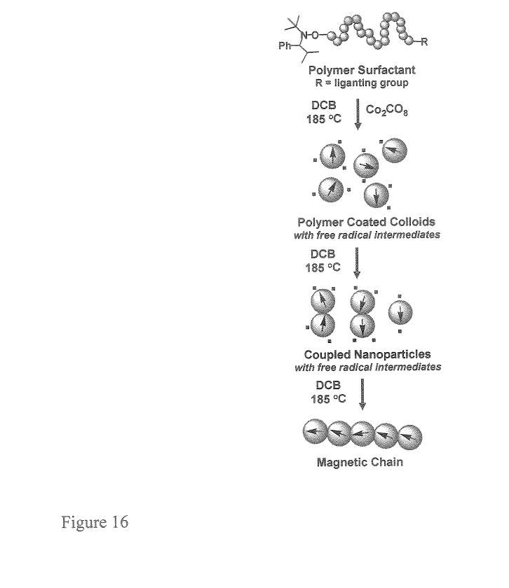

In preparing polymer coated nanoparticles, the inventor of the present invention has founds a one-pot synthesis of mesoscopic chains from polymers surfactants. See for example FIG. 8. Polymer coated nanoparticles are prepared by the thermolysis of metal carbonyls that readily form micron sized 1-D assemblies when cast onto surfaces. See for example FIG. 9. The presence of discrete nanoparticle chains is shown for example in FIG. 15. These robust chains are stable to thermal annealing (at least 200° C.) and remain intact despite deposition via coating on surfaces, including spin coating at high spinning speeds (about 4000 rmp) Obtained magnetic chains are responsive to weak external fields from standard horseshoe magnets and align into rigid rods in the direction of the applied field. Mesoscopic magnetic chains can be synthesized in the absence of an applied field due to the formation of free radicals on nanoparticles, and their preferential 1-D associations from magnetic dipoles (FIG. 16). Metal colloids can be generated within 10 seconds to 10 minutes in the thermolysis of metal carbonyls. The reaction time includes all values and subvalues therebetween, especially including 20, 30, 40, 50, 60 seconds, 1.5, 2, 2.5, 3, 35, 4, 4.5, 5, 5.5, 6, 6.5, 7, 7.5, 8, 8.5, 9 and 9.5 minutes.

In the preparation of the nanoparticles according to the present invention by the pyrolysis of metal carbonyls, a variety of surfactants can be used as described above and further including trioctylphosphine oxide, oleic acid/oleyl amine mixtures, resorcinerenes and organic copolymers, block and random copolymers possessing pyrrolidone, pyridine, cyano, and alkynyl groups using cationic, anionic and free radical methodologies to allow efficient passivation of growing metal complexes and nanoparticle surfaces.

In the present invention, further processing of polymer coated magnetic, nanoparticles into chains, or thin films of chains can be achieved by solution deposition, spin coating, spray coating layer-by-layer self assembly, thermal vapor deposition, chemical vapor deposition, Langmuir-Blodgett techniques onto flat substrates. The thickness of the thin films is from 0.01 to 1000 μm, preferably, 0.05 to 500 μm, more preferably 0.1 to 100 μm, even more preferably 1 to 50 μm and most preferably 1 to 10 μm. The film thickness includes all values and subvalues therebetween, especially including 0.05, 0.1, 0.5, 1, 5, 10, 20, 30, 40, 50, 60, 70, 80, 90, 100, 150, 200, 250, 300, 350, 400, 450, 500, 550, 600, 650, 700, 750, 800, 850, 900 and 950 μm.

In another embodiment, the obtained polymer coated magnetic colloids are aligned using a magnetic field or self-assembly and then optionally crosslinked via crosslinking groups contained in the polymers of the shells of the nanoparticies. Crosslinking can occur using UV, radical initiators or thermally. The magnetic field used for aligning the polymer coated magnetic colloids is in the range of 0.01 to 5 T, preferably 0.1 to 2 T. The strength of the magnetic field includes all values and subvalues therebetween, especially including 0.05, 0.1, 0.5, 1, 1.5, 2, 2.5, 3, 3.5, 4 and 4.5 T.

The magnetic chains may also be blended with additional polymer materials using any of the polymers described above for the polymer shell.

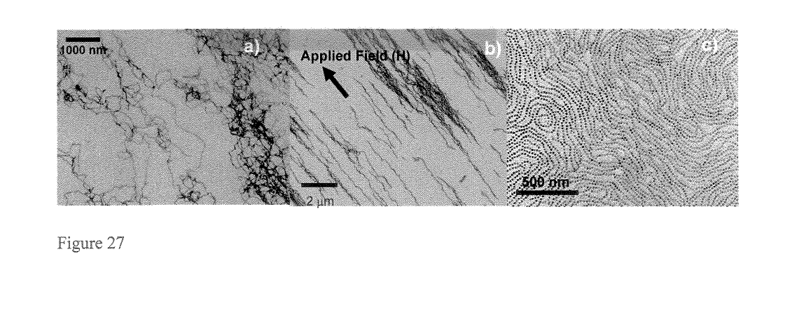

1-D nanoparticle chains have length of from 20 nm to 20 microns. The length includes all values and subvalues therebetween, especially including 30, 40, 50, 60, 70, 80 90, 100, 150, 200, 250, 300, 350, 400, 450, 500, 550, 600, 650, 700, 750, 800, 850, 900, 950, 1000, 1500, 2000, 2500, 3000, 3500, 4000, 4500, 5000, 5500, 6000, 6500, 7000, 7500, 8000, 8500, 9000, 9500, 10000, 11000, 12000, 13000, 14000, 15000, 16000, 17000, 18000 and 19000 nm. Nanoparticle chains can be organized into the following morphologies (see for example FIG. 27):

a) randomly entangled networks of chains

b) rigidly aligned chains

c) folded, lamellae-like chains.

### PREFERRED EMBODIMENTS OF THE PRESENT INVENTION

### Synthesis of Functional Copolymer Surfactants

Copolymer Design. The general concept behind the design of copolymer surfactants according to the present invention is to incorporate functional ligating moieties into well-defined macromolecules for the stabilization of magnetic cobalt colloids. Polymeric surfactants have the ability to synthesize and stabilize magnetic colloids.

However, so far the use of a polymer platform to introduce other useful functionality to the nanoparticles, preferably magnetic nanoparticles has not been described.

In the present invention, multifunctional copolymers are prepared to create an “all-in-one” surfactant system that incorporates coordinating and orthogonal functionality onto a single macromolecule. Polymer and copolymer surfactants according to the present invention are prepared targeting the installation of functional groups as described above, for example, ligating, crosslinkable and other “property-modifying” groups, such as, fluorescent dyes, fluorinated groups and rubbery/glassy segments (FIG. 3). In one embodiment of the present invention, these well-defined, highly functional polymers and copolymers can be synthesized using a combination of controlled radical polymerization and convergent dendrimer synthesis.

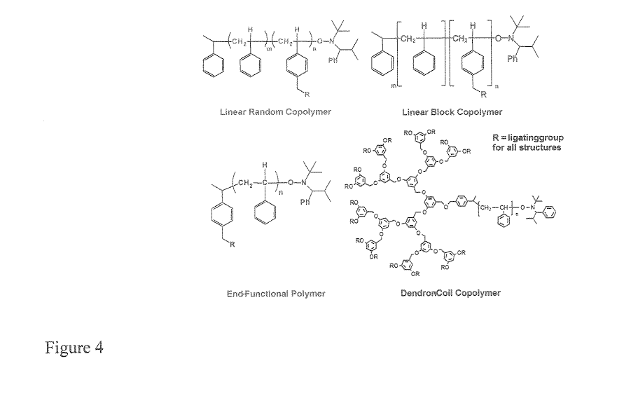

Synthesis of Linear and Dendron-Coil Copolymer Surfactants. Functional copolymer surfactants possessing linear and dendritic architectures can be synthesized as illustrated in FIG. 4. A wide range of monomers is copolymerized to attach various end-, or side chain functional groups into copolymer surfactants. The monomers include ethylenically unsaturated monomers, N-functional monomers, (meth)acrylates, vinyl momomers, thiophene, styrenic monomers, polyethylene glycol, polysiloxanes, ethylene oxide, hydroxyethyl(meth)acrylate, dimethylaminoethyl(meth)acrylate, acrylonitrile, pyrroles, each of which can be substituted or unsubstituted with for example a linear or branched alkyl group having 1 to 24 C-atoms. Two or more monomers may be combined. Preferred are styrenic or acrylate monomers.

Polymers as described above, including linear, random and block copolymers are synthesized using controlled radical polymerization, preferably nitroxide mediated polymerization. The versatility of these systems, particularly those based on the α-hydrido nitroxides and alkoxyamines of Hawker et al, (Benoit. D., Chaplinski, V.; Braslau, R. Hawker, C. J., Development of a Universal Alkoxyamine for \“Living\” Free Radical Polymerizations. Journal of the American Chemical Society 1999, 121, (16), 39043920) makes this method an attractive route to prepare highly functional surfactants for magnetic nanoparticles. A particularly attractive feature of these alkoxyamine initiators is their facile functionalization with a wide range of groups, allowing the synthesis of well-defined end-functional polymers. Additionally, dendron-coil copolymers possessing ligating groups on the dendron periphery can be synthesized and evaluated as a novel surfactant for the passivation of cobalt colloidal surfaces (Gitsov, I.; Frechet, J. M. J., Solution and solid-state properties of hybrid linear-dendritic block copolymers. Macromolecules 1993, 26, (24), 6536-46; Gitsov, I.; Wooley, K. L.; Hawker, C. J.; Ivanova, P. T.; Frechet, J. M. J., Synthesis and properties of novel linear-dendritic block copolymers. Reactivity of dendritic macromolecules toward linear polymers. Macromolecules 1993, 26, (21), 5621-7; Leduc, M. R.; Hawker, C. J.; Dao, J.; Frechet, J. M. J., Dendritic initiators for \“living\” radical polymerizations: a versatile approach to the synthesis of dendritic-linear block copolymers. Journal of the American Chemical Society 1996, 118, (45), 11111-11118; Zubarev, E. R.; Pralle, M. U.; Sone, E. D.; Stupp, S. I., Self-Assembly of Dendron Rodcoil Molecules into Nanoribbons. Journal of the American Chemical Society 2001, 123, (17), 4105-4106; Zubarev, E. R.; Stupp, S. I., Dendron Rodcoils: Synthesis of Novel Organic Hybrid Structures. Journal of the American Chemical Society 2002, 124, (20), 5762-5773; Lecommandoux, S.; Klok, H.-a.; Sayar, M.; Stupp, S. I., Synthesis and self-organization of roddendron and dendron-rod-dendron molecules. Journal of Polymer Science, Part A: Polymer Chemistry 2003, 41, (22), 3501-3518; Johnson, M. A.; Iyer, J.; Hammond, P. T., Microphase Segregation of PEO-PAMAM Linear-Dendritic Diblock Copolymers. Macromolecules 2004, 37, (7), 2490-2501; Santini, C. M. B.; Johnson, M. A.; Boedicker, J. Q.; Hatton, T. A.; Hammond, P. T., Synthesis and bulk assembly behavior of linear-dendritic rod diblock copolymers. Journal of Polymer Science, Part A: Polymer Chemistry 2004, 42, (11), 2784-2814; Pyun, J.; Tang, C.; Kowalewski, T.; Frechet, J. M. J.; Hawker, C. J., Synthesis and Direct Visualization of Block Copolymers Composed of Different Macromolecular Architectures. Macromolecules 2005, 38, (7), 2674-2685).

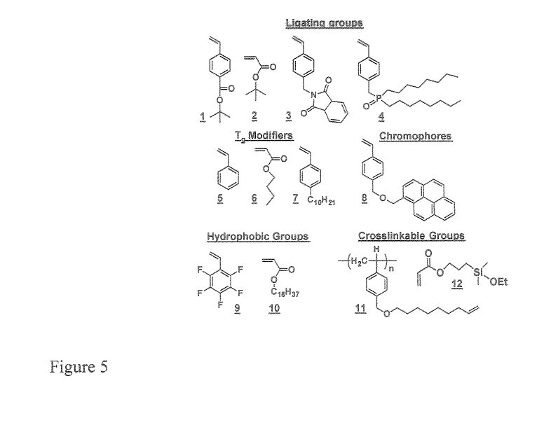

Functional comonomers. The preparation of a library functional surfactants is achieved, for example, by the copolymerization of styrene, acrylate monomers or any of the above mentioned monomers with the various comonomers shown in FIG. 5 or any of the above mentioned monomers.

In a preferred embodiment, metal complexing segments are incorporated by the controlled radical polymerization with comonomers 1-4. Carboxylic acid functional copolymers can be readily obtained after the copolymerization and deprotection of 1 and 2, while amine groups are attached by the copolymerization of 3 followed by treatment with hydrazine. Styrenic monomer 4 can be synthesized to mimic trioctylphosphine oxide (TOPO) (Skaff H.; Ilker, M. F.; Coughlin, E. B.; Emrick, T., Preparation of Cadmium Selenide-Polyolefin Composites from Functional Phosphine Oxides and Ruthenium-Based Metathesis. Journal of the American Chemical Society 2002, 124, (20), 5729-5733).

The glass transition (T_{g}) of copolymers can be controlled by copolymerization with either styrene (5), n-butyl acrylate (6), or decyl styrene (7) to impart either glassy, or rubbery properties to the surfactant and to magnetic cobalt colloids (Quirk, R. P.; Ok, M.-A., Syndiospecific Synthesis of Longer p-n-Alkyl-Substituted Polystyrenes Using Monocyclopentadienyl-Type Titanium Catalysts. Macromolecules 2004, 37, (11), 3976-3982).

The bulk properties of the surfactant and polymer coated nanoparticles can be modified by the introduction of styrenic chromophore 8 which allows the characterization of nanoparticles via UV spectroscopy (Danko, M.; Hrdlovic, P.; Borsig E., Quenching of pyrene fluorescence as a technique for characterization of swelling of interpenetrating polymer network: polyethylene/poly(styrene-co-butyl methacrylate). European Polymer Journal 2003, 39, (11), 2175-2182). Hydrophobic groups can be incorporated by the copolymerization of pentafluorostyrene (9), or stearyl acrylate (10).

Copolymer surfactants possessing crosslinkable moieties can be prepared to allow covalently linking of assembled magnetic nanoparticles. The attachment of side-chain vinyl groups can be achieved by the copolymerization of 4-vinylbenzyl chloride, and subsequent alkylation with 9-nonen-1-ol to afford reactive segment 11. Crosslinking of these dangling vinyl bonds can be activated by ruthenium-alkylidine catalyzed cross-metathesis reactions, or by platinum catalyzed hydrosilation in the presence of multifunctional silanes (Grubbs, R. H., Olefin metathesis Tetrahedron 2004, 60, 34) 7117-7140; Meals, R. N., Hydrosilation in the synthesis of organosilanes, Pure and Applied Chemistry 1966, 13, (1-2), 141-57). Alternatively, direct copolymerization of acrylate 12 can allow the installation of reactive alkoxysilanes to copolymer surfactants. Crosslinking reactions can then be triggered by the addition of dibutyltin dilaurate and water to catalyze for formation of siloxane bonds (Connolly, J.; St. Pierre, T. G.; Rutnakornpituk, M.; Riffle, J. S., Cobalt nanoparticles formed in polysiloxane copolymer micelies: Effect of production methods on magnetic properties. Journal of Physics D: Applied Physics 2004, 37 (18), 2475-2482.) 4-methylstyrene units can be incorporated as a latent crosslinking agent, where free radical induced coupling reactions of tolyl groups can be initiated in the presence of benzoyl peroxide (Pini, D.; Settambolo, R.; Raffaelli, A.; Salvadori, P., Conformational control of benzylic radical bromination in polymers from methylstyrenes, Macromolecules 1987, 20, (1), 58-62).

Linear random and block copolymers. Well-defined random and block copolymers containing functional groups as described above and preferably primary amines, carboxylic acids, pyridines, phenols, or phosphine oxides can be synthesized and tested for their viability as surfactants for magnetic cobalt colloids. Preferably, nitroxide mediated polymerizations are used to prepare these functional polymers and copolymers which possess molecular weights Mn=100 to 100,000 g/mol, preferably Mn=1,000 to 50,000 g/mol. The Mn includes all values and subvalues therebetween especially including 500, 1000, 2000, 3000, 4000, 5000, 6000, 7000, 8000, 9000, 10000, 15000, 20000, 25000, 30000, 40000, 50000, 60000, 70000, 80000, and 90000 g/mol.

Most preferably, the molecular weight Mn is 20,000 g/mol. The amount of ligating segment is 5 to 10-mol % based on the amount of polymer. In this molecular weight and composition regime, carboxylic acid, amines and phosphine oxide containing polymers and copolymers sufficiently passivate cobalt nanoparticles yielding stable colloidal dispersions. However, the nanoparticle core is not limited and includes the examples discussed above. Further, high molar mass random and block copolymers (Mₙ>100,000 g/mol) based on 2-vinylpyrrolidone, or 4-vinylpyridine can be synthesized. While copolymers of high molar mass (Mₙ>100,000 g/mol) are not readily accessible using controlled radical polymerization; according to the present invention, well-defined functional random and block copolymers in this size regime are obtained via a nitroxide mediated process, followed by fractionation. The fractionation is performed via selective precipitation in a mixture of good and poor solvents. It is further possible to prepare random and block copolymer surfactants incorporating a wider range of functionalities, as shown in FIG. 3.

End-functional polymers. The number average molecular weight of the end-functional polymers is not particularly limited, a suitable range is Mn from 1,000 up to 50,000 g/mol.

Preferred low molecular weight polymers (Mₙ<5,000 g/mol) with a single ligating end-group can be synthesized using nitroxide mediated polymerization with functional alkoxyamines. The preparation of end-functional polymers bearing functional groups as described above, preferably primary amines, carboxylic acids, or phosphine oxides creates polymeric surfactants that can mimic the functionality of small molecule surfactants, such as, oleyl amine, oleic acid and TOPO. These particular compounds have proven to be excellent passivating agents in the synthesis and stabilization of, for example, magnetic cobalt nanoparticles.

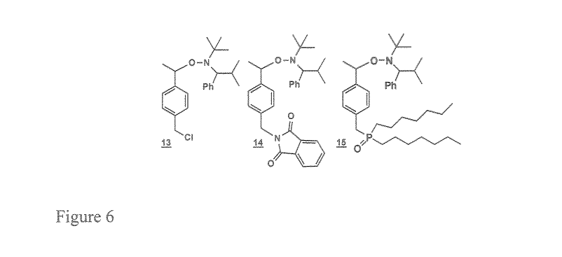

For example, the following alkoxyamines 13-15 (FIG. 6) have been synthesized as a route to prepare amine and phosphine oxide end-functional polystyrene. The synthesis of amine functional PS was achieved by alkylation of benzyl chloride functional alkoxyamine 13 with potassium phthalimide yielding alkoxyamine 14, which was then used as an initiator in the polymerization of syrene (Sty). Deprotection of the phthalimide group using hydrazine afforded a well-defined amine end-functional polystyrene (PS-NH₂, M_{n SEC}=4,900; M_{w}/Mₙ=1.09) Phosphine oxide terminal polystyrene (PS-DOPO, M_{nSEC}=5,100; Mw/Mn=1.10) is synthesized using a similar strategy via the alkylation of alkoxyamine 13 with dioctylphosphine oxide yielding 15, followed by the controlled polymerization of styrene. Copolymerization of styrenic and various comonomers using alkoxyamines 14 & 15 can be conducted as a facile route to introduce functionality to polymeric surfactants and to magnetic nanoparticles. These end-functional copolymers can be used as surfactants in the synthesis and stabilization of metallic nanoparticles, preferably cobalt nanoparticles. Dendron-coil copolymers. Dendrimers and functional dendrons have been prepared for a number of different applications, and have been recently used as ligands for the synthesis and stabilization of various inorganic nanoparticies (Astruc, D.; Chardac, F., Dendritic Catalysts and Dendrimers in Catalysis. Chemical Reviews 2001, 101, (9), 2991-3023; Frechet, J. M. J., Dendrimers and other dendritic macromolecules: From building blocks to functional assemblies in nanoscience and nanotechnology. Journal of Polymer Science, Part A: Polymer Chemistry 2003, 415 (23), 3713-3725; Boas, U.; Heegaard, P. M. H., Dendrimers in drug research. Chemical Society Reviews 2004, 33, (1), 43-63; Crooks, R. M.; Zhao, M.; Sun, L.; Chechik, V.; Yeung, L. K. Dendrimer-Encapsulated Metal Nanoparticles: Synthesis, Characterization, and Applications to Catalysis. Accounts of Chemical Research 2001, 34, (3), 181-190; Gopidas, K. R.; Whitesell, J. K.; Fox, M. A., Synthesis, Characterization, and Catalytic Applications of a Palladium-Nanoparticle-Cored Dendriner. Nano Letters 2003, 3, (12), 1757-1760; Gopidas, K. R.; Whitesell, J. K.; Fox, M. A., Metal-Core-Organic Shell Dendrimers as Unimolecular Micelles. Journal of the American Chemical Society 2003, 125, (46), 14168-14180; Huang, B.; Tomalia, D. A., Dendronization of gold and CdSe/cdS (core-shell) quantum dots with tomalia type, thiol core, functionalized poly(amidoamine) (PAMAM) dendrons. Journal of Luminescence 2005, 111, (4), 215-223; Scott, R. W. J.; Wilson, O. M.; Crooks, R. M., Synthesis, Characterization, and Applications of Dendrimer-Encapsulated Nanoparticles. Journal of Physical Chemistry B 2005, 109, (2), 692-704).

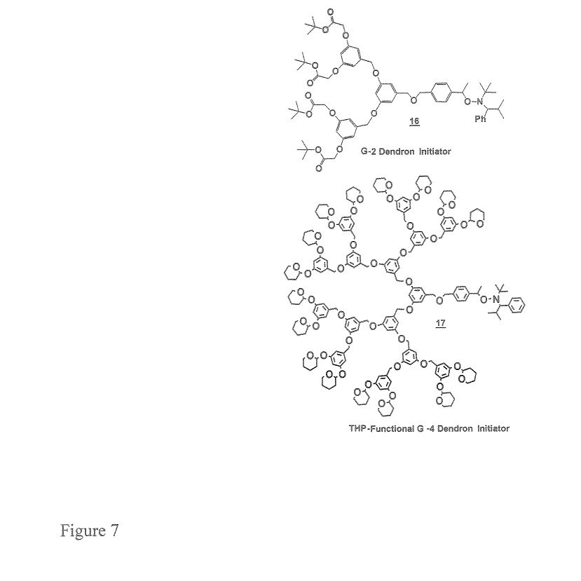

In many of these systems, passivation of the nanoparticle was achieved by attachment of a ligand to the focal point of the dendron, while the dendritic periphery was decorated with solubilizing groups to allow steric stabilization of colloidal dispersion (Kim, M.; Chen, Y.; Liu, Y.; Peng, X., Super-stable, high-quality Fe3O4 dendron-nanocrystals dispersible in both organic and aqueous solutions. Advanced Materials (Weinheim, Germany) 2005, 17, (11), 1429-1432; Wang, R.; Yang, J.; Zheng, Z.; Carducci, M. D.; Jiao, J.; Seraphin, S., Dendron-controlled nucleation and growth of gold nanoparticles Angewandte Chemie, International Edition 2001, 40, (3), 549-552). However, the utilization of the dendron periphery as a multivalent ligand to passivate nanoparticle surfaces has not yet been explored, most likely due to the both challenges associated with the functionalization of terminal dendritic groups and the limited solubility of these compounds in nonpolar media. To overcome these limitations, dendron-coil copolymer surfactants for the passivation of cobalt nanoparticles are prepared, where ligating groups (e.g., NH₂—COOH) can be attached to the dendron periphery and various functionality can be incorporated in the linear coil segment. In this surfactant system, the binding affinity of the dendron segment toward cobalt nanoparticle surfaces can be precisely tuned by variation of the generation and the number of terminal ligating groups. Concurrently, the linear segment can be designed to impart solubility to the copolymer and the final magnetic nanoparticle, while allowing for the installation of useful functional groups to the polymeric shell of cobalt colloids. Dendron-coil copolymers can be synthesized using a convergent approach to prepare a functional Fréchet-type dendron (a benzyl ether based dendron), where an alkoxyamine for controlled radical polymerization can be placed at the focal point, and ligating groups can be attached to the dendritic terminal groups. The inventor of the present invention has prepared both 2^{nd} and 4^{th} generation (G-2. G-4) dendron initiators 16 and 17 with a protected acid and peripheral tetrahydropyran (THP) groups respectively (FIG. 7) (Pyun, J.; Tang, C.; Kowalewski, T.; Frechet, J. M. J.; Hawker, C. J., Synthesis and Direct Visualization of Block Copolymers Composed of Different Macromolecular Architectures. Macromolecules 2005, 38, (7), 2674-2685).

The inventor of the present invention has demonstrated that a dendron-coil comprising a PS linear tail and G-4 amine terminal dendron is an efficient surfactant to stabilize cobalt nanoparticle dispersions Another embodiment of the present invention focuses on the systematical variation of dendron generation, peripheral ligating groups and the introduction of wide range of functional linear segments via controlled radical polymerization through the alkoxyamine focal point.

Effect of Alkoxyamine Chain-ends. In one embodiment of the present invention, an important feature to consider in the surfactants previously described is the presence of a thermally labile alkoxyamine at the copolymer chain end. The effect of this functionality in the synthesis of particles can be determined by comparing CO₂CO₈ thermolysis reactions with copolymer surfactants that retain the alkoxyamine end group and control experiments where this functional chain end is replaced with a nonreactive moiety. A wide range of displacement reactions to remove alkoxyamines from polymers using tributyltin hydride and substitute with other functional groups can be used.

Synthesis of Polymer Coated Cobalt Nanoparticles. Conditions for the preparation of ferromagnetic cobalt colloids can be used targeting particle sizes larger than 15 nm, for example, refluxing in 1,2-dichlorobenzene at 185° C. Cobalt colloids smaller than 15 nm are superparamagnetic and are not easily assembled into extended 1-D mesostructures. According to the present invention, there are two preferred approaches to prepare polymer coated nanoparticles, containing highly functional polymer shells, and ferromagnetic colloidal cores of metallic cobalt.

In Situ Synthesis of Cobalt Nanoparticles using Functional Copolymer Surfactants. One approach is the thermolysis of dicobaltoctacarbonyl (CO₂CO₈) in the presence of functional copolymers (FIG. 8). The preparation of cobalt colloids from this approach can be conducted, for example by the decomposition of CO₂CO₈ at 110° C. using polymeric surfactants, or at 185° C. using a mixture of small molecular surfactants (e.g., oleic acid, TOPO) Functional copolymers surfactants bearing phosphine oxide ligands can be used to efficiently synthesize and stabilize ferromagnetic cobalt colloids via thermolysis of CO₂CO₈ at 185° C. with a reaction time of five minutes. The reaction temperature is preferably in the order of 150-185° C. Further, end-functional polymers containing amine, carboxylic acids, or phosphine oxides as surfactants for cobalt nanoparticies can be synthesized. These chain-end functional polymers can passivate nanoparticles in a similar fashion as observed for oleyl amine, oleic acid and TOPO small molecule surfactants. However, an additional level of structural complexity can be embedded into the surfactant via the inclusion of functional comonomer units in the copolymer backbone.

Preparation of Cobalt Nanoparticles from End-Functional Polymers. In a Preferred embodiment, polymer coated, cobalt colloids are prepared using a mixture of amine (PS—NH₂) and dioctylphosphine oxide (PS-DOPC) end-functional polystrenes. In this system, the thermolysis of Co₂CO₈ was carried out at 185° C. yielding ferromagnetic nanoparticles, similar to a previously reported system by Alivisatos et al., (Puntes, V. F.; Zanchet, D.; Erdonmnez, C. K.; Alivisatos, A. P. Synthesis of hcp. Co nanodisks, Journal of the American Chemical Society 2002, 124, (43), 12874-12880) using aliphatic amines and TOPO. As for the small molecular system, nanoparticle surfaces are coordinated with amine and phosphine oxide end-groups, while the polymer chain stabilizes the colloidal dispersion by forming a sterically shielding shell around the cobalt core. End-functional polymer surfactants possessing molecular weights less than Mₙ=5,000 g/mol are preferred for cobalt colloid synthesis. These polymer coated cobalt nanoparticles were then characterized using TEM to determine particle size and morphology of magnetic cores. Samples for TEM were prepared by drop casting a colloidal dispersion onto a carbon coated copper grid. Low magnification (1,000×-5,000×) TEM images reveal the formation of extended fiber-like assembling spanning several microns in length (FIG. 9a). TEM images of these assemblies at higher magnification clearly demonstrate the presence of individual cobalt nanoparticles particle size˜15 nm, FIG. 9b) organized into 1-D chains. The formation of chaining in these systems is a signature of ferromagnetism arising from the magnetic dipolar associations of individual colloids (Safran, S. A., Ferrofluids. Magnetic strings and networks. Nature Materials 2003, 2, (2), 71-72). These chains are easily aligned into rigid rod-like structures using weak magnetic fields from standard horseshoe magnets. X-ray diffraction (XRD) measurements confirmed that the nanoparticles with the s-cobalt crystalline phase as was formed (Sun, S.; Murray, C. B., Synthesis of monodisperse cobalt nanocrystals and their assembly into magnetic superlattices. Journal of Applied Physics 1999, 85, (8, Pt. 2A), 4325-4330; Puntes, V. F.; Krishnan, K. M.; Alivisatos, A. P., Synthesis, self-assembly, and magnetic behavior of a two-dimensional superlattice of a single-crystal cobalt. Appl. Phys. Lett 2001, 78, 2187-2189). The presence of the organic shell was conformed using thermograviimetric analysis (TGA) and differential scanning calorimetry (DSC).

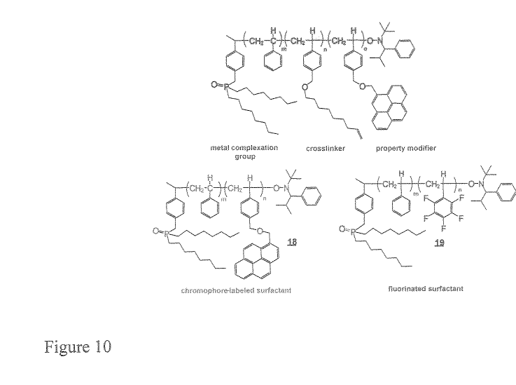

Introduction of Functionality to Magnetic Nanoparticle Shells. A preferred surfactant for this system is a random copolymer which possesses a ligating chain end, random crosslinkable units in the backbone and inclusion of other functional comonomer units to modify material properties (FIG. 10). The structure of the copolymer is not limited as along as a ligating chain end, random crosslinkable units in the backbone and property modifier are present. However, other polymers and functional groups in different positions of the polymer can be used as described above. In addition, functional groups are selected for their compatibility with the nanoparticle and the remainder of the copolymer structure. For example, functional side chain groups in the copolymer should not compete with the ligating end-group for coordination to the nanoparticle surface. Additionally, crosslinkable groups in this system are preferably thermally stable to survive the particle forming thermolysis reaction.

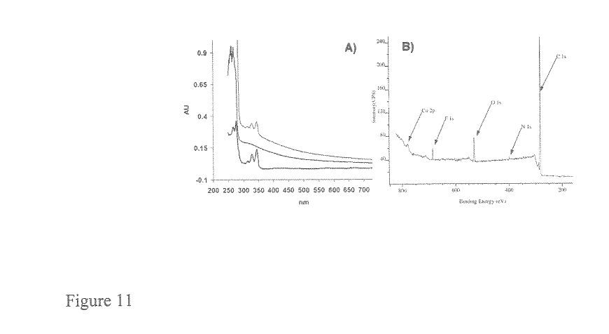

For example, in one embodiment of the present invention, the controlled radical copolymerization of 1-11 can be performed using functional alkoxyamines 14 & 15 to synthesize a small library of functional surfactants. The degree and type of functionality that can be introduced to cobalt colloidal materials can be controlled by varying the composition within a copolymer, or blending different end-functional polymers in the preparation of cobalt colloids. Phosphine oxide end-functional polystyrenic copolymers 18 & 19 that contain either pyrene, or pentafluorostyrene side-chain groups have been synthesized. In a mixed system of either copolymer 18, or 19 with a PS—NH₂ surfactant, functionalized cobalt nanoparticles have been synthesized carrying either fluorinated, or chromophore groups. UV-VIS spectroscopy confirmed the incorporation of pyrene groups to cobalt nanoparticles. As shown in FIG. 11a, the vibronic modes of pyrene are present in the absorption spectrum for pyrene-labeled cobalt nanoparticles. The introduction of fluorinated groups to the polymer corona of cobalt nanoparticles was confirmed by X-ray photoelectron spectroscopy (XPS). XPS is a powerful tool in the characterization of polymer coated nanoparticles, as the elemental composition of both the organic shell and in the inorganic core can be ascertained (FIG. 11b).

Post-functionalization of Cobalt Nanoparticles with Functional Linear and Dendron-Coil Copolymers, A second strategy to prepare polymer coated nanoparticles can also be pursued via ligand exchange of small molecule surfactants on cobalt nanoparticles with functional copolymers. The high temperatures (185° C.) used in the in situ thermolysis of CO₂CO₈ complicates the addition of thermally reactive functional groups onto copolymer surfactants. The ligand exchange approach circumvents this problem, as the introduction of the polymer surfactant coating can be achieved at room temperature. Thus, a wider range of functional groups can be incorporated into polymer coated shells.

Synthesis of Ferromagnetic Cobalt Nanoparticles. Metholodogies of Alivisatos and Krishan et al., are used to synthesize cobalt colloids using surfactants mixtures of TCPO/oleic acid. TOPO/oleyl amine, oleic acid/oleyl amine (Puntes, V. F.; Krishnan, K. M.; Alivisatos. A. P., Synthesis, self-assembly, and magnetic behavior of a two-dimensional superlattice of a single-crystal cobalt. Appl. Phys. Lett 2001, 78, 2187-2189 Bao, Y.; Beerman, M.; Krishnan, K. M., Controlled self-assembly of cobalt nanocrystals. J. Mag. Mag. Mater. 2003, 266, 1245-1249; Puntes, V. F.; Krishnan, K. M.; Alivisatos, A. P., Colloidal nanocrystal shape and size control: The case of cobalt, Science (Washington, D.C., United Sates) 2001, 291, (5511), 2115-2117; Puntes, V. F.; Zanchet. D. Frdonmiez, C. K.; Alivisatos, A. P.) Synthesis of hcp. Co nanodisks. Journal of the American Chemical Society 2002, 124, (43), 12874-12880). Thermolysis reactions are typically performed in DCB (1,2-dichlorobenzene) at 185° C. Ligand stabilized ferromagnetic nanoparticles of sizes in the range of, for example, 15-20 nm are prepared.

Functionalization via Ligand Exchange. The preparation of functional linear and dendron-coil copolymers possessing amine, or carboxylic acid groups can be conducted, as described above. These multifunctional copolymers can be mixed with a cobalt nanoparticle dispersion, to displace surface bound small molecule surfactants. After allowing for sufficient mixing at room temperature, the colloids can be isolated by centrifugation. Efficient coating of cobalt nanoparticles can be examined by redispersing isolated materials from the solid-state, as well as, characterization of the organic shells using TGA/DSC and UV-vis spectroscopy. The branched dendron-coil architecture is more geometrically suited to coordinate on a curved particle surface in comparison to linear copolymers.

Functional Shell-Crosslinked Nanoparticles. The synthesis of discrete shell-crosslinked nanoparticles is performed using the ligand exchange approach (FIG. 12). See also Stewart, S.; Liu, G., Block copolymer nanotubes. Angewandte Chemie, International Edition 2000, 39, (2), 340-344; Wooley, K. L., Shell crosslinked polymer assemblies: nanoscale constructs inspired from biological systems. Journal of Polymer Science, Part A: Polymer Chemistry 2000, 38, (9), 1397-1407; Kang, Y.; Taton, T. A., Micelle-Encapsulated Carbon Nanotubes: A Route to Nanotube Composites. Journal of the American Chemical Society 2003, 125, (19), 5650-5651; Pan, D.; Turner, J. L.; Wooley, K. L., Shell Cross-Linked Nanoparticles Designed To Target Angiogenic Blood Vessels via avb3 Receptor-Ligand Interactions. Macromolecules 2004, 37, (19), 7109-7115; Qi, K.; Ma, Q.; Remsen, E. E.; Clark, C. G., Jr.; Wooley, K. L., Determination of the bioavailability of biotin conjugated onto shell crosslinked nanoparticles. Journal of the American Chemical Society, 2004, 126, (21), 6599-6607; Kang, Y.; Taton, T. A., Core/shell gold nanoparticles by self-assembly and crosslinking of micellar, block-copolymer shells. Angewandte Chemie, International Edition 2005, 44, (3), 409-412; Perkin, K. K.; Turner, J. L.; Wooley, K. L.; Mann, S., Fabrication of Hybrid Nanocapsules by Calcium Phosphate Mineralization of Shell Cross-T inked Polymer Micelles and Nanocages. Nano Letters 2005, 5, (7), 1457-1461; Wooley, K. L.; Hawker, C. J., Nanoscale objects: Perspectives regarding methodologies for their assembly, covalent stabilization, and utilization. Topics in Current Chemistry 2005, 245, (Functional Molecular Nanostructures), 287-305).

Due to the lower temperatures for functionalization, a wider range of crosslinkable segments can be introduced to copolymer surfactants and polymer coated nanoparticles. The preparation of alkoxysilane functional copolymers allows crosslinking of adsorbed copolymers around magnetic colloids. Subsequent condensation reactions of side-chain groups can stitch together adsorbed copolymers around the colloidal core to form a robust, core-shell particle. Preferably, alkoxysilane functional polysiloxanes can be used. The shell-crosslinked nanoparticles can be tolerant to a wider range of polar functionalities that would otherwise displace adsorbed copolymer surfactants from particle surfaces. In the design of shell-crosslinked particles, a dendron-coil block copolymer possessing a ligating dendron, crosslinkable middle segment and a solubilizing outer block can be synthesized (FIG. 12) Thermal analysis (DSC, TGA) of nanoparticles can be performed to probe the thermal stability of crosslinked shells relative to adsorbed copolymer surfactants. The chemical robustness of shell-crosslinked nanoparticles can also be studied by the addition of aggressive ligands (e.g., oleic acid, acetic acid) in attempts to strip the polymer coating from particle surfaces.

Alignment of Magnetic Colloids and Crosslinking into Mesoscopic Magnetic Chains. The magnetic assembly and crosslinking of colloidal building blocks can be pursued to prepare micron-sized magnetic chains with functional polymer coatings. Magnetic nanoparticles dispersed in organic media have recently been demonstrated to organize into 1-D chains in the absence of a magnetic field above a critical particle size and magnetization (Klokkenburg, M., Vonk, C. Claesson, E. M.; Meeldijk, J. D.; Erne, B. H. Philipse, A. P., Direct Imaging of Zero-Field Dipolar Structures in Colloidal Dispersions of Synthetic Magnetite. Journal of the American Chemical Society 2004, 126, (51), 16706-16707). The assembly process was attributed to dipolar interactions arising from magnetic interactions between particles. Magnetic fields in the order of 1 Tesla (T) from an electromagnet have also been reported to induce assembly of Fe colloids (12-18 nm) (Butter, K.; Bomans, P. H. H.; Frederik, P. M.; Vroege, G. J.; Philipse, A. P., Direct observation of dipolar chains in iron ferrofluids by cryogenic electron microscopy. Nature Materials 2003, 2, (2), 88-913. Thus, the preparation of mesoscopic magnetic chains via the assembly of core-shell magnetic nanoparticles into chain-like structures can be induced either using an external magnetic field or by self-assembly processes using ferromagnetic colloids. In the assembly process, both the concentration (10 mg/mL to 0.01 mg/mL) of colloids in organic dispersions and the field strength (H=100 mT to 2 T, T=tesla) can be systematically varied to optimize conditions for chain formation. The concentration includes all values and subvalues therebetween, especially including 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5 mg/mL. The field strength includes all values and subvalues therebetween, especially including 0.2, 0.3, 0.4, 0.5, 0.6, 0.7, 0.8, 0.9, 1, 1.1, 1.2, 1.3, 1.4, 1.5, 1.6, 1.7, 1.8 and 1.9 T.

Co-TEM of magnetic colloidal dispersions in toluene can be conducted to determine whether functional magnetic colloids assemble into mesoscopic 1-D chains. Samples for cryo-TEM can also be prepared both under zero-field conditions and in the presence of a weak applied field (0.2 T) before quenching the dispersion in liquid nitrogen. The formation of chains can be confirmed under an applied field, the connectivity of the assembled colloids can be achieved by crosslinking of reactive groups on the copolymer surfactant. These reactions can both encapsulate the copolymer around the colloidal cores and lock-in the assembled chains through the creation of covalent bonds (FIG. 2). Variation of the number of reactive groups in the surfactant can be performed to suppress incidence of inter-chain coupling during the crosslinking reactions. The 1-D organization of magnetic colloids into mesoscopic chains is reminiscent of chain-growth polymerization of small molecule monomers. The principles of polymerization and polymer chemistry are applied to control both the chain length and composition of assembled nanoparticles in mesoscopic magnetic chains.

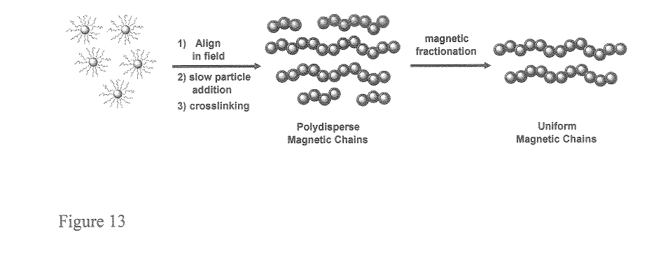

Control of Chain Length. While conventional chain-growth polymerizations typically exhibit poor control of molecular weight and polydispersity, methods, such as slow monomer addition (“starved monomer” conditions) have been developed to improve these limitations (Litvinenko, G. I.; Mueller, A. H. E., Molecular Weight Averages and Degree of Branching in Self-Condensing Vinyl Copolymerization in the Presence of Multifunctional Initiators. Macromolecules 2002, 35, (12), 4577-4583; Cao, C.-P.; Zhu, Z.-N.; Zhang, M.-H.; Yuan, W.-K., Kinetics of butyl acrylate polymerization in a starved feed reactor. Journal of Applied Polymer Science 2004, 93, (4), 1519-1525). Thus, the slow addition of crosslinkable magnetic colloids is used to dilute dispersions of aligned magnetic nanoparticles as a route to minimize the distribution of assembled chains lengths. The polydispersity of these chains compared to magnetic chains formed without slow particle addition can be determined. Further purification of magnetic chains can be performed using magnetic fractionation to isolate assembled 1-D structures of higher chain length and magnetization (FIG. 13). In the magnetic fractionation process, an applied field of an appropriate magnitude (H=100 mT to 2 T, T=tesla) can be used to induce selective aggregation and precipitation of longer micron-sized magnetic chains, as their magnetic moments can be larger than in shorter assemblies. The field strength includes all values and subvalues therebetween, especially including 0.2, 0.3, 0.4, 0.5, 0.6, 0.7, 0.8, 0.9, 1, 1.1, 1.2, 1.3, 1.4, 1.5, 1.6, 1.7, 1.8 and 1.9 T.

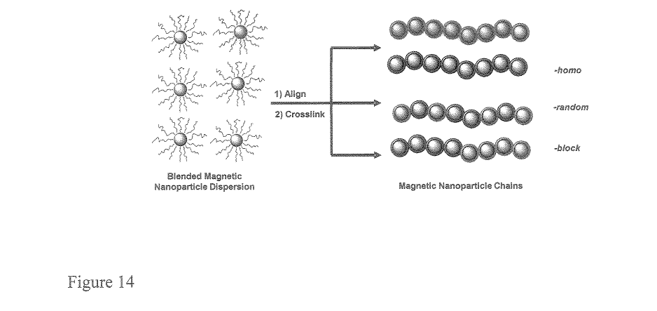

Control of Composition. Mesoscopic chains possessing random and block segments of different magnetic colloids can be prepared (FIG. 14). Blends of dispersed magnetic nanoparticles can be prepared. By the appropriate design of particle shells, and variation of dispersed colloid concentrations, block-like magnetic chains composed of different nanoparticle segments can be prepared. Using the controlled radical polymerization, copolymer surfactants with highly immiscible polymers can be synthesized to prepare libraries of functional magnetic nanoparticles. These various magnetic colloids polymers can be mixed into a one-pot dispersion and assembled by an applied field. The formation of block-like magnetic chains is performed. In addition, colloid assembly is controlled with both homo- and random composition Conditions for assembly can be controlled by modulating the mixing of different colloids (e.g., slow particle addition, time-scale and external field strength. A number of kinetically trapped random compositions can be prepared using this methodology. AFM of assembled structures can be used to deter mine whether colloids phase segregate, or randomize along the organized magnetic chain, where nanoparticles possessing different mechanical properties can be studied to allow phase contrast imaging. Magnetic nanoparticle block chains can also be cast onto thin films and visualized using AFM. Phase separation of block segments in nanoparticle chains to form well-defined morphologies (e.g., spheres, cylinders, lamellae) occurs, where the periodicity of domains is in the order of microns, preferably 0.1 to 20, more preferably 0.5 to 10 and most preferably 1 to 5 μm. In one embodiment, the fundamental morphology and bulk properties of these films are modified to obtain materials with hierarchical order from the molecular to macroscopic using this bottom up approach. Preferably, hierachical order is achieved by controlling the molecular structure of the surfactants thru the polymer chemistry of surfactants, nanoscale order is achieved by preparing organic/inorganic hybrid nanoparticles, mesoscale order is achieved by field induced, or self-assembly of ferromagnetic nanopartices into 1-D chains, and macroscopic order is achieved, for example, by fabrication of thin films.

One-Pot Synthesis of Magnetic Nanoparticle Chains. In preparing polymer coated ferromagnetic nanoparticles, the inventor of the present invention has founds a one-pot synthesis of mesoscopic magnetic chains from copolymers surfactants. As described in FIG. 8, polymer coated nanoparticles can be prepared by the thermolysis of CO₂CO₈ that readily form micron sized 1-D assemblies when cast onto surfaces (FIG. 9). Further dilution of this material revealed the presence of discrete nanoparticle chains (FIG. 15). These robust chains were stable to thermal annealing (at least 200° C.) and remained intact despite deposition via spin coating on surfaces at high spinning speeds (4000 rmp). Additionally, blending of these magnetic chains with excess free PS (polystyrene) (Mₙ=3,000) did not disrupt the connectivity between nanoparticles. These magnetic chains are responsive to weak external fields from standard horseshoe magnets and align into rigid rods in the direction of the applied field. Mesoscopic magnetic chains are synthesized in the absence of an applied field due to the formation of free radicals on nanoparticles, and their preferential 1-D associations from magnetic dipoles (FIG. 16). Ferromagnetic cobalt colloids are generated within 2-3 minutes in the thermolysis of Co₂CO₈ at 185° C. Under these conditions, it was observed that free radicals and coupling of polymeric surfactants possessing alkoxyamine end-groups occurs within five minutes.¹⁷¹ Consequently, free radicals are generated at the particle periphery which allow neighboring magnetic colloids to form covalent linkages from radical coupling reactions. The selective formation of 1-D chains can only be explained by the preferential north-south orientation of dipoles in ferromagnetic colloids during these particle coupling events. Thus, the timely kinetics of a series of reactions, for example the rapid formation of cobalt nanoparticles, generation of free radicals, and preferential 1-D coupling of ferromagnetic colloids, allows the formation of polymer coated mesoscopic chains in a single step. This serendipitous finding demonstrates that Hawker-type alkoxyamine end-groups on polymer surfactants are efficient crosslinking agents to covalently connect nanoparticles into chains. Control experiments have been performed, where alkoxyamine end-groups have been removed from polymeric surfactants and evaluate this effect on particle size and morphology (e.g., chains vs. single particles). AFM experiments of covalently linked nanoparticies are carried out to probe the mechanical integrity of this material in comparison to assemblies formed strictly from magnetic associations.

Characterization of Polymers, Nanoparticles and Assembled Chains.

Polymers and Magnetic Nanoparticles. Copolymer surfactants prepared using convergent dendrimer chemistry and controlled radical polymerization can be characterized using ¹H, ¹³C, ³¹P, NMR, size exclusion chromatography and mass spectrometry. The metallic components in polymer coated nanoparticles can be characterized by TEM and XRD. XPS can be used to characterize the elemental composition of both inorganic particles and polymer shells (FIG. 9b). Magnetic characterization of nanoparticles can be performed on a vibrating sample magnometer (VSM). The characterization of organic shells on nanoparticles using tradition NMR and IR spectroscopy is not possible due to the presence of magnetic components. Thus, both UV-VIS and fluorescence spectroscopy of colloids labeled with chromophores can be conducted. Additionally thermal analysis (DSC, TGA) can be performed to determine the glass transition of polymer shells and confirm the presence of degradable organic coatings on metallic colloids.

Magnetic Assembly Conditions. The organization of magnetic colloids into 1-D assemblies can be characterized using cryo-TEM in toluene dispersions. Magnetic assembly can also be investigated with varying field strengths using weak fields (˜0.2 T) from standard horse-shoe AlNiCo magnets, moderate fields (1-T) from electromagnets) and high fields (2-4 T) from superconducting magnets. Experiments with electro- and superconducting magnets can be done. Monte Carlo Simulations of dispersed magnetic nanoparticle systems can be studied to examine the effect of particle size, concentration and magnetic moment on the morphology of assembled structures.

Magnetic Chains: Proof of Covalent Connectivity and Thin Films. A question to address in the synthesis of mesoscopic magnetic chains is whether nanoparticles are covalently linked, or simply magnetically associated. While tradition spectroscopic analysis of organic shells on magnetic materials is not possible, cobalt cores can be degraded using standard inorganic acids (e.g., HCl) and then the recovered organic materials are characterized using these methods. SEC measurements of recovered polymer shells can also be done to determine if the molar mass of adsorbed polymer surfactants increases due to crosslinking reactions. Alternatively, atomic force microscopy (AFM) nanomechanics of covalently magnetic chains can also be conducted Crosslinking of nanoparticles imparts higher mechanical integrity to assembled chains. A series of control AFM experiments was performed to compare the dimensional stability of assembled magnetic nanoparticles that are not chemically linked. Characterization of magnetic chains possessing random and block compositions can be carried out using tapping-mode AFM. Magnetic force microscopy can also be examined. The differences between crosslinked chains and discrete nanoparticles can be compared.

Novel mechanism for mesoscale assembly. The described approach broadens the existing synthetic toolbox for the preparation of mesoscopic assemblies from nanoparticle materials. The use of magnetic dipolar associations as a driving force for self-assembly is a novel route to complex materials and has not been extensively explored. This is the first system that allows versatile functionalization of dispersed magnetic nanoparticles and harnesses magnetic attractive forces to form discrete nano to micron-sized chains with tunable properties.

Nanoparticle Functionalization. The described approach demonstrates that precision polymer synthesis can be used to prepare functional surfactants that allow precise interfacial control between the organic coating and the magnetic nanoparticle. This fundamental advance broadly impacts a number of different fields that are synthetically limited by methodologies to functionality and coat magnetic nanoparticles. The ability to derivatize magnetic colloids and allow their dispersion, or blending into a wide range of environments (e.g., aqueous, thin films) is an important problem that can benefit from the developed approach. The applications of the materials developed effect areas in biotechnology (MRI, drug delivery) and microelectronics (magnetic storage).

Applications. Various industrial applications can utilize the described magnetic particle dispersions. The preparation of polymer coated ferromagnetic nanoparticles offers a new class of hybrid composite materials possessing the tunable functionality of organic materials with the high magnetization and coercivity of inorganic magnetic substances. The inventor of the present invention has demonstrated that by variation of polymer shell composition, molar mass and functionality, a wide range of novel materials possessing useful properties can be accessed.

Thin films of polymer coated ferromagnetic cobalt nanoparticles possess strong absorptive properties for microwave and radiofrequency irradiation, which are attractive as stealth coatings for fighter jets and bombers and other military equipment requiring stealth coatings. Thin films of polymer coated ferromagnetic cobalt nanoparticles are prepared by solution deposition onto hard, or flexible substrates dip coating, or spin-coating or hot-pressing (melt-pressing) of thin films. All of these processes can be done with an external magnetic field to align nanoparticle chains. The thickness of the thin films is from 0.01 to 1000 μm, preferably, 0.05 to 500 μm, more preferably 0.1 to 100 μm, even more preferably 1 to 50 μm and most preferably 1 to 10 μm. The film thickness includes all values and subvalues therebetween, especially including 0.05, 0.1, 0.5, 1, 5, 10, 20, 30, 40, 50, 60, 70, 80, 90, 100, 150, 200, 250, 300, 350, 400, 450, 500, 550, 600, 650, 700, 750, 800, 850, 900 and 950 μm.

Attachment of both fluorescent and water soluble polymer coatings affords magnetofluorescent nanoparticles which are biocompatible and can be used as a single contrast agent for both MRI and fluorescence imaging in vivo. Preferred fluorescent materials include pyrenes, Nile red, Texas red, fluorescein, polythiophenes, coumarins, laser dyes, and other known fluorescent materials. The dyes can be attached either as a monomer and incorporated into polymers via copolymerization, or via post-polymerization attachment thru functional side chain groups in precursor polymers, via ligand exchange or any other method as described above.

Magnetorheological (MR) Fluids. Current applications of MR fluids in brake clutches and vibration dampeners require suspensions of micron-sized ferromagnetic particles to achieve a drastic change in viscosity and modulus of the media (Klingenberg, D. J., Magnetorheology: applications and challenges. AIChE Journal 2001, 47, (2), 246-249). Ferrofluid dispersions composed of nanometer-sized colloids do not typically possess the mechanical properties necessary for these applications, due to the small size of the nanoparticles. However, the magnetic polymer chains according to the present invention which are formed from the coated nanoparticles according to the present invention possess persistence lengths spanning hundreds of nanometers to microns. Thus, dispersions of magnetic polymer chains display the appropriate viscosity and mechanical properties required for MR fluid applications.

Passivation of the metallic nanoparticle with polymer shells. Passivation of the metallic nanoparticles with poly(ethylene oxide), poly(propylene oxide), mixed PEO/PPO, or poly(polyethylene oxide methacrylate) polymer shells is performed to afford water-soluble, biocompatible magnetic nanoparticles. These hybrid colloids impact the areas of cancer therapy via magnetic field induced heating of tumerous tissues, known as, hyperthermia. The colloids used here preferably have a particle diameter of from 5 to 100 nm. They are preferably used in aqueous media, including mixtures of water with an alcohol such as ethanol.

In one embodiment, the passivation with polymer shells, preferably polystyrenics and poly(meth)acrylics, such as, polystyrene, poly(methyl methacrylate), poly(stearyl methacrylate) enhances dispersion of magnetic particles in blending polymer thin films and protecting the metallic particle from corrosion. These materials are the next generation of binder materials for ultrahigh density flexible magnetic storage (i.e., magnetic tape).

Magnetic Tapes. Magnetic tapes are ubiquitous in every day life and on a per volume basis is the most reliable and cost-effective media for the long term storage of information (Pyun, J., The best paper of all time. Nature (London 2006, 444, 3493). Increasing the capacity of magnetic tapes is driven by growing demand in a number of areas in health care and business, where the documentation and availability of data over a period of decades is essential. Furthermore, the constant threat of natural disasters, terrorism and viruses mandate the need for research in storage media to allow secure and affordable backup of enormous archives of data. Toward this end, the dispersion and stabilization of magnetic nanoparticles in composite films has been identified as an important challenge for advances in magnetic tapes. Hybrid nanocomposites according to the present invention as discussed above (metallic nanoparticle with polymer shell) can be used for this application as functional polymer shells can stabilize nanoparticles against oxidation and allow for efficient dispersion in polymeric thin films. The chain-like assemblies have been reported to possess enhanced magnetic properties, namely, high coercivity (Zhang, L.; Manthiram, A., Experimental study of ferromagnetic chains composed of nanosize Fe spheres, Physical Review B: Condensed Matter 1996, 54, (5), 3462-3467; Zhang, L.; Manthiram, A., Chains composed of nanosize metal particles and identifying the factors driving their formation. Applied Physics Letters 1997, 70, (18), 2469-2471; Gross A. F.; Diehl M. R.; Beverly, K. C.; Richman E. K.; Tolbert, S. H. Controlling Magnetic Coupling between Cobalt Nanoparticles through Nanoscale Confinement in Hexagonal Mesoporous Silica Journal of Physical Chemistry B 2003, 107, (23), 5475-5482).

The preparation of mechanically robust thin films containing aligned polymer coated magnetic particles according to the present invention dispersed in a polymeric matrix is performed for use in magnetic tapes. Such films can be obtained by spin coating, dip coating, spray coating, layer-by-layer self-assembly, thermal vapor deposition, chemical vapor deposition or Langmuir Blodgett techniques. The polymer matrix may include any polymer described above for the shell of the nanoparticles. The thickness of the thin films is from 0.01 to 1000 μm preferably, 0.05 to 500 μm, more preferably 0.1 to 100 μm, even more preferably 1 to 50 μm and most preferably 1 to 10 μm. The film thickness includes all values and subvalues therebetween, especially including 0.05, 0.1, 0.5, 1, 5, 10, 20, 30, 40, 50, 60, 70, 80, 90, 100, 150, 200, 250, 300, 350, 400, 450, 500, 550, 600, 650, 700, 750, 800, 850, 900 and 950 μm.

Preferably, the magnetic tape comprises three major layers: a base film (1 to 10 microns as supporting substrate, e.g., PET, PEN), an under layer (0.1 to 5 microns), and a magnetic coating (also referred to as binder coating having up to 50-vol % of magnetic colloidsto the present according to the present invention, with an overall film thickness ˜50-100 nm). Our invention only refers to this binder coating, where polymer technology can “engineer” the performance of organic polymer binder layer more efficiently and with far greater control

The present invention provides a new route to improved binder coating materials for particulate tape media. Notably, the binder materials of the present invention which contain the coated polymer nanoparticles, optionally in a polymer matrix, are “all-in-one” binder materials that passivate magnetic nanoparticle to protect from oxidation, tune mechanical properties (variable from glassy to rubbery—as desired) by control of polymer shell composition and improve dispersion in polymer thin films.

In a preferred embodiment, core-shell colloids containing magnetic cores and functional polymer shells are cast into thin films having a thickness of from 10-200 n0 and crosslinked in the presence of a magnetic field Control of the polymer shell composition allows the introduction of crosslinkable moieties to the particle and concurrently allows for tuning of the mechanical properties of the nanocomposite thin film.

Previous reports have described the organization of magnetic nanoparticles into 1-D, or 2-D nanostructures via magnetic dipolar associations ((a) Hess, T. J. App. Phys. 1966, 37, 2914-2915. (b) Bronstein et al., Colloid Polym. Sci. 1997, 275, 426-31. (c) Nikles et al. J. Appl. Phys. 1999, 85, 5504-5506. (d) Murray et al., Nature 2003, 423, 968-971). However, harnessing the features of magnetic assembly has not been widely explored in the preparation of nanoparticle-filled thin films. Progress in this area has been stifled by the need for versatile synthetic methodologies to coat nanoparticies enabling functionalization of colloidal surfaces and efficient dispersion when cast into thin films. Using the synthetic methodology described above, highly functional colloidal building blocks can be prepared that allow formulation into UV-curable resins, which are used to prepare crosslinked thin films for binders in magnetic tapes.

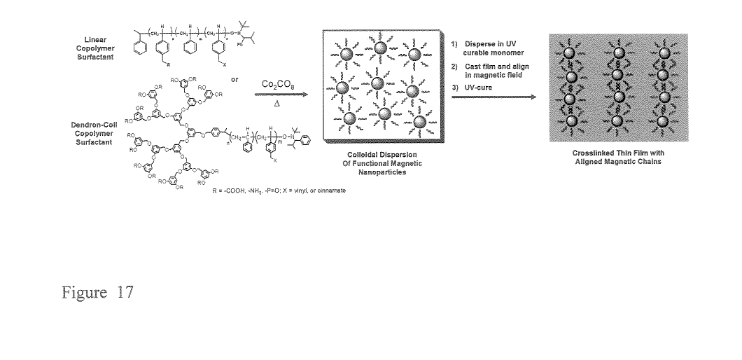

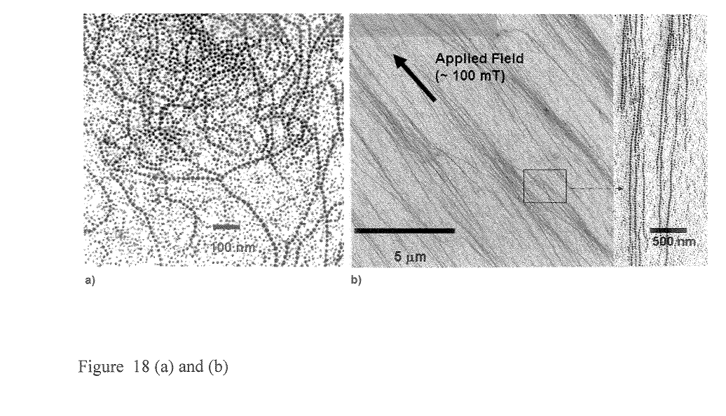

The preparation of ordered, nanoparticle-filled thin films is performed using the above described coated nanoparticles according to the present invention Preferably, colloidal building blocks containing magnetic cores and UV-curable polymer shells are used in preparing ordered nanocomposite films for magnetic tapes. Both the functionality and mechanical properties of the copolymer coating are tuned using both dendrimer and controlled polymerization chemistry, as described above. Preferably, glassy and/or rubbery polymer coatings are prepared by controlling the composition of styrenic, acrylic and diene comonomers. Functionalization of copolymer surfactants with UV-curable groups is performed by the attachment of either vinyl, or cinnamate moieties. Due to the higher temperatures (T>100° C.) required to synthesize cobalt nanoparticles, more reactive groups, such as, (meth)acrylates can not be utilized. In one embodiment, thin films are cast onto flat, or flexible substrates and aligned under a magnetic field (FIG. 17). The morphology of thin films can be characterized using TEM, AFM and MFM (magnetic force microscopy). TEM imaging of thin films prepared in the absence of a magnetic field indicate that polymer coated cobalt colloids (20 nm), self-assemble into 1-D chains spanning several microns in length (FIG. 18a). These chains also form entangled networks, reminiscent of organic polymer chains. However, when the same colloidal dispersions are cast onto surfaces in the presence of a magnetic field (˜10 mT), the formation of rigid, extended 1-D chains are formed which are oriented in the direction of the applied field (FIG. 18b). In addition, the aligned chains can be UV crosslinked into continuous films.

Preferably, the magnetic tape comprises a base substrate, a polymer matrix having dispersed therein or on its surface the coated nanoparticles according to the present invention. The base substrate is not particularly limited, preferably materials known for use as base material in magnetic tapes are used, more preferably polymer and most preferably PET. The substrate has a thickness of from 1 to 20 μm, preferably 10 μm or more. The substrate thickness includes all values and subvalues therebetween, especially including 2, 3, 4, 5, 6, 7, 8, 9, 10, 11, 12, 13, 14, 15, 16, 17, 18 and 19 μm.

Optionally, an underlayer is used. The thickness of the underlayer can be 0.5 μm to 10 μm, preferably about 1 μm. The thickness of the underlayer includes all values and subvalues therebetween, especially including 1, 1.5, 2, 2.5, 3, 3.5, 4, 4.5, 5, 5.5, 6, 6.5, 7, 7.5, 8, 8.5, 9 and 9.5 μm. The underlayer may contain materials conventionally used in underlayers such as electrostatic absorbers, modifiers.

Preferably, the storage media contain a magnetic coating (˜100 nm thick) comprising 50-vol % of magnetic nanoparticles according to the present invention, 50-vol % of a polymeric binder thin film.

When applying the polymer matrix to the substrate, solvents can be used. For example, polymers are cast in presence of solvent after harsh grinding and ball milling.

A main challenge in the preparation of magnetic tapes are dispersion of magnetic nanoparticles in polymer thin films without aggregation. However, this has been overcome according to the present invention by passivation of magnetic colloids with compatabilizing polymer shell. Another challenge is the suppression of undesirable corrosion (i.e., oxidation cause formation of oxide layer “rust like” which is not magnetic. This has been overcome according to the present invention by using a polymer barrier which suppresses oxidation.

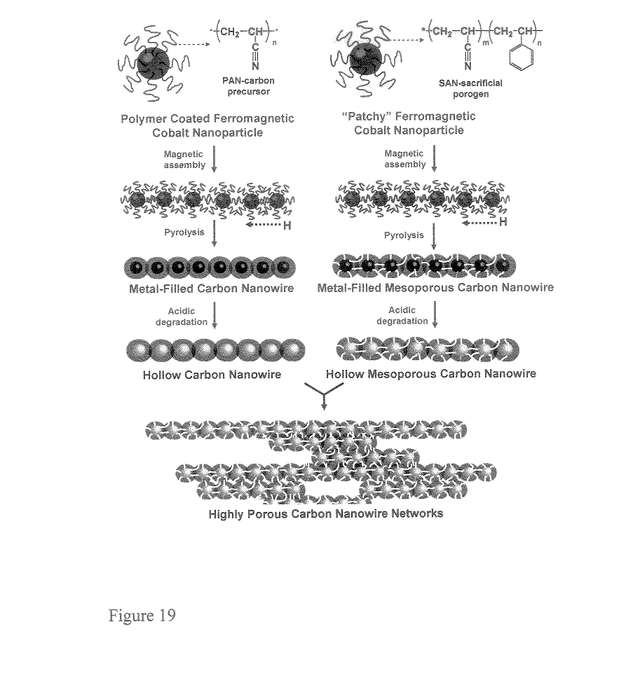

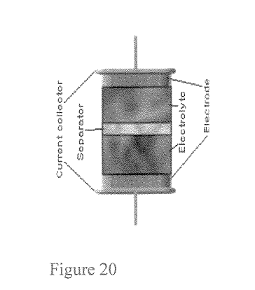

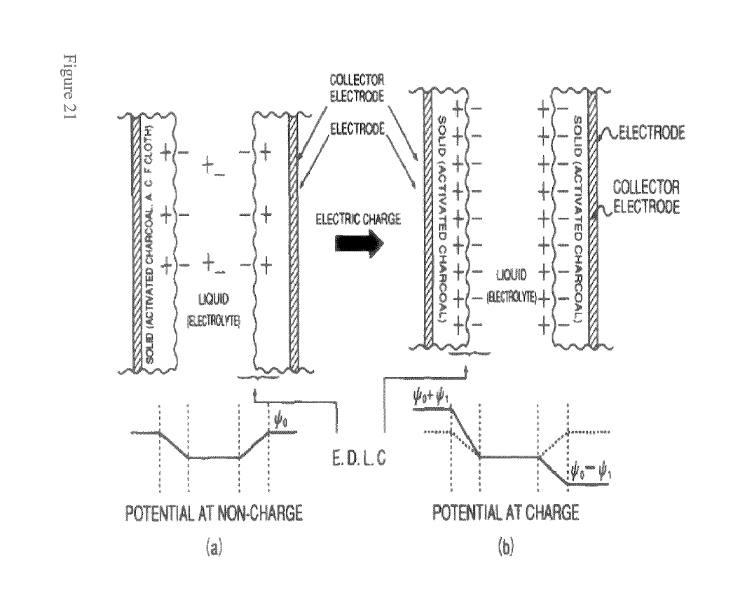

Carbon nanowire type structures. Passivation of the metallic nanoparticles with polyacrylonitrile (PAN), magnetic 1-D assembly and pyrolysis of PAN coated ferromagnetic nanoparticles affords carbon nanowire type structures via bottom-up self-assembly approaches (FIG. 19). These materials impact the areas of energy storage as materials for supercapacitor devices. Bottom-up self-assembly refers to progressive organization of materials on the molecular, nanometer, submicron, micron and macroscopic size levels. Supercapacitor devices are preferably used for energy storage (FIG. 20). They consist of two electrodes to allow a potential to be applied across the cell, and there are therefore two double-layers present, one at each electrode/electrolyte interface. An ion-permeable separator is placed between the electrodes in order to prevent electrical contact, but still allows ions from the electrolyte to pass through. The electrodes are made of high effective surface-area materials such as porous carbon or carbon aerogels in order to maximize the surface-area of the double-layer. When a potential is applied, carbon at each electrode can either form a negative charge (concentration of electrons), or positive charge (removal of electrons). This creates a situation of taking porous carbon and polarizing charges. When load is applied, rapid flow of electrons from anode to cathode occurs (i.e., work). This type of configuration is known an “electrochemical double layer capacitor” (FIG. 21). High surface area, highly porous carbons with very thin film thickness are deposited onto charge collecting foils (e.g., Al, Ni) to create electrodes. Unlike batteries, supercapacitor is simply two carbon coated electrodes in close contact, separated by “separator layer” which screens ions. Carbon aerogels, mesoporous carbon thin films, carbon nanotubes have all been used as supercapactor electrode material. But, these materials are difficult and expensive to make and process to control the material structure (i.e, nanoscale porosity). Particularly preferred are polyacrylonitrile coated ferromagnetic colloid (˜20 nm) that assembles into 1-D chains and after pyrolysis affords carbon nanowire-like materials. Furthermore, “patchy” nanoparticles with sacrificial porogens, such as, polystyrene-random-acrylonitrile copolymers, or polymethyl methacrylate can also be added with PAN polymers to coat magnetic nanoparticles. After pyrolysis, porous shells of carbon nanowires can be prepared. Highly porous carbon materials can be prepared by further degradation of magnetic metallic cores by dissolution with mineral acids (e.g., HCl, HNO₃).

Supercapacitors. According to the present invention, the nanostructured carbon materials possessing hierarchical structure and porosity suitable for supercapacitor applications can be prepared. According to the present invention, metallic cores are functionalized with polymers that act as carbon precursors to obtain a polymer coated nanoparticle. Polymers acting as carbon precursors include polyacrylonitrile (PAN), including copolymers containing PAN units, each of which may be substituted or unsubstituted. Other polymers include resorcinol/for aldehyde copolymers. The polymer coated nanoparticles may be aligned using self assembly or preferably a magnetic field. The assembled chains then undergo pyrolysis to obtain a metal filled carbon nanowire. The temperature is not particularly limited as long as the assembled chains undergo the pyrolysis and a carbon wire is obtained. The pyrolysis may be a one stage or a two stage process. In a two stage process, a temperature of from 100 to 350° C. is used in the first stage and a temperature of from 500 to 900° C. is used in a second stage. The reaction time is in the order of 20 minutes to 5 hours. The reaction time includes all values and subvalues therebetween, especially including 30, 40, 50, 60 minutes, 1.5, 2, 2.5, 3.35, 4 and 4.5 hours. Preferably, the pyrolysis is a two stage temperature process with T1=250° C. in air for 1-2 hrs; T2=600-800° C. for 1-2 hrs. Acid degradation results in hollow carbon nanowires which may be further assembled into highly porous carbon nanowire networks (FIG. 19).

The supercapacitors of the present invention have high electrical conductivity, surface area and porosity.

Tuning of mesoporosity is possible by controlling the morphology of polymer coated nanoparticle thin films using self-assembled conditions (i.e., zero-field) and externally applied magnetic fields. Additional manipulation of micro- and mesoporosity can be obtained by controlling magnetic nanoparticle surface chemistry with a mixture of for example PAN and “sacrificial” polymer porogens. Magnetic assembly and pyrolysis of these “patchy” magnetic nanoparticles can afford porous 1-D carbon mesostructures from the thermal degradation of these “sacrificial” polymers that are carried in the carbonization process. A porogen that can be used in the present invention is any polymer that can be degraded thermally below T=400° C. Examples of porogens include but are not limited to PMMA and polystyrene-random-acrylonitrile (SAN). Poroges include polymers having polystyrene units. The present invention provides for highly oriented 1-D carbon nanomaterials with controllable porosity using solution phase magnetic assembly to expedite fabrication of electrochemical devices.

An attractive feature of using polymer coated nanoparticle materials is the ability to form free standing nanocomposite and carbonized thin films, for example when casting films from ferromagnetic PS-CoNPs (D_{Co colloid}=15 nm; M_{n PS shell}=5,000 g/mol, shell thickness=2 nm) on surfaces.

Solution deposition and orientation of polymer coated nanoparticle chains and carbon nanowires perpendicular to surfaces using external magnetic fields (100-300 mT) can be performed. This general approach offers a straightforward processing methodology to align carbon nanowires.

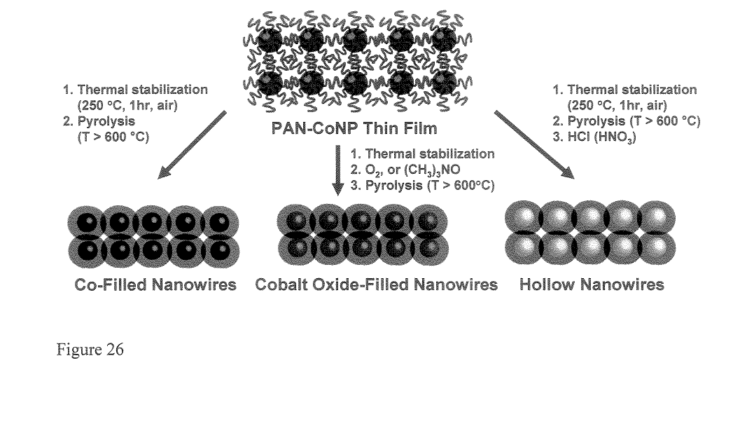

As previously discussed, ligand exchange using polymeric surfactants has been developed to controllably functionalize ferromagnetic cobalt nanoparticles. As summarized previously, ligand exchange of is used to prepare “patchy” magnetic nanoparticles that carry both carbonizing precursors and sacrificial porogens. Magnetic assembly and pyrolysis can afford 1-D carbon mesostructures with porosity in the carbon shell from the degradation of the sacrificial porogens (FIG. 19). Acidic degradation of the metal nanoparticle, (see FIG. 26), yields a hollow carbon nanowire with mesoporosity embedded in the carbon shell. A significant advantage is the highly modular nature of the system that allows controllable functionalization of ferromagnetic colloids using ligand exchange. Thus, highly oriented, 1-D carbon mesostructures can be prepared with tunable porosity in carbon phases. The marriage of these desirable properties is difficult to achieve in existing systems based on carbon nanotubes, or mesoporous carbons and is an attractive feature of the system according to the present invention.

In one embodiment, cobalt ferromagnetic colloids can be decorated with a polymer shell that is a precursor to carbon (i.e., poly-acrylonitrile, PAN).

Magnetic assembly of functional magnetic nanoparticles, followed by pyrolysis of one-dimensional (1-D) mesostructures can afford electro-chemically active carbon nanowires and ordered thin films. Partially graphitic materials can be prepared using this approach. These magnetically assembled carbon nanowires can possess both meso-(2-50 n) and microporosity (<2 nm) by control of thin film morphology and nanoparticle surface chemistry.

The preparation of “patchy” magnetic nanoparticles can be performed according to the present invention, where the coverage of PAN precursor chains can be systematically varied along with “sacrificial” polymers of poly(styrene-random-acrylonitrile) (SAN) that can degrade upon pyrolysis generating both micro- and mesoporosity in carbon shells. Additionally, metal nanoparticles cores can be degraded with mineral acid treatment to prepare hollow 1-D mesostructures that can also increase the accessible surface area of the carbon material (FIG. 19). Using this modular synthetic platform, micro- and mesoscale porous carbon can be designed to be electrically conductive and possess high capacitance. An attractive feature of this system is the use of solution-processable precursors that can be controllably organized using magnetic fields before pyrolysis to yield carbonaceous materials. This versatile system combines the advantageous of high surface area porous carbon with the highly oriented features of 1-D carbon nanotubes/nanofibers that have both been extensively investigated as supercapacitor electrodes.

Carbonaceous Supercapacitors. Supercapacitors have gained significant attention as potential power sources for portable energy and hybrid automotive vehicles. Charge-storage mechanisms based on electric double layer capacitors (EDLC) widely utilize high surface area carbon electrodes to maximize electrostatic interactions with electrolyte ions and create interfaces for charge separation. The characteristics of carbon-based supercapacitor electrode materials have been summarized as the following: (i) high electrical conductivity, (ii) high surface area, (iii) high dimensional stability (i.e., chemical, thermal), (iv) controlled porosity, (v) low cost and processability (Pandolfo, A. G.; Hollenkamp, A. F., Carbon properties and their role in supercapacitors. Journal of Power Sources 2006, 157, (1), 11-27.). Pseudocapacitors based on metal oxides, such as, ruthenium oxide (RuO₂) operate via fast faradiac redox reactions for charge storage, and have been reported to possess significantly higher specific capacitance values than carbon based electrodes (e.g., 700-1300 F/g.) (Hu, C.; Chang, K.; Lin, M.; Wu, Y., Design and Tailoring of the Nanotubular Arrayed Architecture of Hydrous RuO2 for Next Generation Supercapacitors. Nano Lett. 2006, ASAP; Miller, J. M.; Dun, B., Morphology and Electrochemistry of Ruthenium/Carbon Aerogel Nanostructures. Langmuir 1999, 15, 799-806). Porous conductive metal oxide aerogels have also been investigated by Rolison and Anderson et al. for these applications). Organic conjugated polymers, such as, polypyrrole (PPy), polyaniline (PA) and polythiophene (PT) have also been employed as pseudocapacitor electrodes, due to their relatively high capacitance values and facile solution processing methods via electropolymerization. See Conway, B. E.; Birss, V; Wojtowicz, J., The role and utilization of pseudocapacitance for energy storage by supercapacitors, Journal of Power Sources 1997, 66, (1-2), 1-14; Zheng J. P., Electrochem. Solid-State Lett. 1999, 2, 359; Ghosh, S.; Ignanas, S., Electrochemical Characterization of Poly(3,4-ethylene dioxythiophene) Based Conducting Hydrogel Networks. J. Electrochem. Soc. 2000, 147, 1872-1877; Groenendaal, B. L.; Jonas, F.; Freitag, D.; Pielartzik, H.; Reynolds, J. R., Poly(3,4-ethylenedioxythiophene) and Its Derivatives: Past, Present, and Future. Adv. Mater. 2000, 12, 481; Mastragostino, M.; Paraventi, R.; Zanelli, A., J. Electrochem. Soc. 2000, 147, 3167; Mastragostino, M.; Arbizzani, C.; Soavi, F., Solid State Ionics 2002, 148, 493.

While these pseudocapacitive materials possess intriguing properties, the collective features of carbonaceous EDLC electrodes, with respect to cost, dimensional stability and processing have made these attractive materials for supercapacitor applications. However, significant synthetic and processing challenges remain to prepare well-defined carbonaceous materials possessing controllable morphology and porosity with improved properties for supercapacitors.

Various carbon materials have been synthesized and electrochemically evaluated to create highly capacitive electrodes. Porous carbon electrodes have been widely studied as a route to these materials. See Fischer, U.; Saliger, R.; Bock, V.; Petricevic, R.; Fricke, J., Carbon aerogels as electrode material in supercapacitors, Journal of Porous Materials 1997, 4, (4) 281-285; Li, W.; Reichenauer, G; Fricke, J., Carbon aerogels derived from cresol-resorcinol-formaldehyde for supercapacitors. Carbon 2002, 40, (15), 2955-2959; Li, W.; Probstle, H.; Fricke, J., Electrochemical behavior of mixed CmRF based carbon aerogels as electrode materials for supercapacitors. Journal of Non-Crystalline Solids 2003, 325, (1-3), 1-5; Talbi, H.; Just, P. E.; Dao, L. H., Electropolymerization of aniline on carbonized polyacrylonitrile aerogel electrodes: applications for supercapacitors. Journal of Applied Electrochemistry 2003, 33, (6), 465-473; Proebstle, H.; Wiener, M.; Fricke, J., Carbon Aerogels for Electrochemical Double Layer Capacitors. Journal of Porous Materials 2004, 10, (4), 213-222; Shen, J.; Hou, J.; Guo, Y.; Sue, H.; Wu, G.; Zhou, B., Microstructure Control of Resorcinol-Formaldehyde and Carbon Aerogels Prepared by Sol-Gel Process. Journal of Sol-Gel Science and Technology 2005, 36, (2), 131-136.

The preparation of carbon aerogels has been conducted via crosslinking of phenolic resins (e.g., resorcinol/formaldehyde) to form gels, supercritical drying and pyrolysis of the intact porous network. Electrochemical studies confirmed that capacitance properties were strongly correlated with mesopore surface area, noting that aerogels possessing pore diameters ranging from 3-13 nm exhibited optimal device performance (Li, W.; Reichenauer, G.; Fricke, J., Carbon aerogels derived from cresol-resorcinol-formaldehyde for supercapacitors. Carbon 2002, 40, (15), 2955-2959; Proebstle, H.; Wiener, M.; Fricke, J., Carbon Aerogels for Electrochemical Double Layer Capacitors. Journal of Porous Materials 2004, 10, (4), 213-222). Other phenolic resins were also utilized to form microporous carbon materials by deposition into zeolites templates and subsequent pyrolysis (Johnson, S. A.; Brigham, E. S.; Olliver, P. J.; Mallouk, T. E., Chem. Mater. 1997, 9, 2448.). Porous PAN and carbon electrodes have also been prepared using supercritical drying methods, inverse emulsion, or air dried thin film methods to increase the capacitance of these materials (Gouerec, P.; Talbi H.; Miousse, D.; Tran-Van, F.; Dao, L. H.; Lee, K. H., Preparation and modification of polyacrylonitrile microcellular foam films for use as electrodes in supercapacitors. Journal of the Electrochemical Society 2001, 148, (1), A94-A101.). However, control of the porous morphology in these materials was difficult using these types of methods. This problem was addressed to some extent by the preparation of mesoporous carbon materials using ordered templates (e.g., mesoporous silica) (Lee, J.; Kim, J.; Hyeon, T., Recent progress in the synthesis of porous carbon materials, Adv. Mater. 2006, 18, 2073-2094).

1-D carbon nanostructures, such as, single- and multi-walled carbon nanotubes (SWNT, MWNT) have also been investigated as potential EDLC supercapacitor materials. See Liu, C.-Y.; Bard, A. J.; Wudl, F.; Weitz, I.; Heath, J. R., Electrochemical characterization of films of single-walled carbon nanotubes and their possible application in supercapacitors. Electrochemical and Solid-State Letters 1999, 2, (11), 577-578; Frackowiak, E.; Metenier, K.; Bertagna, V.; Beguin, F., Supercapacitor electrodes from multiwalled carbon nanotubes. Applied Physics Letters 2000, 77, (15), 2421-2423; An, K. H.; Jeon, K. K.; Heo, J. K.; Lim, S. C.; Bae, D. J.; Lee, Y. H., High-Capacitance Supercapacitor Using a Nanocomposite Electrode of Single-Walled Carbon Nanotube and Polypyrrole. Journal of the Electrochemical Society 2002, 149, (8), A1058-A1062; Frackowiak, E.; Beguin, F., Electrochemical storage of energy in carbon nanotubes and nanostructured carbons. Carbon 2002, 40, (10), 1775-1787; Frackowiak, E.; Delpeux, S.; Jurewicz, K.; Szostak, K.; Cazorla-Amoros, D.; Beguin, F., Enhanced capacitance of carbon nanotubes through chemical activation. Chemical Physics Letters 2002, 361, (1,2), 35-41; Hughes, M.; Chen, C. Z.; Shaffer, M. S. P.; Fray, D. J.; Windle, A. H., Electrochemical Capacitance of a Nanoporous Composite of Carbon Nanotubes and Polypyrrole, Chemistry of Materials 2002, 14, (4), 1610-1613; Hughes, M.; Shaffer, M. S. P.; Renouf, A. C.; Singh, C.; Chen, C. Z.; Fray, D. J.; Windle, A. H., Electrochemical capacitance of nanocomposite films formed by coating aligned arrays of carbon nanotubes with polypyrrole. Advanced Materials (Weinheim, Germany) 2002, 14, (5), 382-385; Lee, J. Y.; An, K. H.; Heo, J. K.; Lee, Y. H., Fabrication of Supercapacitor Electrodes Using Fluorinated Single-Walled Carbon Nanotubes. Journal of Physical Chemistry B 2003, 107, (34), 8812-8815; Chen, Q.-L.; Xue, K.-H.; Shen, W.; Tao, F.-F.; Yin, S.-Y.; Xu, W., Fabrication and electrochemical properties of carbon nanotube array electrode for supercapacitors. Electrochimica Acta 2004, 49, (24), 4157-4161; Dalton, A. B.; Collins, S.; Razal, J.; Munoz, E.; Ebron, V. H.; Kim, B. C.; Coleman, J. N.; Ferraris, J. P.; Baughman, R. H. Continuous carbon nanotube composite fibers: properties, potential applications, and problems. Journal of Materials Chemistry 2004, 14, (1), 1-3; Lota, K.; Khomenko, V.; Frackowiak, E., Capacitance properties of poly(3,4 ethylenedioxythiophene)/carbon nanotubes composites, Journal of Physics and Chemistry of Solids 2004, 65, (2-3), 295-301; Deng, M. Yang, B.; Hu, Y., Polyaniline deposition to enhance the specific capacitance of carbon nanotubes for supercapacitors. Journal of Materials Science 2005, 40, (18), 5021-5023. Du, C.; Yeh, J., Pan N., High power density supercapacitors using locally aligned carbon nanotube electrodes. Nanotechnology 2005, 16, (4), 350-353; Portet, C.; Taberna, P. L.; Simon, P.; Flahaut, E., Influence of carbon nanotubes addition on carbon-carbon supercapacitor performances in organic electrolyte. Journal of Power Sources 2005, 139 (1-2), 371-378; Zhou, C.; Kumar, S.; Doyle, C. D.; Tour, J. M., Functionalized Single Wall Carbon Nanotubes Treated with Pyrrole for Electrochemical Supercapacitor Membranes. Chemistry of Materials 2005, 17, (8), 1997-2002; Frackowiak, E.; Khomenko, V.; Jurewicz, K.; Loa, K.; Beguin, F., Supercapacitors

based on conducting polymers/nanotubes composites. Journal of Power Sources 2006, 153, (2), 413-418; Futaba, D. N.; Hata, K; Yamada, T.; Hiraoka, T.; Hayamizu, Y; Kakudate, Y.; Tanaike, O.; Hatori, H.; Yumura, M.; Iijima, S., Shape-engineerable and highly densely packed single-walled carbon nanotubes and their application as super-capacitor electrodes. Nature Materials 2006, 5, (12), 987-994; Jurewicz, K.; Babel, K.; Pietrzak, R.; Delpeux, S.; Wachowska, H., Capacitance properties of multi-walled carbon nanotubes modified by activation and ammoxidation. Carbon 2006, 44, (12), 2368-2375; Kim, Y.-T.; Mitani, T., Oxidation treatment of carbon nanotubes. An essential process in nanocomposite with RuO2 for supercapacitor electrode materials. Applied Physics Letters 2006, 89, (3), 033107/1-033107/3; Zhou, C.; Liu, T.; Wang, T.; Kuar, S., PAN/SAN/SWNT ternary composite: Pore size control and electrochemical supercapacitor behavior. Polymer 2006, 47, (16), 5831-5837; Du, C.; Yeh, J.; Pan, N., Carbon nanotube thin films with ordered structures. Journal of Materials Chemistry 2005, 15, (5), 548-550.

Carbon nanotubes (CNT) are attractive candidates for supercapacitors due to their high electrical conductivity and controllably mesoporosity arising from the central nanotube canal and voids formed from nanotube entanglements. Capacitance properties of these materials were found to be highly dependent on CNT thin film morphology and purity (20-180 F/g). Deposition of thin conjugated polymer coatings onto CNT has been reported as a route to increase the capacitance of these materials (170-256 F/g) combining both the electric double layer capacitance of CNTs and the redox capacitance of the conjugated polymer. See the references above and Wang, Y.-G.; Li, H.-Q.; Xia, Y.-Y., Ordered whiskerlike polyaniline grown on the surface of mesoporous carbon and its electrochemical capacitance performance. Advanced Materials (Weinheim, Germany) 2006, 18, (19), 2619-2623; Gupta, V.; Miura, N., Polyaniline/single-wall carbon nanotube (PANI/SWCNT) composites for high performance supercapacitors. Electrochimica Acta 2006, 52, (4), 1721-1726; Gupta. V.; Miura, N., Influence of the microstructure on the supercapacitive behavior of polyaniline/single-wall carbon nanotube composites. Journal of Power Sources 2006, 157, (1), 616-620; Beguin, F.; Szostak, K.; Lota, G.; Frackowiak, E., A self-supporting electrode for supercapacitors prepared by one-step pyrolysis of carbon nanotube/polyacrylonitrile blends. Advanced Materials (Weinheim, Germany) 2005, 177 (19), 2380-2384; Di Fabio, A.; Giorgi. A.; Mastragostino, M; Soavi, F., Carbon-poly(3-methylthiophene) hybrid supercapacitors. Journal of the Electrochemical Society 2001, 148, (8), A845-A850; An, K. H.; Kim, W. S.; Park, Y. S.; Choi, Y. C.; Lee S. M.; Chung, D. C.; Bae, D. J.; Li, S. C.; Lee, Y. H. Supercapacitors using single-walled carbon nanotube electrodes. Advanced Materials (Weinheim, Germany) 2001, 13, (7), 497-500.

The high cost of CNTs and challenges in processing of these materials remain critical issues in large-scale fabrication of devices.

Hybrid nanocomposite materials composed of carbon thin films from PAN precursors with SWNT inclusions have also been studied for supercapacitors (Liu, T.; Sreejumar, T. V.; Kumar, S.; Hauge, R. H.; Smalley, R. E., SWNT/PAN composite film-based supercapacitors, Carbon 2003, 41, 2427-2451). In this system, SWNT fillers were blended into carbon matrices to enhance electronic transport, introduce mesoporosity and toughen the thin film. At critical loadings of SWNT fillers (30-wt %) and optimized pyrolysis conditions of PAN, high capacitive properties were observed (100 F/g) despite low BET surface area values (157 m²/g). Specific capacitance values for the PAN-SWNT nanocomposite were significantly higher than for the SWNT, or the pyrolyzed PAN alone Additional porosity was incorporated into thin films of pyrolyzed PAN/SWNT nanocomposites by blending with poly(styrene-random-acrylonitrile) (SAN). While SAN is inherently immiscible with PAN thin films, the presence of SWNT inclusions compatabilized the two phases, SAN was degraded in these blended films when heated above 600° C. to introduce mesoporosity with pore sizes ranging from 1-200 nm. Specific capacitance values as high as 135 F/g were obtained SAN porogens in pyrolyzed PAN/SWNT blends.

Electrospinning of PAN fibers and pyrolysis also yielded carbonanceous materials for supercapacitors. Optimization of electrospinning, pyrolysis and activiation conditions formed entangled webs with fibers 300 nm diameter exhibiting maximum specific capacities of 173 F/g (Kim, C.; Yang, K. S., Electrochemical properties of carbon nanofiber web as an electrode for supercapacitor prepared by electrospinning. Applied Physics Letters 2003, 83, (6), 1216-1218).

Nanostructured Carbon via Self-Assembly. Processing approaches that harness self-assembly principles have the potential to allow large-scale fabrication of thin films and electrodes for supercapacitors. The controllable organization and assembly of nanostructured carbon materials remains an important technological challenge using bottom up approaches. One example of a self-assembling system is obtained using block copolymer templates of poly(acrylonitrile)-block-poly(n-butyl acrylate) (PAN-b-PBA) to prepare ordered, periodic arrays of carbon thin films. Annealing and pyrolysis of phase separated PAN-b-PBA thin films afforded periodic spherical, cylindrical, or lamellae domains of carbon, where the sacrificial PBA segment was burned off at higher temperatures (Kowalewski, T.; Tsarevsky, N. V.; Matyjaszewski, K., Nanostructured Carbon Arrays from Block Copolymers of Polyacrylonitrile. Journal of the American Chemical Society 2002, 124, (36), 10632-10633.). Highly oriented lamellae morphologies of carbon spanning microns in length were obtained using “zone-casting” thin film techniques (Tang, C.; Tracz, A.; Kruk, M.; Zhang, R.; Smilgies, D. M.; Matyjaszewski, K.; Kowalewski, T., Long-Range Ordered Thin Films of Block Copolymers Prepared by Zone-Casting and Their Thermal Conversion into Ordered Nanostructured Carbon. J. Am. Chem. Soc. 2005, 127, 6918-6919.). These examples demonstrate that non-covalent interactions and thin film processing can be utilized to organize soluble PAN precursors for pyrolysis into ordered nanostructured carbon materials.

The ferromagnetic colloids according to the present invention, (e.g., metallic cobalt, iron) can selectively assemble into micron-sized nanoparticle chains due to dipolar associations between nanoparticles. While the magnetic assembly of ferromagnetic nanoparticles via dipolar associations has been known since the 1960's, the utilization of this useful phenomenon as a tool for “bottom up” assembly has not been conducted, primarily due to limitations in the functionalization of ferromagnetic nanoparticles. According to the present invention, polymeric surfactants can effectively passivate ferromagnetic cobalt nanoparticles and carry useful functionality onto colloidal surfaces. Decoration of ferromagnetic cobalt nanoparticles with carbon precursors, such as, PAN, offers a unique opportunity to prepare 1-D carbon nanowires by the magnetic assembly of functional colloids and pyrolysis of organized mesostructures.

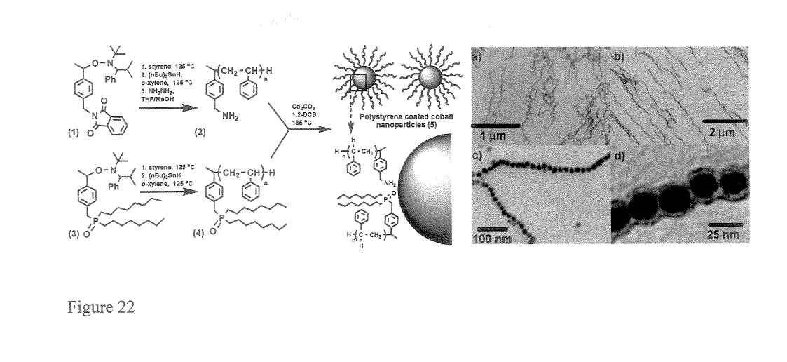

Magnetic Assembly to Form Ordered 1-D Carbon Nanowires. Polymer coated ferromagnetic cobalt nanoparticles. Transmission electron microscopy (TEM) imaging of the polymer-coated magnetic colloids according to the present invention deposited onto surfaces in the presence of a weak magnetic field (100 mT) revealed the formation of aligned nanoparticle chains spanning several microns in length (FIG. 22). These mesostructured materials were formed via the inherently long range interactions between ferromagnetic nanoparticles. Higher magnification TEM images indicate that the uniform nanoparticles are composed of metallic cobalt colloids (15±1 nm diameter) possessing a thin cobalt oxide layer (1 nm) and an organic polymer shell (2 nm thick). Atomic force and magnetic force microscopies (AFM, MFM) further confirmed the dimensions and assignment of these components. Vibrating sample magnometry (VSM) and powder x-ray diffraction (XRD) indicated that ferromagnetic f.c.c. cobalt colloids were prepared (Mₛ=38 emu/g. H_{c}=300 Oe, at 20° C.) without requiring high temperature annealing steps. It was confirmed by VSM and XRD that these PS-Co colloids retain their magnetic properties and do not further oxidize to cobalt oxide phases over periods of several weeks when stored in air (20° C. and 50° C.).

Functionalization of Ferromagnetic Colloids via Ligand Exchange. The versatile functionalization of ferromagnetic colloids has also been achieved by the inventor of the present invention using a ligand exchange process. While extensive work has been dedicated to the functionalization of gold (Au) and cadmium selenide (CdSe) quantum dots using ligand exchange reactions, synthetic methods to functionalize ferromagnetic nanoparticles are so far lacking. See Hostetler, M. J.; Green, S. J.; Stokes, J. J.; Murray, R. W., Monolayers in Three Dimensions: Synthesis and Electrochemistry of δ-Functionalized Alkanethiolate-Stabilized Gold Cluster Compounds. J. Am. Chem. Soc. 1996, 118, 4212-4213; Templeton, A. C.; Hostetler, M. J.; Kraft, C. T.; Murray, R. W., Reactivity of Monolayer-Protected Gold Cluster Molecules: Steric Effects. J. Am. Chem. Soc. 1998, 120, 1906-1911; Hostetler, M. J.; Templeton, A. C.; Murray, R. W., Langmuir 1999, 15, 3782-3789; Boal, A. K.; Ilhan, F.; DeRouchey, J. E.; Thurn-Albrecht, T.; Russell, T. P.; Rotello, V. M., Self-assembly of nanoparticles into structured spherical and network aggregates. Nature (London) 2000, 404, (6779), 746-748; Templeton, A. C.; Wuelfing, W. P.; Murray, R. W., Monolayer-Protected Cluster Molecules. Acc. Chem. Res. 2000, 33, 27-36; Astruc, D.; Chardac, F., Dendritic Catalysts and Dendrimers in Catalysis. Chemical Reviews 2001, 101, (9), 2991-3023; Frankamp, B. L.; Uzun, O.; Ilhan, F.; Boal, A. K.; Rotello, V. M., Recognition-Mediated Assembly of Nanoparticles into Micellar Structures with Diblock Copolymers. J. Am. Chem. Soc. 2002, 124, 892-893; Shenhar, R.; Rotello, V. M., Nanoparticles: Scaffolds and Building Blocks. Accounts of Chemical Research 2003, 36, (7), 549-561; Shenhar, K.; Norsten, T. B.; Rotello, V. M., Adv. Mater. 2005, 17, 657-669; Murray, C. B.; Norris, D. J.; Bawendi, M. C., Synthesis and Characterization of Nearly Monodisperse (E=S, Se, Te) Semiconductor Nanocrystallites. J. Am. Chem. Soc. 1993, 115, 8706-8715; Pathak, S.; Choi, S.; Arnheim, N.; Thompson, M. E., Hydroxylated quantum dots as luminescent probes for in situ hybridization. J. Am. Chem., Soc. 2001, 123, 4103-4104; Skaff, H., Ilker, M. F.; Coughlin, E. B.; Emrick, T., Preparation of Cadmium Selenide-Polyolefin Composites from Functional Phosphine Oxides and Ruthenium-Based Metathesis. Journal of the American Chemical Society 2002, 124, (20), 5729-5733; Skaff, H.; Emrick, T. S., The use of 4-substituted pyridines to afford amphiphilic, pegylated cadmium selenide nanoparticles. Chem. Comm. 2003, 52-53; Skaff, H.; Emrick, T. S., Reversible addition fragmentation chain transfer (AFT) polymerization from unprotected cadmium selenide nanoparticles. Angnew. Chem. Int, Ed. 2004, 43, 5383-5386; Skaff, H.; Sill, K.; Emrick, T. S., Quantum Dots Tailored with Poly(para-phenylene vinylene). J. Am. Chem. Soc. 2004, 126, 11322-11325.

The ligand exchange process is described above. For example, polystyrenic surfactants bearing amine and phosphine oxide end-groups are first used to prepare ferromagnetic nanoparticles and are then replaced with other functional polymers with end-functional ligands (i.e., —COOH) that possess a higher affinity for the colloidal surface. The major advantage of the ligand exchange process is the mild conditions employed in the reaction (T=25-50° C.) enabling a much wider range of functionality that can be introduced to the ferromagnetic colloid periphery, in comparison to conditions used to synthesize nanoparticies (T=185° C.).

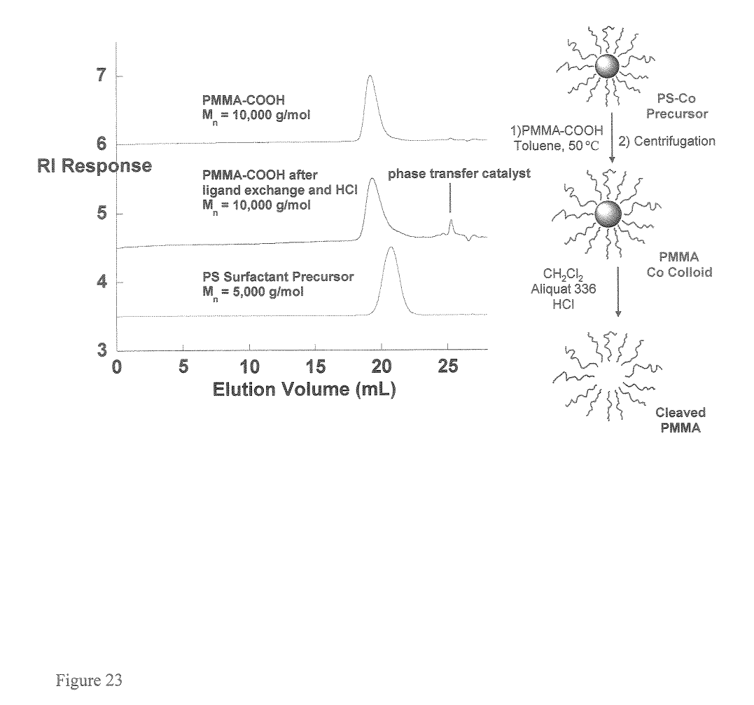

The inventor of the present invention has developed a straightforward analytical method to quantify the efficiency of ligand exchange by acidic degradation of metallic colloidal cores with mineral acids (e.g., HCl) and recovery of cleaved polymers. A development in this approach is the ability to cleanly isolate ligand-exchanged nanoparticles from free surfactants using centrifugation (e.g., 5.000 rpm, 20 min.) from good solvents. Polymer coated cobalt colloids are difficult to characterize directly using traditional NMR spectroscopy, or laser light scattering due to both the ferromagnetic properties and the strongly absorbing nature of these materials. Thus, by cleavage and recovery of ligand exchanged polymeric surfactants, traditional techniques, such as, size exclusion chromatography (SEC) and NMR, can be utilized to characterize the composition of organic nanoparticle shells (FIG. 23).

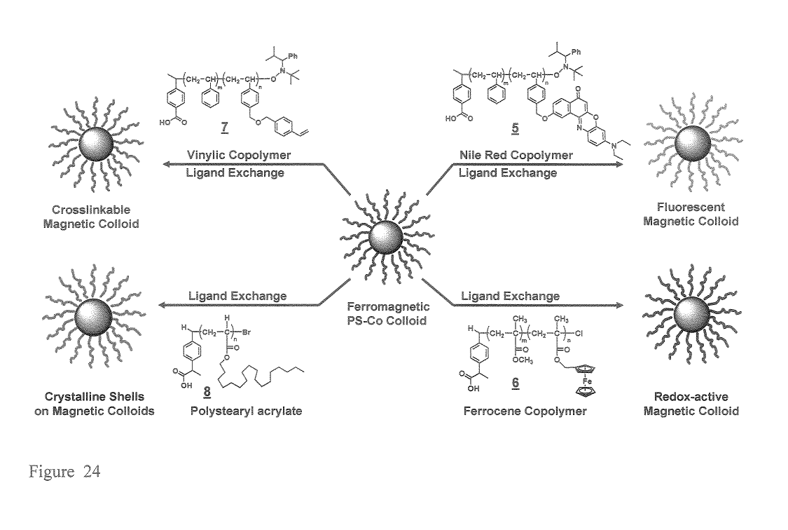

For the ligand exchange, carboxylic acid end-functional polymers were synthesized using controlled polymerization techniques, such as, atom transfer radical polymerization (ATRP), which allow synthesis of polymers possessing precise molecule weight, composition and functionality (Matyjaszewski, K., Xia, J., Atom Transfer Radical Polymerization. Chemical Reviews 2001, 101, 2921-2990). Using copolymerization of comonomers, or modification of protected side chain groups on copolymers, a wide range of functionality can be introduced onto polymeric surfactants and ferromagnetic nanoparticles via ligand exchange (FIG. 24).

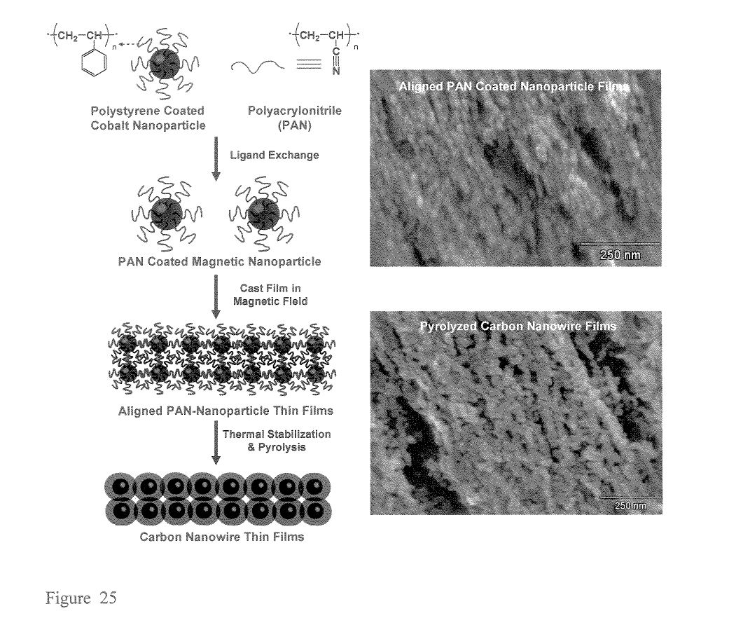

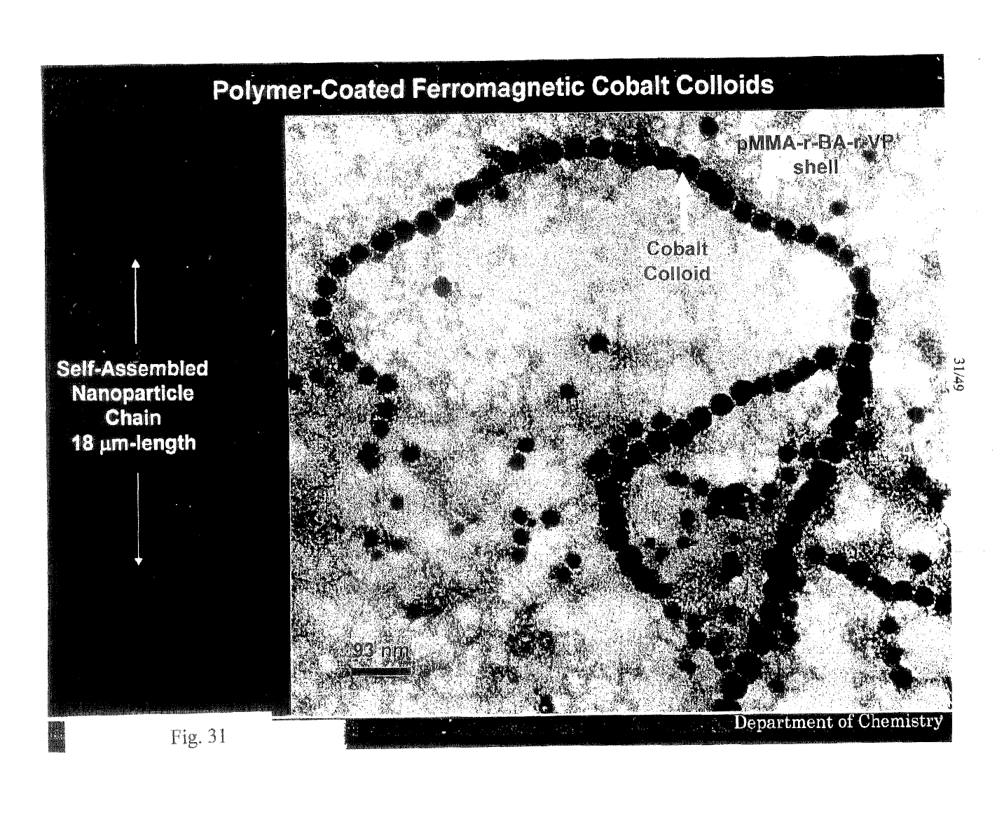

Synthesis of PAN Coated Magnetic Nanoparticles and Assembly into Carbon Nanowires. Carbon nanowires were synthesized using this general methodology by the synthesis magnetic assembly and pyrolysis of PAN coated ferromagnetic cobalt nanoparticies (PAN-CoNPs) (FIG. 25). Beginning with polystyrene coated cobalt nanoparticles (PS-CoNPs), PAN (Mₙ=6,000 g/mol; M_{w}/Mₙ=1.2) was synthesized using ATRP and ligand exchanged onto the ferromagnetic colloid while dispersed in, N,N-dimethylformamide (DMF). The nitrile side chain groups from PAN hompolymers were found to displace amine and phosphine oxide PS surfactants coordinated to the cobalt nanoparticle. SEC of HCl degraded PAN-CoNPs confirmed that quantitative exchange of PS for PAN chains occurred. Colloidal dispersions were then dropped cast onto Si wafers in the presence of a weak magnetic field (100 mT) yielding oriented films of PAN coated nanoparticle chains as confirmed using field-emission scanning electron microscopy (FE-SEM). Thermal stabilization in air at T=250° C. and pyrolysis at 600° C. for 1 hr afforded carbon nanowire thin films that retained the 1-D morphology from magnetically aligned PAN nanoparticle chains. X-ray photoelectron spectroscopy (XPS) and Raman spectroscopy of pyrolyzed materials confirmed the formation of graphitic carbon phases, which was likely catalyzed by the metallic cobalt colloidal inclusion. X-ray diffraction (XRD) and vibrating sample magnometry (VSM) confirmed that f.c.c. metallic cobalt nanoparticles survived the pyrolysis step and were annealed to form a more crystalline f.c.c. phase that exhibited higher magnetic moment and coercivity, C-AFM and FE-SEM analysis of these carbon nanowires confirmed that these materials were electrically conductive (see FIG. 31). Four-pt probe measurements are pending to quantify the conductivity of these materials.

Self-assembled, magnetically oriented carbon nanowires with controllable micro- and mesoporosity can be prepared. 1-D carbonaceous materials contain preferably metallic Co, cobalt oxide (CoO, or Co₃O₄), or hollow inclusions, which can be accessed by oxidation, or acidic dissolution of metallic Co colloids. Tuning of mesoporosity is possible by controlling the morphology of PAN-CoNPs thin films using self-assembled conditions (i.e., zero-field) and externally applied magnetic fields. Additional manipulation of micro- and mesoporosity can be obtained by controlling magnetic nanoparticle surface chemistry with a mixture of PAN and “sacrificial” polymer porogens. Magnetic assembly and pyrolysis of these “patchy” magnetic nanoparticles can afford porous 1-D carbon mesostructures from the thermal degradation of these “sacrificial” polymers that are carried in the carbonization process. The present invention includes development of methods to scale-up the synthesis of PAN-CoNP's and “patchy” magnetic nanoparticles using inexpensive starting materials. Further, the present invention provides for highly oriented 1-D carbon nanomaterials with controllable porosity using solution phase magnetic assembly to expedite fabrication of electrochemical devices.

Carbon Nanowire Thin Films Effect of Magnetic Nanoparticles. The synthesis and characterization of metal-filled carbon nanowires from PAN-CoNPs can be conducted as a benchmark for electrical conductivity and electrochemical properties. These magnetically assembled carbon nanowires exhibit similar electrochemical properties to carbon nanotube-based supercapacitor electrodes.

The synthesis of cobalt oxide filled carbon nanowires can be performed by oxidation of PAN-CoNP thin films after the thermal stabilization step (T=250° C., 1 hr. in air), but before high temperature pyrolysis (FIG. 26). Upon thermal stabilization PAN can form a ladder polymer network, which serves as a crosslinked intermediate before carbonization. At this stage, it is anticipated that the 1-D structure of magnetically assembled chains can remain intact, however, the metal colloid can be still be accessible to small molecule oxidizing agents. Exposure of stabilized PAN-CoNP thin films to oxygen, or strong oxidizers, such as, N-methyloxide ((CH₃)₃N0) can then be conducted to oxidize the Co core to cobalt oxide colloids. ND, XPS and TEM can be used to characterize the extent of Co colloid oxidation, and the phase of cobalt oxides (i.e., CoO vs. CO₃O₄) that are formed. The use of CO₃O₄ has been reported to possess high specific capacitance values (410 F/g) and may enhance capacitive capabilities as colloidal inclusions in carbon nanowires (Cao, L.; Lu, M.; Li, H. L., J. Electrochem. Soc. 2005, 152, A871). The deposition of cobalt oxides has also been conducted onto carbon electrode to increase the specific capacitance of these materials. In a similar fashion, the presence of cobalt oxide inclusions in carbon nanowires may also enhance the capacitive properties of the hybrid materials via charge storage directly into nanoparticles (i.e., pseudocapacitance).

Hollow carbon nanowires can also be prepared by etching of cobalt cores with mineral acids (e.g., HCl, HNO₃) (Zalich, M. A.; Baranauskas, V. V.; Riffle, J. S.; Saunders, M.; St. Pierre, T. C., Structural and magnetic properties of oxidatively stable cobalt nanoparticies encapsulated in graphite shells. Chemistry of Materials 2006, 18, (11), 2648-2655). Degradation of magnetic nanoparticles can be evaluated both after the thermal stabilization step and after pyrolysis. Characterization of the acid dissolution of metal colloids can be conducted also be conducted by XRD, XPS and TEM measurements. BET surface area measurements can also be conducted before and after the particle degradation to quantify changes in porosity generated from creating hollow inclusions.

Control of Porosity in Carbon Nanowire Thin Films. Control of Thin Film Morphology. Porosity generated from 1-D carbonaceous materials prepared from PAN-CoNPs arises from voids generated between entanglements of carbon nanowires. Limited microporosity is present after pyrolysis in carbonized PAN shells. Similar behavior was observed for thin films of carbon nanotubes. This mesoporosity can be controlled by manipulation of PAN-CoNP morphology when solution casting films onto substrates. An attractive feature of using polymer coated PAN-CoNP materials is the ability to form free standing nanocomposite and carbonized thin films, for example when casting films from ferromagnetic PS-CoNPs (D_{Co colloid}=15 nm; M_{n PS shell}=5,000 g/mol, shell thickness=2 nm) on surfaces. When colloidal dispersions in toluene were cast onto supporting surfaces, the formation of brittle, glassy films was observed when deposited both with and without an applied magnetic field (˜100 mT). Robust films were prepared by blending a small amount of free PS (Mₙ=5,000 g/mol) with PS-Co nanoparticles, ranging from 10-50 wt % of free PS chain in the thin film. There is an effect of processing conditions on the morphology of PS-Co nanoparticle ultra-thin films cast onto TEM grids. By variation of the solvents used in the deposition, the formation of discrete morphologies of non-chemically linked assembled chains can be controlled. The solvents include a combination of good and poor solvents for each polymer shell, in case of polystyrene coated nanoparticles, toluene and methanol is a preferred one co-solvent system dichlorobenzene/methanol can be used as well. Ultra-thin films cast from toluene in the absence of an applied field formed an entangled network of assembled chains residing in more extended conformations (FIG. 27a). Rigidly aligned chains formed when a weak magnetic field was applied during solution deposition of PS-CoNPs (FIG. 27b) However, when a mixture of volatile dichloromethane (CH₂Cl₂) and non-volatile 1,2-dichlorobenzene (DCB) was used to prepare thin films, the formation of a densely packed ultra-thin film composed of non-chemically linked nanoparticle chains in coiled and looped conformations was observed, which is reminiscent of lamellar morphologies observed in organic semi-crystalline polymers (FIG. 27c). The self-assembly process leads to formation of lamellae-like structures and is attributed to the vast difference in volatility of CH₂Cl₂ vs. DCB (1,2-dichlorobenzene).

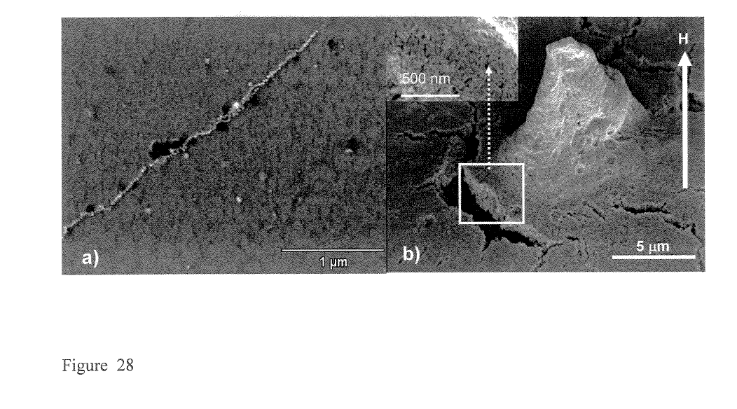

Similar morphologies of randomly entangled, aligned, and lamellae carbon nanowires can be formed using the polymer coated nanoparticles of the present invention such as PAN-CoNPs. Determination of porosity with BET surface area measurements can be conducted in addition to electrochemical analysis (CV, EIS) to allow structure-property correlations of carbon nanowire morphology with capacitance. Magnetic field alignment and pyrolysis of PAN-Co NP chains from DMF solutions has been achieved onto graphite (FIG. 28a). Micron-sized nanowires oriented parallel to supporting substrates were imaged using FE-SEM.

Solution deposition and orientation of PAN-CoNPs chains and carbon nanowires perpendicular to surfaces using external magnetic fields (100-300 mT) was performed. This general approach offers a straightforward processing methodology to align carbon nanowires. Magnetical orientation of carbon nanowires perpendicular to Si substrates was performed demonstrating that PAN-CoNPs cast from DMF are responsive to the external fields, organizing into micron sized bundles of nanoparticle chains. FE-SEM of pyrolyzed thin films confirmed the formation of tall aggregates (˜5 μm) ubiquitously spaced throughout the Si substrate, composed of hundreds carbon nanowires (FIG. 28b). Numerous cracks were observed in the carbonized thin film, presumably due to strain induced from the magnetic assembly of PAN-CoNP into larger aggregates. Titled FE-SEM images (45°) along crack edges confirmed that carbonized nanowires were oriented in the direction of the applied field (FIG. 28b-top left insert). The above results demonstrate the viability of perpendicular alignment using magnetic fields.

Synthesis of “Patchy” Magnetic Nanoparticles with Sacrificial Polymer Porogens. As previously discussed, ligand exchange using polymeric surfactants has been developed to controllably functionalize ferromagnetic cobalt nanoparticles. As summarized previously, ligand exchange of PS-CoNP with PAN and SAN polymers is used to prepare “patchy” magnetic nanoparticles that carry both carbonizing precursors and sacrificial porogens. Magnetic assembly and pyrolysis can afford 1-D carbon mesostructures with porosity in the carbon shell from the degradation of the SAN-sacrificial (FIG. 19). Acidic degradation of the metal nanoparticle, as described previously (see FIG. 26), yields a hollow carbon nanowire with mesoporosity embedded in the carbon shell. An significant advantage is the highly modular nature of the system that allows controllable functionalization of ferromagnetic colloids using ligand exchange. Thus, highly oriented, 1-D carbon mesostructures can be prepared with tunable porosity in carbon phases. The marriage of these desirable properties is difficult to achieve in existing systems based on carbon nanotubes, or mesoporous carbons and is an attractive feature of the system according to the present invention.

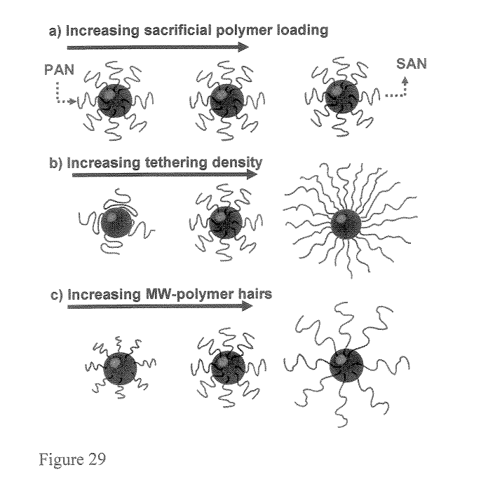

A systematic approach is used for the surface functionalization of PAN and sacrificial polymer porogens to ascertain optimal nanoparticle motifs to yield materials for supercapacitors (FIG. 29). Hybrid materials of end-tethered organic polymers on inorganic colloids are part of a broad class of materials, referred to as polymer brushes. In these systems, a strong dependence of polymer shell film thickness on the grafting density and molecular weight of end-tethered polymer chains has been shown. Different motifs of polymer functionalization onto ferromagnetic colloids, pyrolyze organized assemblies and fully correlate particle structures with electrochemical properties have been performed. In one embodiment, variation of PAN to SAN polymer loading onto nanoparticle surfaces using ligand exchange reactions is used. As for the case of PAN, nitrile side chains groups from SAN are sufficient to coordinate to cobalt colloidal surfaces. However, end-functionalization SAN polymers with carboxylic acid (COOH) ligating groups can also be conducted via ATRP methods. Higher loadings of SAN sacrificial polymers onto cobalt nanoparticles can increase the porosity and surface area of pyrolyzed carbon materials. However, minimum PAN loading onto nanoparticles can be determined to insure the formation of coherent, conductive carbon nanowires.

Electrochemical analysis of carbon materials. Electrical conductivity. Conductivity measurements of carbon nanowire materials with Co. cobalt oxide and hollow inclusions can be conducted using C-AFM and four-point probe measurements.

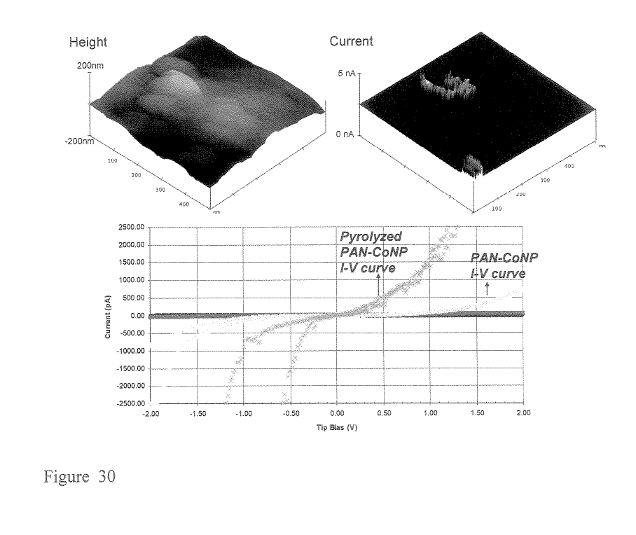

C-AFM measurements on PAN-CoNPs before and after pyrolysis confirmed the formation of conductive materials (FIG. 30). The current-voltage (I-V) characteristics of PAN-CoNPs determined from C-AFM were found to be non-conductive at measured voltages up to 1.5. After short pyrolysis of PAN-CoNPs at 600° C. for 10 minutes, I-V curves exhibited rectifying behavior with an approximate turn-on voltage of 0.5 V. The modest conductivity of the pyrolyzed PAN-CoNP was attributed to the short pyrolysis times that presumably did not afford a high yield of graphitic carbon phases. Optimization of thermal stabilization and pyrolysis conditions can be conducted, in addition to four-point probe measurements. Magnetically aligned films can also be prepared to examine anisotropy effects on the electrical conductivity of carbonized materials.

Capacitance measurements. CV can be extensively utilized to determine the capacitance of carbonaceous materials prepared from PAN-CoNPs by dividing output current by scan rates in the measurement. Screening of carbon nanowire samples with various inclusions can be conducted by CV to evaluate the capacitance of these materials. Impedence spectroscopy of these materials can also be used to characterize the frequency dependence on the capacitive properties. Galvanic charge-discharge experiments at constant current can also be performed to confirm rapid response times. Experiments can be performed in aqueous media using either H₂SO₄, or KOH as the electrolyte. Electrodes for electrochemical measurements can be fabricating using established methods for carbon nanotubes, or PAN/SWNT materials. Direct deposition/pyrolysis of PAN-CoNPs onto nickel foils as charge collectors can initially be attempted. The electrochemical properties of PAN-CoNP films before and after pyrolysis can be conducted to determine if the Ni foils survive the carbonization process without compromise of electrochemical properties. Free standing films of PAN-CoNPs can also be cast into thick films (1-10 μm) on Si substrates and pyrolyzed to form carbonaceous materials which can be directly sandwiched between steel, or Ni current collectors. Pellets from PAN-CoNPs can also be pressed and directly pyrolyzed to form supercapacitor electrodes. Free PAN can be blended with PAN-CoNPs if cracking in films, or pellets are observed after pyrolysis. Chemical activation of carbonized samples can also be investigated using established methods by treatment with NaOH, or KOH to generate additional porosity into the electrode material.

Electrodeposition of conjugated polymers. Deposition of conducting polymers, such as, polypyrrole, or polythiophene can also be performed as a route to increase the specific capacitance of the carbonaceous materials of the present invention. Model systems are prepared by depositing PAN-CoNPs thin films onto indium tin oxide (ITO) substrates and pyrolyzed to form carbon nanowires. Electropolymerization in the presence of pyrrole, or thiophene is performed to coat thin layers of conjugated polymers onto the porous carbon network. C-AFM and spectroelectrochemistry are conducted to confirm the efficiency of the electropolymerization and characterize the electrical properties of coatings. To prepare materials for electrode thin films, carbonized films, or pellets from PAN-CoNPs can be immersed water in the presence of pyrrole, or thiophene monomers and electrochemically polymerized using FeCl₂, or FeCl₃ oxidizing agents.

Scale-up of PAN-CoNP and 1-D Carbon Materials. Model systems were employed to prepare PAN (co)polymers of precise molecular weight and uniform ferromagnetic Co colloids. Using these synthetic approaches gram quantities (1-2 g) of well-defined PAN-CoNP and carbonized materials can be accessible However for large-scale synthesis and fabrication of devices polymerization and particle forming methodologies amenable to scale-up are required.

The synthesis of PAN and SAN copolymer surfactants on multi-gram quantities can be conducted using conventional free radical polymerizations. Unlike ATRP, or other controlled radical polymerization, conventional radical polymerizations using benzoyl peroxide, or 2,2′-azobis(isobutyronitrile) (AIBN) typically afford polymers of high molar mass possessing broad molecular distributions (i.e., high polydispersity, M_{w}/Mₙ>1.5). However, the use of polydisperse PAN and SAN can not significantly affect the ability to prepare PAN-CoNP and carbon materials.

The scale-up synthesis of uniform, ferromagnetic Co nanoparticles can be conducted using a low temperature methodology (T=110° C., toluene) for the thermolysis of CO₂(CO)₈ using a polymeric surfactant. The preparation of polymer coated ferromagnetic Co colloids was reported by Thomas from the Chevron group in the 1960s's. These mild conditions allow particle reactions to be conducted on 10-100 g quantities of ferromagnetic Co nanoparticles. However, these magnetic colloids were difficult to handle due to rapid flocculation from dipolar associations and were not redispersible in organic solvents after isolation as a powder. To overcome this limitation, the inventor of the present invention developed the above described ligand exchange methodology to functionalize the nanoparticles according to the present invention, for example, ferromagnetic Co nanoparticles prepared from the method of Thomas with COOH-end functional polystyrene (PS) surfactants. After this ligand exchange step, multi-gram quantities of PS coated ferromagnetic Co nanoparticles exhibited long-term colloidal stability in organic media and was readily dispersed from the solid-state in non-polar solvents (e.g. toluene, THP, CH₂Cl₂). These particles were 20 nm in size and TEM confirmed that micron sized dipolar chains were formed when deposited onto carbon coated copper grids (FIG. 31).

To prepare multi-gram quantities of PAN-CoNP, “patchy” magnetic nanoparticles and carbon nanowire materials, preparation of polymer coated magnetic nanoparticles is performed using a combination of conventional free radical polymerization and the method of Thomas to prepare precursor materials. PAN and SAN (co)polymers can be synthesized and ligand exchanged onto Co colloids in DMP. Isolation of PAN-CoNPs can be achieved via centrifugation, or magnetic precipitation. At least 10-50 g quantities of PAN-CoNPs and “patchy” magnetic nanoparticles containing PAN and SAN chains can be prepared. Similar scales of pyrolyzed carbon materials can be synthesized, along with porous mesostructures after acid dissolution of cobalt colloids.

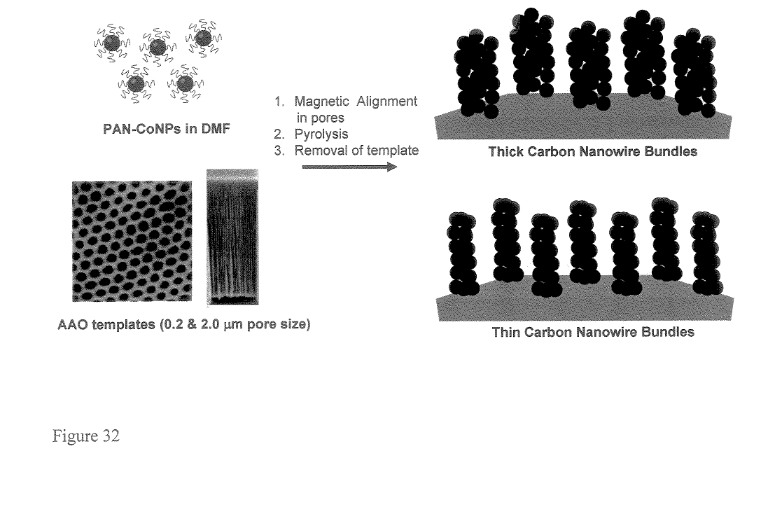

The successful development of 1-D carbon nanostructures can allow preparing ordered materials combining both the “bottom up” magnetic assembly of PAN-CoNPs with “top-down” patterning approaches. Ordered 1-D carbon nanowires are prepared using anodized aluminum oxide membranes (AAO) as templates to orient soluble PAN-CoNPs perpendicular to substrates, AAO membranes of varying pore diameters from 0.02 microns to 2 microns, are an alternative medium to create well-defined confined environments to corral PAN-CoNPs using solution processing. Pyrolysis and acid degradation of the alumina template can afford vertically aligned carbon nanowire arrays (FIG. 32).

An advantage of this template approach is the ability to vertically deposit PAN-CoNPs onto a wide range of substrates such as, conductive metal oxides, such as ITO, where the adsorption of nitrile groups onto surfaces can anchor nanoparticle arrays after pyrolysis and removal of the AAO membrane. Crosslinking generated from the formation of graphitic continuous shells can impart sufficient mechanical integrity to maintain 1-D vertical alignment of pyrolyzed assemblies.

Having generally described this invention, a further understanding can be obtained by reference to certain specific examples which are provided herein for purposes of illustration only, and are not intended to be limiting unless otherwise specified.

### EXAMPLES

### Measurement Methods

TEM images were obtained on a JEM100CX II transition electron microscope (JEOL) at an operating voltage of 60 kV, using in house prepared copper grids (Cu, hexagon, 270 mesh). Analysis of images was carried out using ImagePro 4.1 software (MediaCybemetics). Samples prepared by solution deposition of polymer coated magnetic nanoparticles onto carbon coated copper grids.

Magnetic VSM measurements were obtained using a Waker HF 9H electromagnet with a Lakeshore 7300 controller and a Lakeshore 668 power supply. Magnetic measurements were carried out at room temperature (300 K) and low temperature (40 K), with a maximum applied field of 15 kOe, a ramp rate of 33 Oe/s and a time constant of 0.1.

Thermal analysis: DSC data was obtained using a 2920 Modulated DSC (TA Instruments) running Thermal Solutions 1.4E (TA Instruments) software. DSC measurements were run in the range of −35° C. to 200° C., at a ramp rate of 10° C. per minute. TGA analysis was carried out using a TGA Q50 (TA Instruments) instrument and software from TA Instruments. TGA measurements were taken from 20° C. to 900° C. at a ramp rate of 20° C. per minute.

X-ray diffraction: XRD measurements were performed using the X'pert x-ray diffractometer (PW1827) (Phillips) at room temperature with a CuKα radiation source at 40 kV and 30 mA. The scan angle was from 30 to 80 degrees with a scan size of 0.2 degrees and a scan time of 0.5 seconds per 0.2 degrees. XPS characterization was performed on a KRATOS 165 Ultra photoelectron spectrometer, using a monochromatic A1 Kα radiation source.

Atomic and magnetic force microscopy: Magnetic force microscopy (MFM) studies were carried out with the aid of a Nanoscope III-M system (Digital Instruments, Santa Barbara, Calif.), equipped with a J-type “vertical engage” scanner. The MFM observations were performed at room temperature in air using silicon cantilevers with nominal spring constant of 1-5 N/m and nominal resonance frequency of 24-33 kHz (Co/Cr coated etched silicon probes). Topographic images were acquired with the cantilever oscillating at a frequency at which the oscillation amplitude was equal to 50% of amplitude on resonance. Typically, the ratio of cantilever operating amplitude A to free amplitude Ao ranged from 0.7 to 0.8 with Ao=2V (uncalibrated detector signal). Non-contact MFM images were acquired simultaneously with topography using interleaved lift mode, and frequency or phase shift detection. In the interleaved MFM scan, the cantilever was oscillated at its resonance frequency with the amplitude ranging from 7 to 14 V, and was scanned at the lift height of 150 nm above the previously recorded topographic profile. High lift heights and cantilever amplitudes employed here were shoves by other authors to assure, respectively, good separation of magnetic effects from topography and improved signal-to-noise ratio. All the images were acquired at a scan frequency of 1 Hz. Before imaging, the tips were magnetized with an external magnet and checked by imaging a standard magnetic recording tape. AFM/MFM samples were prepared by drop casting colloidal dispersions (1-wt % in toluene) onto carbon coated mica. Field aligned samples were prepared in a similar fashion between the poles of a hand magnet, or electromagnet (100 mT).

### Example 1

Controlled/living radical polymerization ((a) Matyjaszewski, K.; Xia, J. Chem. Rev 2001, 101, 2921-2990 (b) Hawker, C. J.; Bosman, A. W. Harth, E. Chem. Rev. 2001, 101, 3661-3688) has proven to be a versatile method for the synthesis of well-defined organic/inorganic hybrid materials. The versatility of controlled radical process allows for the incorporation of a wide range of functional groups to organic (co)polymers, which directly allows intimate interfacial compatabilization with inorganic materials.

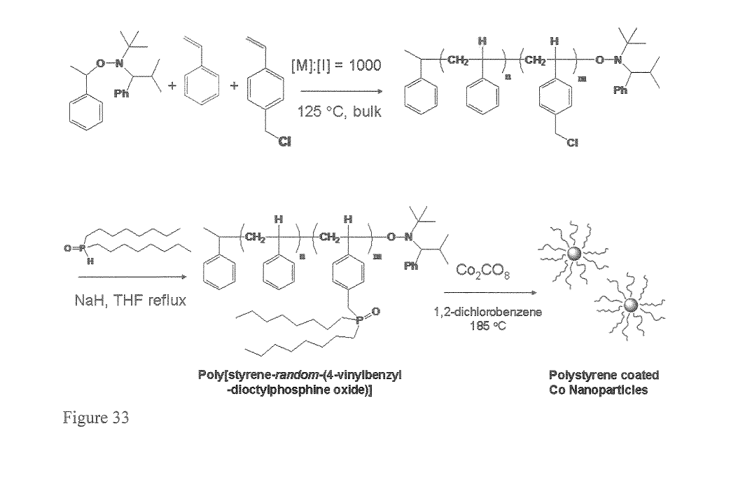

The preparation of polymer coated nanoparticles occurs via thermolysis of metal carbonyl complexes in the presence of functional copolymers. The use of the controlled/living radical polymerization methodology allowed systematic variation of various ligating moieties in copolymer surfactants. The synthesis of polymer coated cobalt nanoparticles proceeds using random copolymers containing phosphine oxide ligating groups (FIG. 33). The core-shell cobalt nanoparticles was characterized using transmission electron microscopy, thermal analysis and x-ray diffraction.

Materials. Styrene (Sty) 4-vinylbenzyl chloride (VBzCl) were purchased from Aldrich and filtered through neutral alumina before use. Dicobaltoctacarbonyl (CO₂CO₈) was purchased from Strem and used as received. Toluene (anhydrous), 1,2-dichlorobenzene (anhydrous) and were purchased from Aldrich and purged with argon for thirty minutes before use. 2,2,5-Trimethyl-3-(1-(4′-chloromethyl)phenylethoxy)-4-phenyl-3-azahexane and 2,2,5-trimethyl-4-phenyl-3-azahexane-3-nitroxide was prepared using previously reported methods. Linear random and block copolymers of poly[styrene random-(4-vinylbenzyl chloride)) were prepared using nitroxide mediated polymerizations as previously reported (Benoit, D.; Chaplinski, V. Braslau, R.; Hawker, C. J. J. Am. Chem. Soc. 1999, 121, 3904-3920).

Synthesis of poly[styrene-random-(4-vinylbenzyldioctylphosphine oxide)]. Dioctylphosphine oxide (160 mg, 0.96 mmol), sodium hydride (34 mg, 1.4 mmol) suspended in dry THF (5 mL) and refluxed for 30 minutes. A solution of poly[styrene-random-(4-vinylbenzyl chloride)] (Mₙ=50,000; M_{w}/Mₙ=1.40; 5-mol % pVBzCl) (1.000 g, 0.020 mmol-polymer) in THF (7 mL) was injected via syringe slowly and the reaction mixture was refluxed overnight under Ar. The mixture was quenched with a small amount of water and the polymer was recovered by precipitation into MeOH (1 L).

Representative procedure for the synthesis of copolymer coated cobalt nanoparticles Poly[styrene-random-(4-vinylbenzyldioctylphosphine oxide)]. (100 mg, 002 mmol) was dissolved in 1,2-dichlorobenzene (10 mL) and heated to 185° C. while stirring under argon. CO₂CO₈ (500 mg, 1.35 mmol) was dissolved in 1,2-dichlorobenzene (5 mL) at room temperature and rapidly injected into the hot copolymer solution. After 1-h stirring at 185° C., the black dispersion was allowed to cool to room temperature. The fluid was responsive to weak magnetic fields from standard horseshoe magnets. Samples for TEM were removed and diluted to a concentration of 1 mg/mL in toluene. Addition of the dispersion into an excess of hexane yielded a black solid precipitate which was dried under vacuum.

Synthesis of Functional Random Copolymers. The nitroxide mediated polymerization of Sty/VBzCl (95:5 vol %) was first conducted to yield a random copolymer (Mₙ=50,000; M_{w}/Mₙ=1.40) containing 5-mol % of benzyl chloride moieties. Comonomer mixtures with higher feed ratios of VBzCl in the polymerizations afforded poorly defined copolymers of high polydispersity, due to chain transfer to benzyl chloride groups. The incorporation of phosphine oxide groups to the copolymer was achieved using a similar methodology developed by Emrick et al.,⁴ via the alkylation of benzyl chloride moieties with dioctylphosphine oxide (FIG. 33) ¹H and ³¹P NMR confirmed complete consumption of benzyl chloride groups and the attachment of phosphine oxide functionalities to the copolymer.

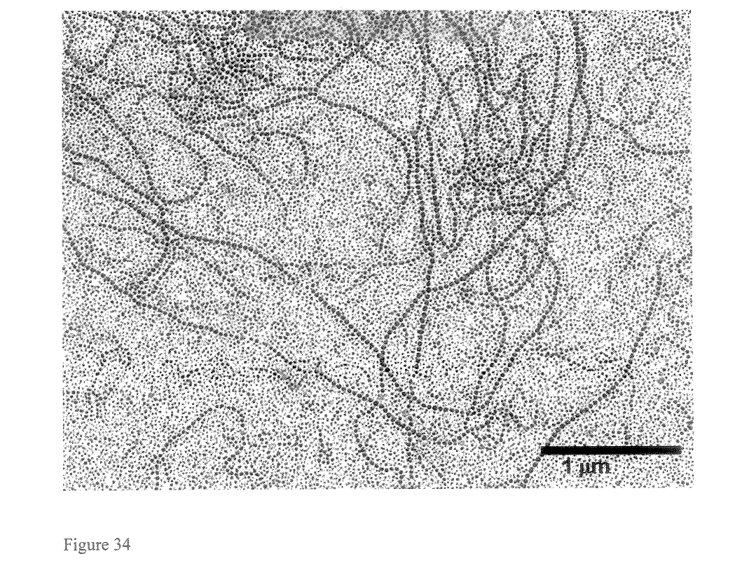

Synthesis and Characterization of Polymer Coated Cobalt Nanoparticles. Copolymers of poly[styrene-random-(4-vinylbenzyldioctylphosphine oxide)] were then used as surfactants in the thermolysis of dicobaltoctacarbonyl at 185° C. to prepare polymer coated cobalt nanoparticles.⁵ In the particle forming reaction, feed ratios of 20-wt % copolymer relative to metal carbonyl complex were used to target the formation of single-domain ferromagnetic colloids. TEM confirmed the formation of cobalt nanoparticles in the size range of 7-30 nm (FIG. 34). A striking feature of these images is the formation of extended magnetic chains of cobalt colloids assembled via dipolar associations, which extend over 2 microns in length.

### Example 1

demonstrates the viability of controlled/living radical techniques as a route to prepare functional copolymer surfactants for cobalt nanoparticles.

### Example 2

The preparation of polymer coated ferromagnetic nanoparticles is more challenging as high temperature annealing steps are often required to convert superparamagnetic colloids into ferromagnetic phases (Sun, S.; Murray, C. B. J. Appl. Plays. 1999, 85, (8, Pt. 2A), 4325-4330). A few examples of polymer coated ferromagnetic nanoparticles of metallic cobalt (Co) (Thomas, J. R. J. Appl Phys, 1966, 37, (7), 2914-15. (b) Safran, S. A., Nature Materials 2003, 2, (2), 71-72; Platonova, O. A.; Bronstein, L. M.; Solodovnikov, S. P.; Yanovskaya, I. M.; Obolonkova, E. S.; Valetsky, P. M.; Wenz, E.; Antonietti, M. Colloid Polym. Sci. 1997, 275, (5), 426-431), or iron have been reported, however, methodologies to synthesize well-defined nanocomposite colloids of uniform size and tunable magnetic properties have not been extensively developed.

The synthesis and characterization of polymer coated ferromagnetic nanoparticles that organize into extended one-dimensional assemblies is described in the following Controlled radical polymerization, specifically, nitroxide mediated polymerizations((a) Matyjaszewski, K.; Xia, J. Chem. Rev. 2001, 10, (9), 2921-2990. (b) Hawker, C. J.; Bosmran, A. W.; Harth, E. Chem. Rev. 2001, 101, (12), 3661-3688. (c) Benoit, D.; Chaplinski, V.; Braslau, R.; Hawker, C. J. Am. Chem. Soc. 1999, 121, (16), 3904-3920), allow the preparation of well-defined polymeric surfactants which were used to prepare uniform ferromagnetic cobalt nanoparticles. By control of macromolecular structure and functionality, the inventor of the present invention has demonstrated that polymeric surfactants can be synthesized to direct the formation of magnetic nanoparticles.

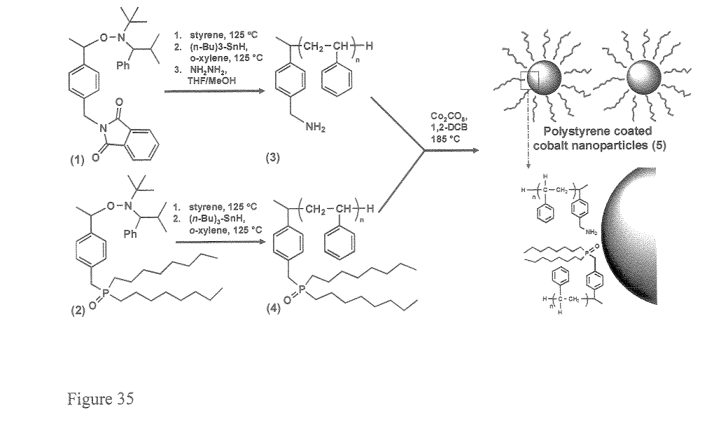

Polystyrene (PS) coated cobalt nanoparticles were synthesized by the thermolysis of dicobalt octacarbonyl in the presence of end-functional PS surfactants in refluxing 1,2-dichlorobenzene. Two different pS surfactants (Mₙ=5,000 g/mol; M_{w}/Mₙ=1.09) containing either a benzyl amine, or dioctylphosphine oxide end-groups were synthesized to mimic the small molecule surfactant system developed by Alivisatos et al., using aliphatic amines and trioctylphosphine oxide (TOPO) (FIG. 35) (Skaf, H.; Illker, M. F.; Coughlin, E. G.; Emrick, T. J. Am. Chem. Soc. 2002, 124, 5729-5733; (a) Puntes, V. F.; Krishnan, K. M.; Alivisatos, A. P. Science 2001, 291, (5511), 2115-2117. (b) Puntes, V. F.; Zanchet, D.; Erdonmez, C. K.; Alivisatos, A. P. Am. Chem. Soc. 2002, 124, (43), 12874-12880). A mixture of amine and phosphine oxide PS surfactants were then used in the thermolysis of CO₂CO₈ to prepare polymer coated cobalt nanoparticles, where the ligating end-group passivates the colloidal surface. The combination of both amine and phosphine oxide ligands were necessary to yield uniform ferromagnetic nanoparticles, which is in agreement with similar studies using small molecular surfactants. Furthermore, ferromagnetic cobalt colloids were obtained for pS surfactant systems despite variation of the molar mass although end-functional polymers possessing Mₙ=5,000 g/mol afforded the most uniform particle size distribution.

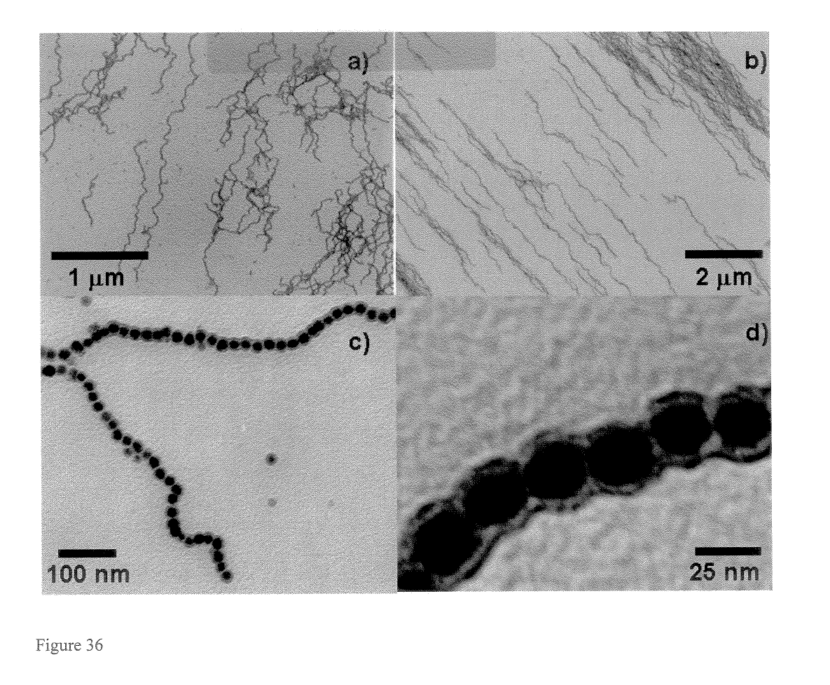

These polymer coated cobalt nanoparticles were then characterized using both transmission electron microscopy (TEM) and atomic force microscopy (AFM) to determine particle size and morphology of magnetic colloids and nanoparticle chains. Low magnification TEM images reveal the formation of highly uniform colloids organizing to extended nanoparticle chains spanning several microns in length (FIG. 36a). These chains are easily aligned by deposition of colloidal dispersion in the presence of weak magnetic fields (100 mT) (FIG. 36b). TEM images of these 1-D chains at higher magnification clearly demonstrate the presence of individual cobalt nanoparticles (D_{particle}=15 nm±1 nm) surrounded by a halo of pS (shell thickness=2=nm FIGS. 36c,d). AFM confirmed both the formation of pS coated cobalt nanoparticles of uniform size and were in good agreement with the TEM values. AFM imaging of magnetic nanoparticle chains passivated with pS surfactants (Mₙ=5,000; M_{w}/Mₙ=1.10) under variable temperature conditions further confirmed the presence of the pS shell, as evidenced by the onset of a glass transition (T_{g}) at 85° C. Differential scanning calorimetry (DSC) measurements of the bulk material did not observe a T_{g}, presumably due to the low fraction (˜30 N/t %) of the polymer coating to the inorganic core. The retention of the pS coating on cobalt nanoparticle was further confirmed using x-ray photoelectron spectroscopy, as evidenced by peaks at both 280 ev and 330 ev, assigned to carbon and cobalt atoms, respectively.

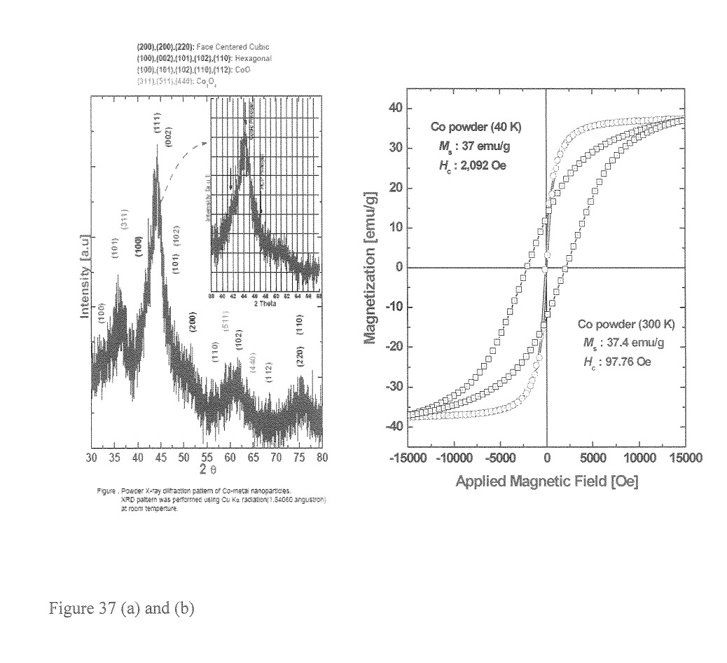

X-ray diffraction (XRD) (FIG. 37) of pS coated magnetic nanoparticles indicated that the face centered cubic phase of cobalt was formed from this process. The presence of small amount of cobalt oxide (CoO) was also detected, which was assigned to the formation a thin passivating oxide layer around the metal core. Vibrating sample magnometry (VSM) confirmed these hybrids materials were weakly ferromagnetic at room temperature (Mₛ=40 emu/g, H_{c}=100 Oe) and strongly ferromagnetic at 40 K (Mₛ=40 emu/g; H_{c}=2000 Oe). Significant enhancement of the magnetic coercively was observed by aligning nanoparticle chains under a weak magnetic field (Mₛ=40 emu/g, H_{c}=300 Oe) at 300 K.

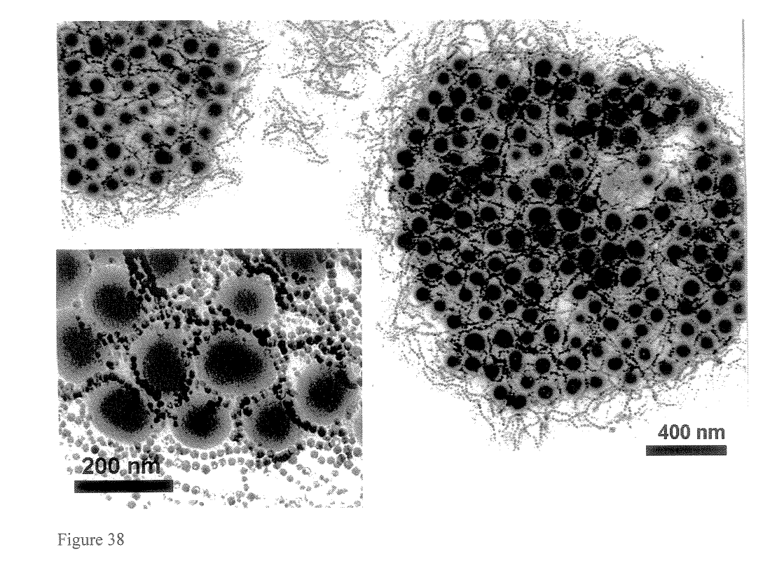

To illustrate the potential of 1-D nanoparticle chains for bottom up assembly, ferromagnetic pS-cobalt colloids were blended with silica beads (D=120 n) and cast onto TEM grids. The formation of micron-sized assemblies composed of isolated SiO₂ colloids dispersed in a matrix of pS-cobalt nanoparticle chains, as imaged from TEM (FIG. 38). While the overall size of the CO—SiO₂ binary assembly was not controlled, this morphology demonstrates that polymer coated nanoparticle chains possess sufficient mechanical integrity to maintain their 1-D structure when blended and cast onto surfaces, as observed in the organization of smaller nanoparticle chains around the silica colloid inclusions.

In conclusion, the synthesis of ferromagnetic cobalt nanoparticles using well-defined polymeric surfactants is described. By control of surfactant structure, ferromagnetic colloids possessing polymeric shell were able to be synthesized. These functional colloids are intriguing building blocks for bottom-up assembly and allow the preparation of more complex, organized mesoscopic structures.

### Example 3

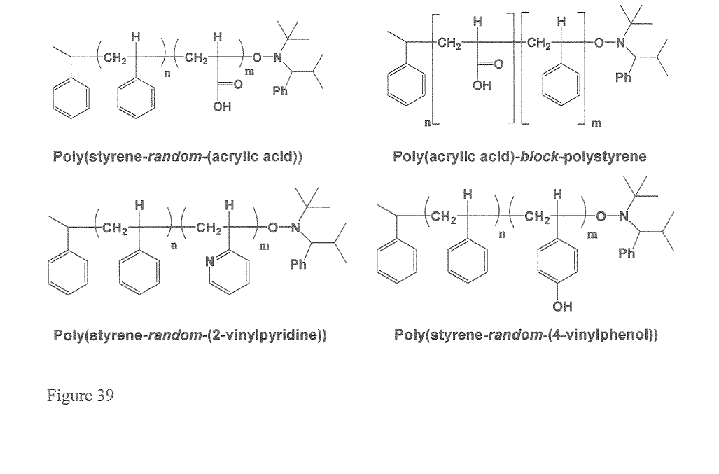

The preparation of magnetic nanoparticles composed of cobalt colloidal cores and organic copolymer shells is described. Controlled radical polymerizations were used to synthesize block and random copolymers incorporating different functional ligands with varying binding affinity to cobalt nanoparticles (FIG. 39). Previous studies with small molecule surfactants have demonstrated enhanced passivation of cobalt colloidal surfaces using oleic acid and trioctylphosphine oxide ((a) Thomas, J R.; J. Appl. Phys. 1966, 37, 2914 (b) Hess, P. H.; Parker, P. H.; J. Appl. Polym. Sci. 1966, 10, 1915-1927 (c) Dinega, D. P.; Bawendi, M. G. Angew. Chem. Int. Ed. 1999, 38, 1788-1791. (d) Puntes, V. F.; Krishnana, K. M.; Alivisators, A. P. Science 2001, 291, 2115-2117. (e) Puntes, V. F.; Zanchet, D.; Erdonmez, C. K.; Alivisatos, A. P. J. Am. Chem., Soc. 2002, 124, 12874-12880. (Tripp, S. L.; Pusztay, S. P.; Ribbe, A. E.; Wei, A. J. Am. Chem. Soc. 2002, 124, 7914-7915). Deprotected random, or block copolymers possessing pyridine, carboxylic acid, or phenol groups were prepared and used to synthesize cobalt nanoparticles via the thermal decomposition of dicobalt octacarbonyl (CO₂(CO)₈). The effect of copolymer composition on the particle size aid morphology of cobalt nanoparticles was then examined using transmission electron microscopy (TEM).

Materials. Styrene (Sty), t-butyl acrylate (tBA), 2-vinylpyridine (VP), 4-acetoxystyrene (AS) were purchased from Aldrich and filtered through neutral alumina before use. Dicobaltoctacarbonyl (CO₂CO₈) was purchased from Strem and used as received. Toluene (anhydrous), 1,2-dichlorobenzene (anhydrous) and were purchased from Aldrich and purged with argon for thirty minutes before use. Hydrazine hydrate was purchased from Aldrich and used as received, 2,2,5-Trimethyl-3-(1-(4′-chloromethyl)phenylethoxy)-4-phenyl-3-azahexane and 2,2,5-trimethyl-4-phenyl-3-azahexane-3-nitroxide was prepared using previously reported methods (Benoit, D.; Chaplinski, V.; Braslau, R; Hawker, C. J. J. Am. Chem. Soc. 1999, 121, 3904-3920.). Linear random and block copolymers of poly(styrene random-(t-butyl acrylate))poly(t-butyl acrylate)-block-polystyrene, poly(styrene-random-(2-vinylpyridine)) and poly(styrene-random-(4-acetoxystyrene)) were prepared using nitroxide mediated polymerizations as previously reported (Benoit, D.; Chaplinski, V.; Braslau, R; Hawker, C. J. J. Am. Chem. Soc. 1999, 121, 3904-3920; Harth, E.; Van Horn, B.; Lee, V. Y.; Germack, D. S.; Gonzales, C. P.; Miller, R. D.; Hawker, C. J. J. Am. Chem. Soc. 2002, 124. 8653-8660). Polyacrylic acid-block-polystyrene was prepared by the deprotection of poly(t-b-utyl acrylate)-block-polystyrene as previous reported (Davis, K. A.; Charleaus, B.; Matyjaszewski K. J. Polym. Sci. Polym. Chem. 2000, 38, 2274-2283).

Synthesis of poly(styrene-random-(4-vinylphenol)). Poly(styrene-random-(4-acetoxystyrene))(Mₙ=15,000; M_{w}/Mₙ=1.30; 25-mol % pAS) (800 mg, 0.05 mmol-polymer) was dissolved in a mixture of THF (25 mL), McOH (5 mL), hydrazine hydrate (3 mL) and stirred overnight at room temperature. The solution was then added to a large excess of stirring hexane (200 mL) and a white solid precipitate was recovered after vacuum filtration.

Instrumentation Size exclusion chromatography was conducted in a dichloromethane mobile phase with a Waters 510 isocratic pump with three Jordi columns (pore sizes 10⁴, 10³, 10² Å) and equipped with Waters 410 differential refractometer, 996 photodiode array and DAWN-EOS MALLS detectors. Molar masses were calculated using the Empower software (Waters) calibrating against linear polystyrene standards. NMR measurements were performed on a Broker DRX-500 MHz spectrometer. Transmission electron microscopy was performed on a JEOL 100 CX II instrument at 60 kV. Samples for TEM were prepared by drop casting dilute nanoparticle dispersions (1 mg/mL) onto carbon coated mica, floating the carbon film onto water and depositing onto a carbon coated grid.

Representative procedure for the synthesis of copolymer coated cobalt nanoparticles. Polyacrylic acid)-block-polystyrene (100 mg, 0.01 mmol-polymer, 0.20 mmol-acid) was dissolved in 1,2-dichlorobenzene (10 mL) and heated to 185° C. while stirring under argon. CO₂CO₈ (500 mg, 1.35 mmol) was dissolved in 1,2-dichlorobenzene (5 mL) at room temperature and rapidly injected into the hot copolymer solution. After 1-h stirring at 185° C., the black dispersion was allowed to cool to room temperature. The fluid was responsive to weak magnetic fields from standard horseshoe magnets. Samples for TEM were removed and diluted to a concentration of 1 mg/mL in toluene. Addition of the dispersion into an excess of hexane yielded a black solid precipitate which was dried under vacuum.

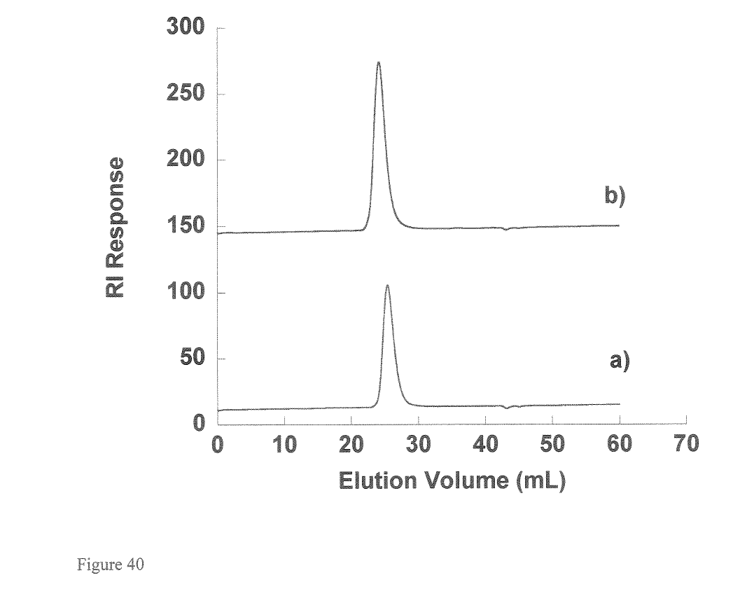

Synthesis of functional random and block copolymers. Random and block copolymers from styrene and t-butyl acrylate were prepared using bulk nitroxide mediated polymerization (Hawker, C. J.; Bosnian, A. W.; Harth, E. Chem. Rev. 2001, 101, 3661-3668; Benoit, D. Chaplinski, V.; Braslau, R; Hawker, C. J. J. Am. Chem. Soc. 1999, 121, 3904-3920.) Copolymers possessing a molar composition of 20-mol % poly(t-butyl acrylate) and molar masses in the range of 10,000 to 15,000 g/mol were targeted. ¹H NMR and SEC (FIG. 40) confirmed the preparation of well-defined poly(styrene-random-(t-butyl acrylate))(Mₙ=14,000; M_{w}/Mₙ=1.12; 25-mol % ptBA) and poly(t-butyl acrylate)-block-polystyrene (Mₙ=10,000; M_{w}/Mₙ=1.09; 20-mol % ptBA). Deprotection of t-butyl groups under acidic conditions using HCl and 1,4-dioxanesr afforded carboxylic acid containing random and block copolymers of poly(styrene-random-(acrylic acid)) and poly(acrylic acid)-block-polystyrene, as confirmed from ¹H NMR.

Poly(styrene-random-(4-acetoxystyrene))(Mₙ=15,000; M_{w}/Mₙ=1.30; 30-mol % pAS) was also synthesized via the nitroxide mediated copolymerization of styrene and 4-acetoxystyrene. Treatment of the copolymer with hydrazine quantitatively removed acetate groups as indicated by ¹H NMR, yielding poly(styrene-random-(4-vinylphenol)). Direct copolymerization of styrene and 2-vinylpyridine via the nitroxide mediated process yielded the poly(styrene-random-(2-vinylpyridine) copolymer (M_{n NMR}=13,000 g/mol; 15-mol % pVP) as indicated from ¹H NMR. SEC of the poly(styrene-random-(2-vinylpyridine)) in nonpolar media, such as, dichloromethane and tetrahydrofuran, were unsuccessful due to interaction of pyridine groups with the stationary phase, SEC measurements in more polar media (i.e., N,N-dimethylformamide) and the subject of future efforts.

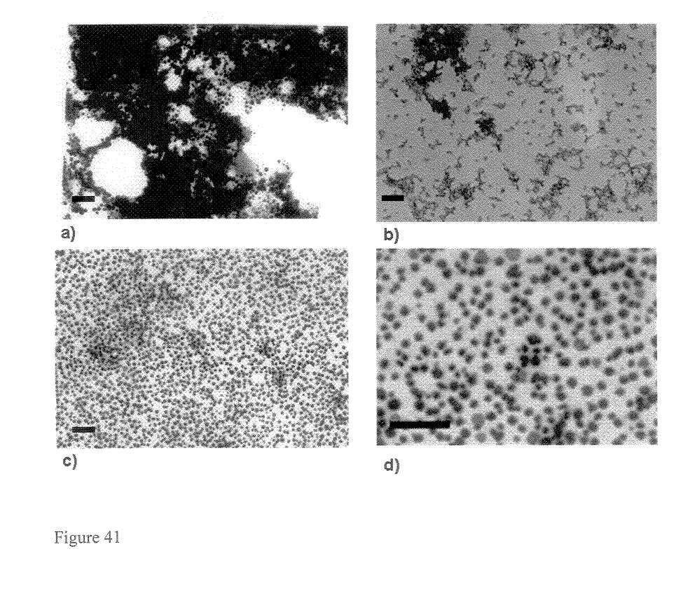

Synthesis of Cobalt Nanoparticles using Copolymer Surfactants. The synthesis of cobalt nanoparticles was first attempted by decomposition of CO₂CO₈ in the presence of poly(styrene-random-(4-vinylphenol)) at 185° C. in 1,2-dichlorobenzene. Different reports have demonstrated the ability of phenol groups to coordinate and stabilize cobalt and iron oxide nanoparticle dispersions (Tripp, S. E.; Pusztay, S. P.; Ribbe, A. E.; Wei, A. J. Am. Chem. Soc. 2002, 124, 7914-7915; Vestal, C. R.; Zhang, Z. J. J. Am. Chem. Soc. 2003, 125, 9828-9833). However, the use of poly(styrene-random-(4-vinylphenol)) as a surfactant in the thermolysis of CO₂CO₈ resulted in the formation of black precipitates, indicative of poor stabilization of growing cobalt species. TEM of the sol-fraction of the dispersion revealed the presence of large micron size particles composed of colloidal aggregates (FIG. 41a).

Thermolysis reaction of CO₂CO₅ in the presence of the poly(styrene-random-(2-vinylpyridine) formed stable magnetic dispersions (i.e., ferrofluids), indicative of the improved passivation of cobalt nanoparticles. These ferrofluids were able to respond to weak applied magnetic fields (−100 G). TEM revealed that cobalt nanoparticles prepared from this reaction possessed a spherical morphology, but nonuniform particle sizes ranging from 5-50 nm (FIG. 41b). Thus, while pyridine groups improved the ligation of the copolymer surfactant to cobalt complexes and colloidal surfaces, the preparation of nanoparticles with uniform size and morphology required the incorporation of functional groups with stronger interactions to insure efficient passivation.

Cobalt nanoparticles possessing a spherical morphology and uniform particle size were synthesized from copolymer surfactants containing carboxylic acid moieties (FIGS. 41c,d). Particle forming reactions were initially attempted with the poly(styrene-random-(acrylic acid), however, the limited solubility of the surfactant in arene solvents prevented evaluation of this copolymer to prepare nanoparticles. However, the poly(acrylic acid)-block-polystyrene copolymer was soluble in 1,2-dichlorobenzene at 185° C. and afforded spherical cobalt nanoparticles of uniform size in the range of 10-20 nm after thermolysis of the CO₂CO₈ particle precursor. The strong interactions of carboxylic acid groups and cobalt nanoparticle surfaces has been observed in other investigations using oleic acid and fatty acids (Wu, N; Fu, L.; Su, M.; Aslam, M.; Wong, K. C.; Dravid, V. P. Nanolett. 2004, 4, 383-386). The TEM results indicate that poly(acrylic acid) segments also efficient passivate magnetic colloids enabling control of size distribution and morphology under these conditions.

Cobalt nanoparticles have been successfully synthesized using functional random and block copolymers prepared from controlled radical polymerization. This polymerization methodology is a versatile route to prepare a variety of functional copolymers that effectively function as surfactants in the preparation of cobalt nanoparticles. The use of copolymers containing poly(acrylic acid) segments was shown to efficiently passivate cobalt nanoparticles, enabling the preparation of colloids with uniform size and morphology. The interfacial control achieved from this system is a direct consequence of the copolymer structure. This general approach allows intimate compatabilization of the organic and inorganic components, which may afford “plastic magnets” that possess the processing advantages of polymeric materials while retaining significant magnetic properties.

### Example 4

FIG. 31 shows ferromagnetic cobalt nanoparticle and micron-sized nanoparticle chains coated with a terpolymer surfactant of poly(methyl methacrylate-random-ethyl acrylate-random-(2-vinylpyrrolidone)(Mₙ=200,000 g/mol; M_{w}/Mₙ=2.0). Particle size=25 nm+4 nm. The sample was prepared by drop casting dilute nanoparticle dispersion in toluene (1 mg/mL) onto carbon coated copper grid.

### Example 5

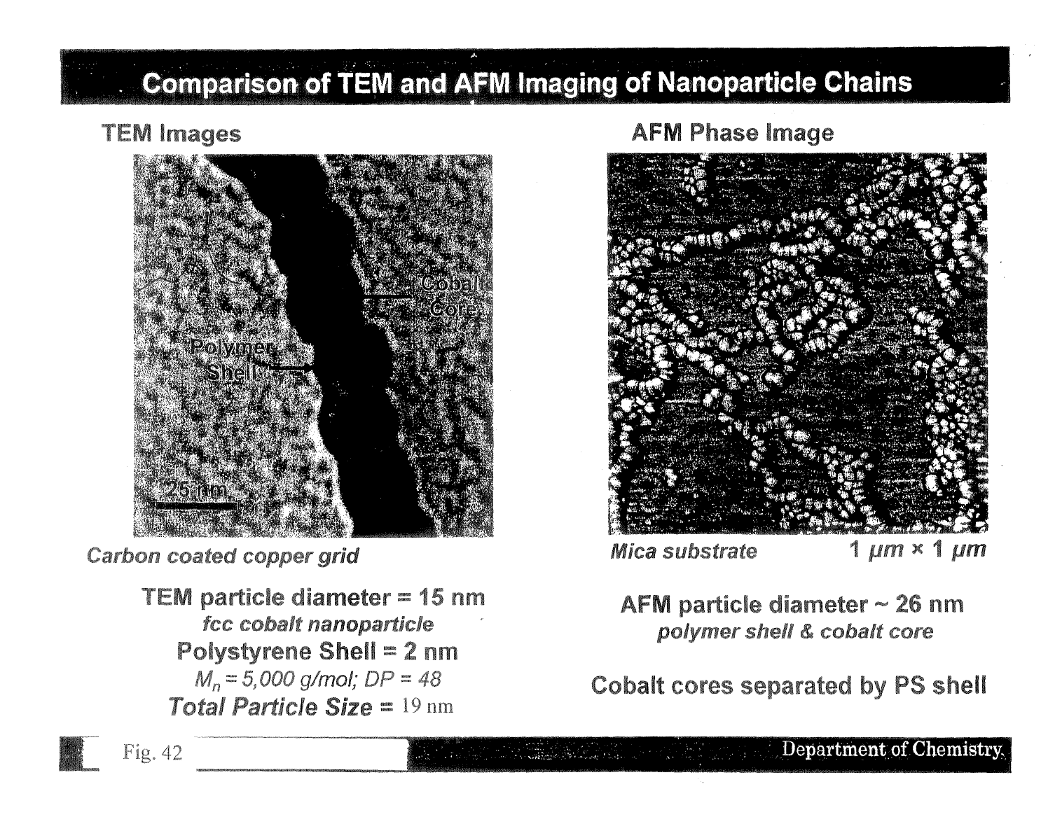

FIG. 42 shows (left image) TEM image of ferromagnetic polystyrene coated cobalt nanoparticies deposited onto carbon coated copper grid from dilute toluene nanoparticle dispersion (1 mg/mL). Polystyrene Mₙ=5,000 g/mol; M_{w}/Mₙ=1.10; particle size cobalt core=15 nm+1.5 nm; thickness of polystyrene shell=2 nm total diameter=19 nm. X-ray diffraction shows crystalline, FCC structure. Magnometry shows saturation magnetization of Ms=38 emu/g; magnetic coercivity, Hc=100 Oe at room temperature.

(right image): tapping mode atomic force microscopy image of same ferromagnetic nanoparticles.

### Example 6

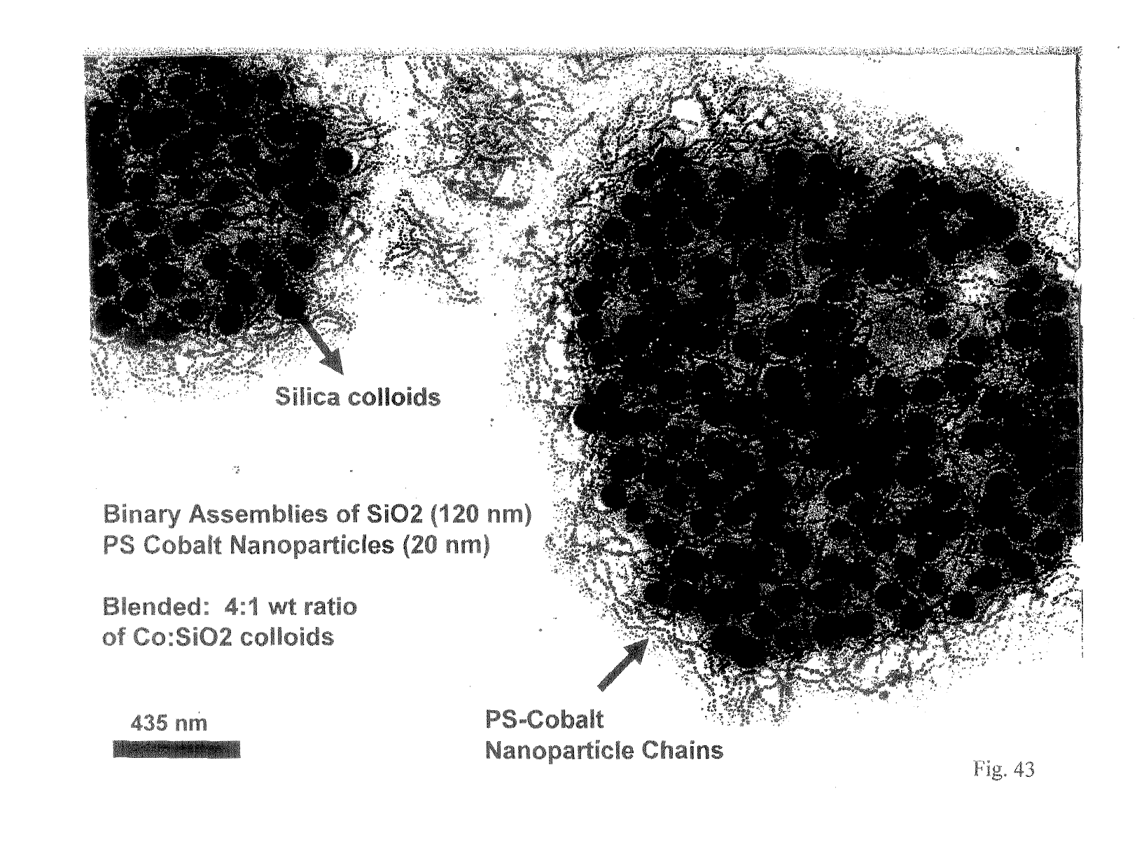

FIG. 43 shows a TEM image of a binary colloidal assembly of silica nanoparticles (particle size=170 nm) and ferromagnetic polystyrene nanoparticles (details same as for FIG. 42). The sample was prepared by dispersing both SiO₂ and PS-Co nanoparticles in toluene (1:4 wt-ratio of SiO₂ to PS-Co) and drop casting onto carbon coated TEM grid. Formation of 1-2 micron sized assemblies of PS-Co nanoparticle chains interdigitating between larger SiO₂ colloids was observed. This image demonstrates that magnetic associations between nanoparticles and entanglements from polystyrene hairs on nanoparticles is sufficient to hold together 1-D nanoparticle chains. In other words, PS-Co nanoparticles behave as nanoparticle chains, not single nanoparticles.

### Example 7

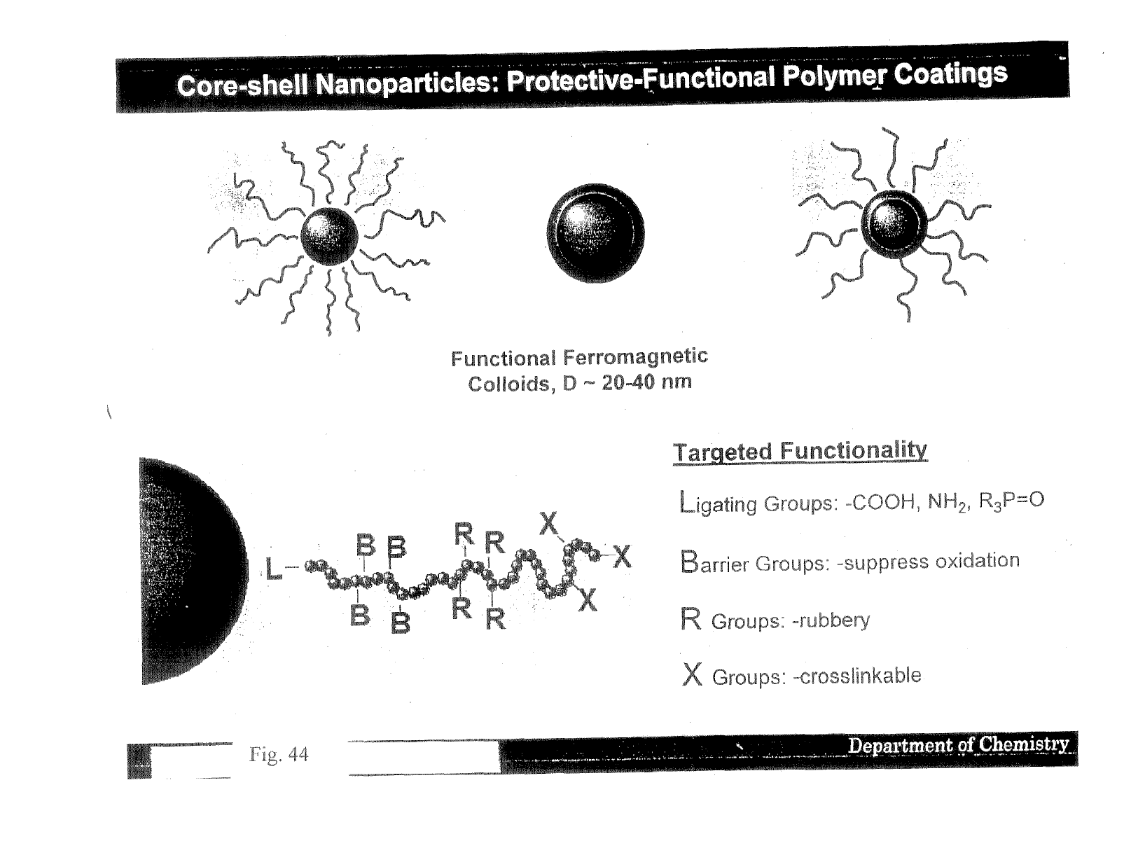

FIG. 44 shows a scheme (top): different arrangements of polymeric coatings on nanoparticles, (top-left)-end tethered polymers on nanoparticle surface forming “hairy nanoparticle,” (top-center)-dense crosslinked polymer shell around nanoparticle “shell-crosslinked nanoparticle,” (top-right)-combination of two previous architectures, multi-layer core-shell nanoparticle with dense crosslinked inner layer and “hairy” outer layer

(bottom-left): scheme of magnetic nanoparticle surface with single polymer chain coordination to surface. Polymer chain has many comonomer units carrying different functional groups. By controlling polymer structure, MW and composition, many different kinds of functionality can be introduced to particle shell (e.g., hydrophobic, hydrophilic, glassy, rubbery, crosslinkable, fluorescent, etc. . . . )

(bottom-right): description in words of kinds of functional groups and polymers that can be introduced to ferromagnetic nanoparticles. All of this is new ground for ferromagnetic nanoparticles.

### Example 8

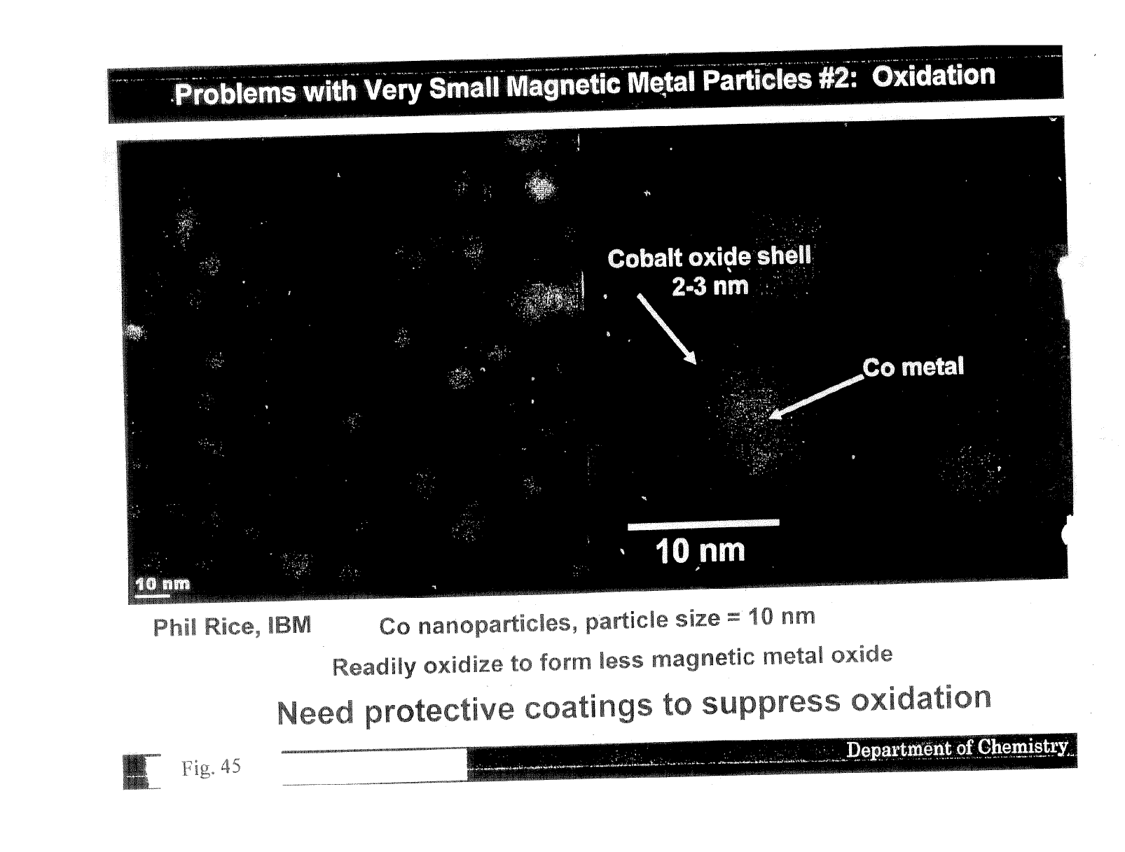

FIG. 45 shows (left) Dark-field TEM images of cobalt nanoparticles (10 nm) with 2 nm cobalt oxide layer that is antiferromagnetic (i.e., “non-magnetic”). (right) high resolution/magnification TEM image of same Co nanoparticles. Showing much more distinctly the 2 nm oxide layer around magnetic nanoparticles. For small particles, the oxide layer completely kills the magnetic properties since a significant volume fraction of nanoparticles is not metallic magnetic material.

### Example 9

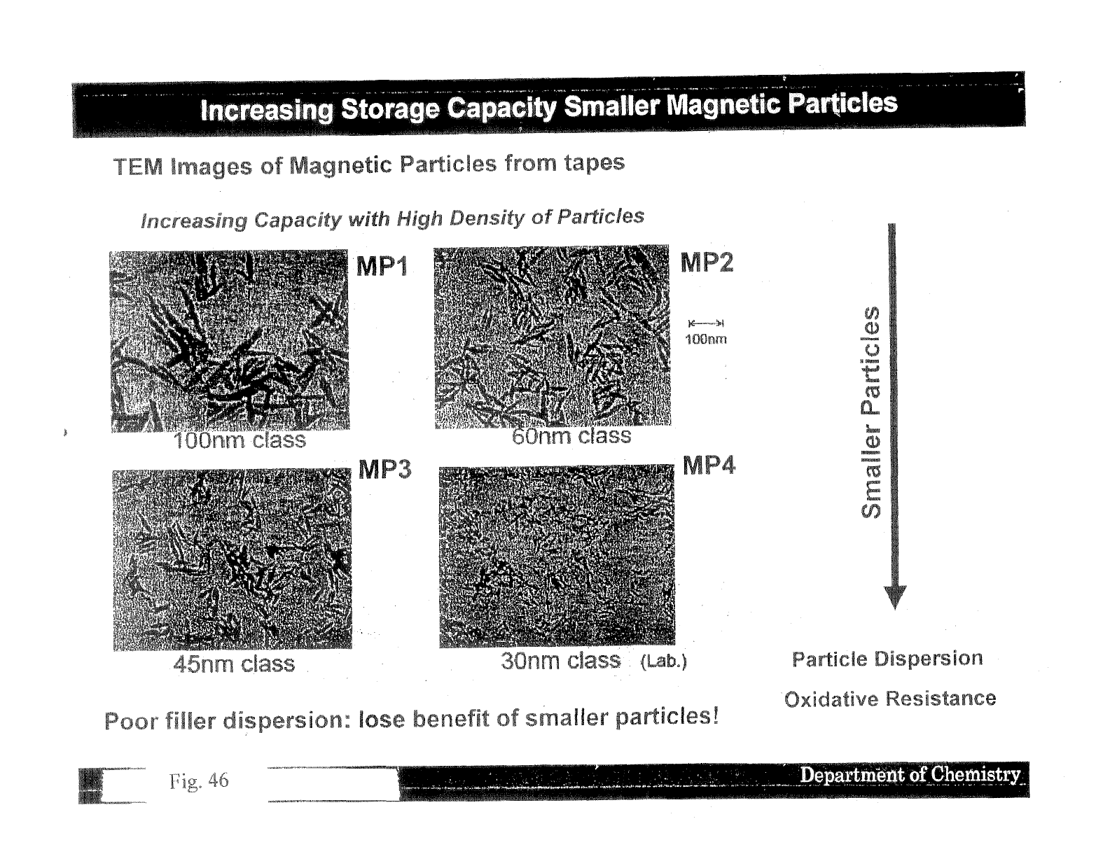

FIG. 46 shows four TEM images of different sizes of magnetic nanoparticles used as the storage media for magnetic tape. As particle size reduction is attempted from 100 nm to “40 nm” significant aggregation is observed, primary nanoparticles are not obtained and only agglomerates are milled to smaller size. Significant debris is formed from this process.

### Example 10

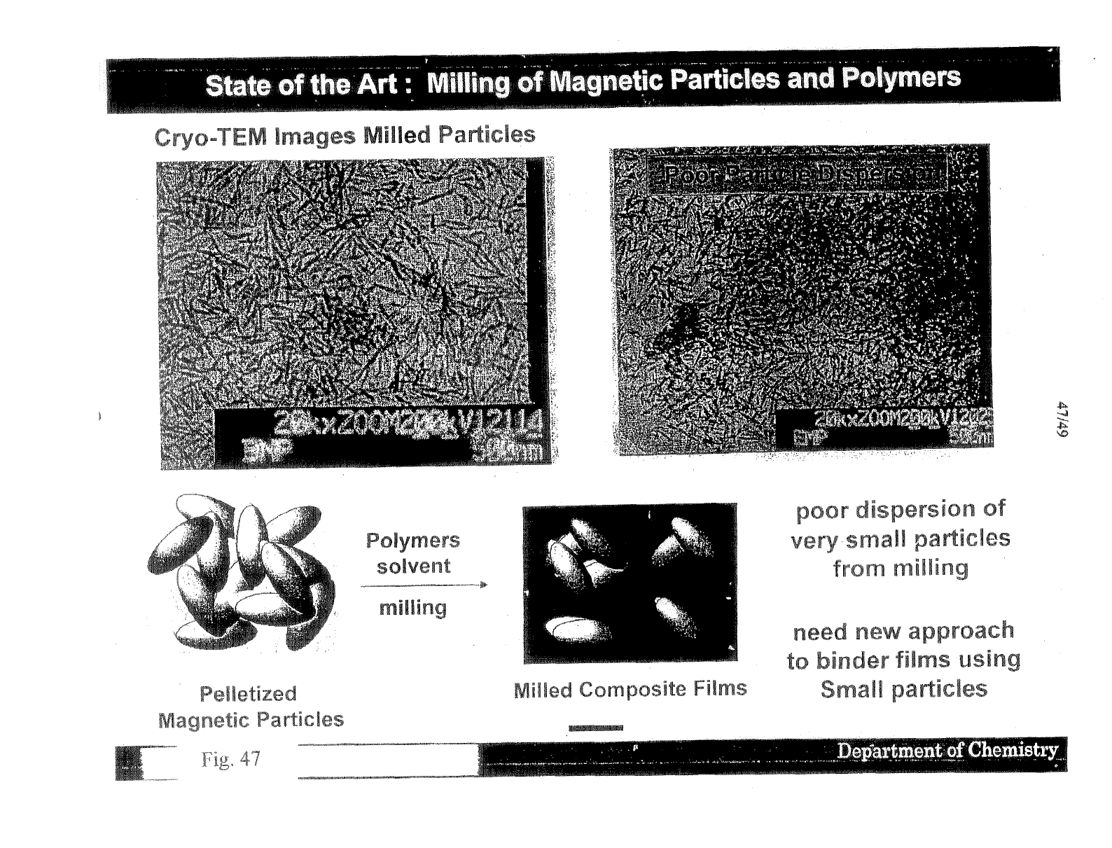

FIG. 47 shows another TEM of magnetic nanoparticles that are ball milled in attempt to obtained particles of smaller size. Significant aggregation, bottom scheme is scheme of process.

### Example 11

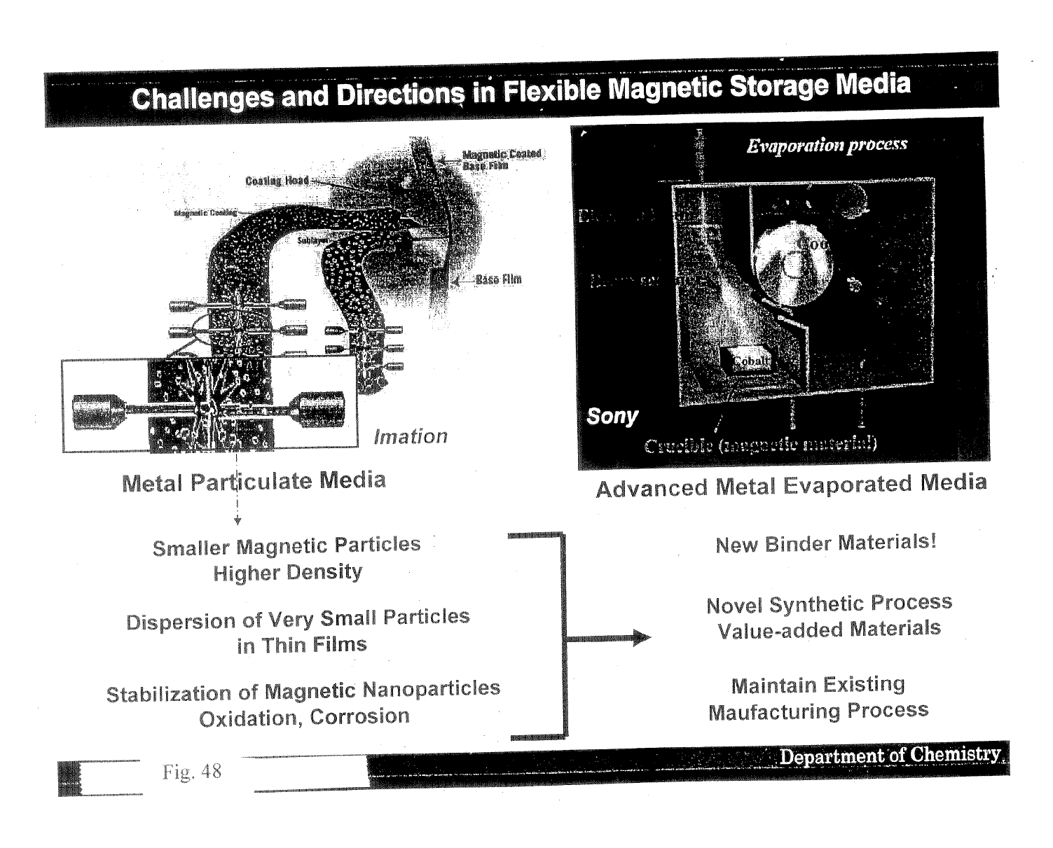

FIG. 48 shows two general types of storage media for magnetic tape (left) particulate media is composed of magnetic nanoparticles blended in polymer thin film (right) evaporative media is continuous metallic thin film of magnetic material (e.g. cobalt).

### Example 12

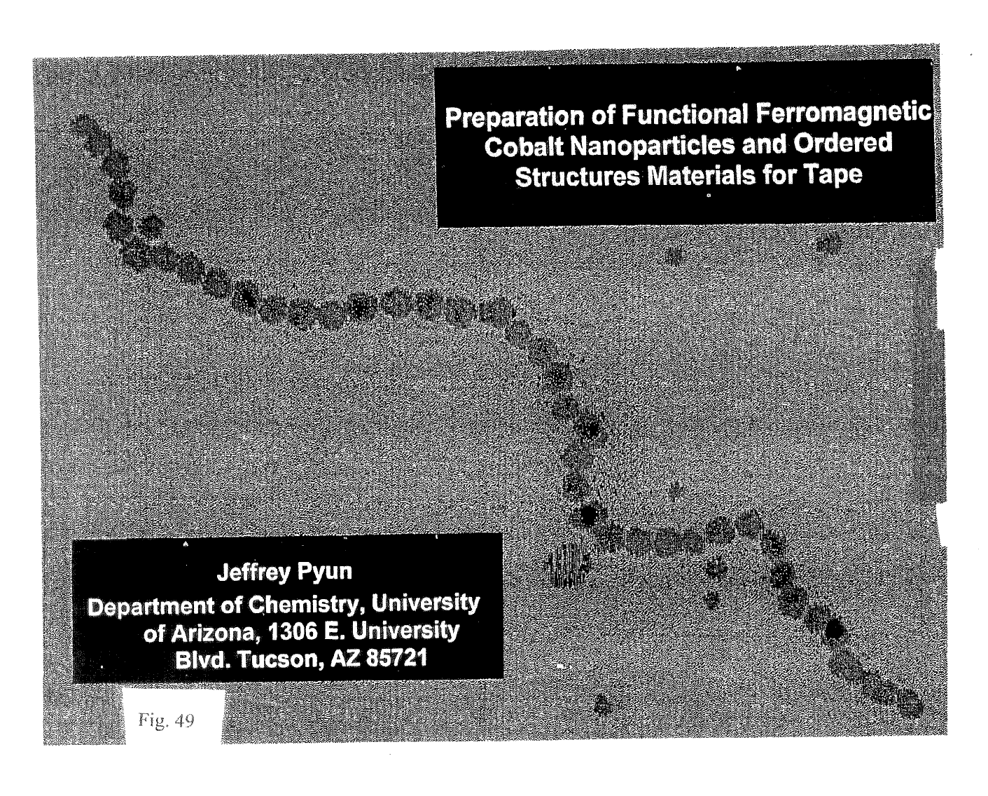

FIG. 49 shows a TEM image of ferromagnetic polystyrene cobalt nanoparticles and single nanoparticle chain formed on carbon coated TEM grid. For information on nanoparticle, see caption from FIG. 42.

U.S. provisional patent application 60/781,030 filed Mar. 10, 2006, and all papers and patents discussed herein are incorporated herein by reference.

Numerous modifications and variations on the present invention are possible in light of the above teachings. It is therefore to be understood that within the scope of the appended clams, the invention may be practiced otherwise than as specifically described herein.

1. A polymer coated nanoparticle, comprising:
a metallic core; and
a polymer shell encapsulating said metallic core.

2. The nanoparticle according to claim 1, which is ferromagnetic.

3. The nanoparticle according to claim 1, which has a particle size of 1-200 nm.

4. A chain structure, comprising:
a plurality of nanoparticles according to claim 1.

5. A colloid, comprising: a plurality of particles according to claim 1.

6. The nanoparticle according to claim 1, wherein said polymer is a homopolymer, a copolymer comprising polymerized monomer units of two or more monomers or a mixture thereof.

7. The nanoparticle according to claim 1, wherein said polymer shell is crosslinked.

8. The nanoparticle according to claim 1, wherein said polymer is one layer or a combination of two or more layers.

9. The nanoparticle according to claim 1, wherein said metallic core comprises a combination of two or more metals, semi-metals, metal oxides, or doped metal oxides.

10. The nanoparticle according to claim 1, wherein said metallic core comprises Co, Ni, Fe or mixtures thereof.

11. The nanoparticle according to claim 1, having a saturation magnetization of 10-100 emu/g.

12. The nanoparticle according to claim 1, having a coercivity range of 100-2000 Oe at room temperature.

13. The nanoparticle according to claim 1, wherein polymer of said polymer shell has a functional group in the main chain side chain or as an end-group of the main chain or side chain.

14. A polymer matrix, comprising:
the nanoparticle according to claim 1.

15. The nanoparticle according to claim 1, wherein said polymer shell comprises a metal complexation group a crosslinking group and a functional group.

16. A process for preparing the nanoparticle according to claim 1, comprising:
reacting a metal carbonyl compound or mixtures of different metal carbonyl compounds in the presence of a polymer.

17. A process for preparing the nanoparticle according to claim 1, comprising:
exchange of a polymer onto a nanoparticle by a ligand exchange reaction using a ligand that has a higher affinity toward the metallic core than the ligand already attached to the metallic core.

18. A metal-filled carbon nanowire, obtained by alignment, and pyrolysis of a plurality of the polymer coated nanoparticles according to claim 1.

20. A hollow carbon nanowire, obtained by alignment pyrolysis and acidic degradation of a plurality of the polymer coated nanoparticles according to claim 1.

21. A magnetic tape, comprising:
the polymer coated nanoparticle according to claim 1.

22. The magnetic tape according to claim 21, wherein said nanoparticle is ferromagnetic.

23. The magnetic tape according to claim 21, further comprising a polymer matrix.

24. The magnetic tape according to claim 21, wherein said nanoparticle has a particle size of 1-200 nm.

25. The magnetic tape according to claim 21, wherein said polymer is a homopolymer, a copolymer comprising polymerized monomer units of two or more monomers or a mixture thereof.

26. The magnetic tape according to claim 21, wherein said polymer shell is crosslinked.

27. The magnetic tape according to claim 21, wherein said polymer is one layer or a combination of two or more layers.

28. The magnetic tape according to claim 21, wherein said metallic core comprises a combination of two or more metals, semi-metals, metal oxides, or doped metal oxides.

29. The magnetic tape according to claim 21, wherein said metallic core comprises Co, Ni, Fe or mixtures thereof.

30. The magnetic tape according to claim 21, wherein said nanoparticle has a saturation magnetization of 10-100 emu/g.

31. The magnetic tape according to claim 21, wherein said nanoparticle has a coercivity range of 100-2000 Oe at room temperature.

32. The magnetic tape according to claim 21, wherein polymer of said polymer shell has a functional group in the main chain, side chain or as an end-group of the main chain or side chain.

33. The magnetic tape according to claim 21, wherein said polymer shell comprises a metal complexation group, a crosslinking group and a functional group.

34. A magnetic tape, comprising:
a polymer thin film; and
a polymer coated nanoparticle, comprising:
a magnetic metallic core; and
a polymer shell encapsulating said magnetic metallic core, thereby protecting said core from oxidation;
wherein the mechanical properties of said polymer shell are varied by control of the polymer composition;
wherein said polymer shell improves the dispersion of said nanoparticle in said polymer thin film compared to a nanoparticle having no polymer shell.

35. The magnetic tape according to claim 34, further comprising
a base film;
an under layer.

36. A magnetic tape, comprising
a magnetic coating which comprises
a polymer coated nanoparticle, comprising
a magnetic metallic core; and
a polymer shell encapsulating said magnetic metallic core, thereby protecting said core from oxidation.

37. The magnetic tape according to claim 36, wherein said magnetic coating comprises up to 50-vol % of said polymer coated nanoparticle.

38. The magnetic tape according to claim 36, wherein said magnetic coating has a film thickness of from 50-100 nm.

39. A method of making a magnetic tape according to claim 36, comprising providing said magnetic layer on a base layer,
wherein the mechanical properties of said polymer shell are varied by control of the polymer composition.
